(19) United States
(12) Patent Application Publication
(10) Pub. No.: US 2015/0350820 A1
(43) Pub. Date: Dec. 3, 2015

(54) BEACON ADDITIONAL SERVICE OF ELECTRONIC DEVICE AND ELECTRONIC DEVICE FOR SAME BACKGROUND ARTS

(71) Applicant: Samsung Electronics Co., Ltd., Gyeonggi-do (KR)

(72) Inventors: Sung-Ho SON, Daegu (KR); Kwang-Sub SON, Gyeonggi-do (KR); Won-Suk CHOI, Seoul (KR); Young-Eun HAN, Gyeonggi-do (KR)

(21) Appl. No.: 14/727,998

(22) Filed: Jun. 2, 2015

(30) Foreign Application Priority Data
Jun. 2, 2014 (KR) 10-2014-0067130

(51) Int. Cl. H04W 4/00; H04W 8/00; H04W 12/06; H04W 12/08; H04W 40/24; H04W 12/02

(52) U.S. Cl. CPC H04W 4/008; H04W 40/244; H04W 40/246; H04W 12/02; H04W 12/06; H04W 12/08; H04W 8/005

(57) ABSTRACT

An electronic device and method are disclosed herein. The electronic device includes a beacon module for detecting a beacon signal, and a processor. The processor may implement the method, including detecting a transmitted beacon signal by a beacon interface, extracting additional information from the detected beacon signal, and accessing a resource using the extracted additional information, the resource accessed from at least one of a source of the beacon signal and a remote terminal discoverable through a network.

### CROSS-REFERENCE TO RELATED APPLICATION

This application claims the priority under 35 U.S.C. §119(a) to Korean Application Serial No. 10-2014-0067130, which was filed in the Korean Intellectual Property Office on Jun. 2, 2014, the entire content of which is hereby incorporated by reference.

### TECHNICAL FIELD

Various embodiments of the present disclosure relate to a method for providing a beacon additional service of an electronic device and the electronic device for the same.

### BACKGROUND

As a communication technology for replacing the Near Filed Communication (NFC) technology, a Bluetooth Low Energy (BLE) beacon using BLE has been proposed. The BLE beacon is being commercialized in various fields including marketing, purchase, automatic check-in, etc. beyond provision of location information.

The NFC has a limited valid communication distance of about 4 cm to 20 cm, while the BLE beacon has an enlarged valid communication distance of about 5 cm to 50 m. Further, while the NFC requires a separate chip to be installed in each mobile communication terminal, the BLE beacon can be used for a near field wireless communication if it has a BLE recognition function. Therefore, the BLE beacon is more economic than the NFC and can provide a wireless communication service even in a wider indoor area.

From the recent version, Bluetooth 4.0, the BLE beacon can achieve synchronization with mobile communication terminals without limitations, such that the mobile communication terminals may include various types of electronic devices, such as a smart phone or a tablet PC. The mobile communication terminals transmit or receive a beacon signal when a beacon application program is executed or a user selects a particular icon provided by the beacon application program, and transmits predetermined contents through a beacon signal at a predetermined period.

### SUMMARY

Various embodiments of the present disclosure provide a beacon service for an electronic device and a method for implementing the same, which enable an electronic device, such as a smart phone or a tablet PC, to access various resources by using additional information included in a beacon signal received at a particular place.

According to various embodiments of the present disclosure, an operation method of an electronic device may include: detecting a transmitted beacon signal by a beacon interface, extracting additional information from the detected beacon signal, and accessing a resource using the extracted additional information, the resource accessed from at least one of a source of the beacon signal and a remote terminal discoverable through a network.

According to various embodiments of the present disclosure, an electronic device may include: a beacon module to detect a beacon signal, and a processor to extract additional information from the detected beacon signal, and access a resource using the extracted additional information, the resource accessed from at least one of a source of the beacon signal and a remote terminal discoverable through a network.

### BRIEF DESCRIPTION OF THE DRAWINGS

The present disclosure will be more apparent from the following detailed description taken in conjunction with the accompanying drawings, in which:

FIG. 1 illustrates a network environment including an electronic device according to various embodiments of the present disclosure.

FIG. 2 illustrates an electronic device according to various embodiments of the present disclosure.

FIG. 3 is a block diagram showing some elements of an electronic device according to various embodiments of the present disclosure.

FIG. 4 illustrates the configuration of a beacon packet according to various embodiments of the present disclosure.

FIG. 5 illustrates a transmission process of a beacon signal according to various embodiments of the present disclosure.

FIG. 6 illustrates example set advertisement parameters according to various embodiments of the present disclosure.

FIG. 7 illustrates example set advertisement data according to various embodiments of the present disclosure.

FIG. 8 is a block diagram schematically illustrating an electronic device according to various embodiments of the present disclosure.

FIG. 9 schematically illustrates the configuration of a situation processing module according to various embodiments of the present disclosure.

FIG. 10 schematically illustrates the configuration of a direct communication module according to various embodiments of the present disclosure.

FIG. 11 is a flowchart showing a filter-based data processing method according to various embodiments of the present disclosure.

FIG. 12 illustrates filter-based data transmission or reception according to various embodiments of the present disclosure.

FIG. 13 illustrates filter-based data transmission or reception according to another embodiment among various embodiments of the present disclosure.

FIG. 14 illustrates filter-based data transmission or reception according to another embodiment among various embodiments of the present disclosure.

FIG. 15 illustrates a reception information filter operation according to various embodiments of the present disclosure.

FIG. 16 illustrates an example of a screen that can be provided in a filter-based data processing operation according to various embodiments of the present disclosure.

FIG. 17 illustrates an example relation-based data processing module according to various embodiments of the present disclosure in more detail.

FIG. 18 illustrates a relation-based data processing method according to various embodiments of the present disclosure.

FIG. 19 illustrates a relation-based data processing method according to another embodiment among various embodiments of the present disclosure.

FIG. 20 illustrates a relation-based data processing method according to another embodiment among various embodiments of the present disclosure.

FIG. 21 is a flowchart illustrating a method of transmitting a beacon changed according to status information by a transmitter electronic device according to various embodiments of the present disclosure.

FIG. 22 is a flowchart illustrating a method of generating a beacon changed depending on status information according to various embodiments of the present disclosure.

FIG. 23 is a signal flow diagram illustrating the signal flow between a transmission electronic device and a reception electronic device according to various embodiments of the present disclosure.

FIG. 24 is a flowchart illustrating a method of generating a beacon changed depending on status information according to various embodiments of the present disclosure.

FIG. 25 is a flowchart illustrating a method of generating a beacon changed depending on status information according to various embodiments of the present disclosure.

FIG. 26 is a flowchart illustrating a method of generating a beacon changed depending on status information according to various embodiments of the present disclosure.

FIG. 27 is a flowchart illustrating a method of controlling a beacon signal by an electronic device according to various embodiments of the present disclosure.

FIG. 28 illustrates change of the transmission cycle of a beacon signal according to various embodiments of the present disclosure.

FIG. 29 illustrates change of a transmission power of a beacon signal according to various embodiments of the present disclosure.

FIG. 30 is a flowchart illustrating a method of controlling a beacon signal by an electronic device according to another embodiment among various embodiments of the present disclosure.

FIG. 31A and FIG. 31B illustrate an example in which an electronic device according to various embodiments of the present disclosure controls a beacon signal on the basis of a motion sensor.

FIG. 32A and FIG. 32B illustrate an example in which an electronic device according to various embodiments of the present disclosure controls a beacon signal on the basis of a position sensor.

FIG. 33 illustrates an example in which an electronic device according to various embodiments of the present disclosure controls a beacon signal on the basis of a fingerprint sensor.

FIG. 34 illustrates an example in which an electronic device according to various embodiments of the present disclosure controls a beacon signal on the basis of an acceleration sensor.

FIG. 35 illustrates an example in which an electronic device according to various embodiments of the present disclosure controls a beacon signal on the basis of a geomagnetic sensor.

FIG. 36 illustrates an example in which an electronic device according to various embodiments of the present disclosure controls a beacon signal on the basis of a camera sensor.

FIG. 37 illustrates an example in which an electronic device according to various embodiments of the present disclosure controls a beacon signal on the basis of a microphone sensor.

FIG. 38 illustrates an example in which an electronic device according to various embodiments of the present disclosure controls a beacon signal on the basis of a heart rate monitor.

FIG. 39, FIG. 40, FIG. 41 and FIG. 42 illustrate the structures of transfer condition information included in a beacon packet according to various embodiments of the present disclosure.

FIG. 43 illustrates a beacon relay process according to various embodiments of the present disclosure.

FIG. 44 is a flowchart illustrating a method of relaying a beacon signal by an electronic device according to another embodiment among various embodiments of the present disclosure.

FIG. 45 is a flowchart illustrating a method of relaying a beacon signal by an electronic device according to another embodiment among various embodiments of the present disclosure.

FIG. 46 is a flowchart illustrating a method of relaying a beacon signal by an electronic device according to another embodiment among various embodiments of the present disclosure.

FIG. 47 is a flowchart illustrating a method of relaying a beacon signal by an electronic device according to another embodiment among various embodiments of the present disclosure.

FIG. 48 illustrates an example of additional information according to various embodiments of the present disclosure.

FIG. 49 illustrates an example in which an electronic device according to various embodiments of the present disclosure receives a beacon signal at a particular place.

FIG. 50 illustrates an example in which an electronic device according to various embodiments of the present disclosure communicates with a server or terminal through a beacon additional service.

FIG. 51 is a flowchart illustrating a beacon additional service method of an electronic device according to various embodiments of the present disclosure.

FIG. 52 illustrates an example of a performance video displayed on an electronic device according to various embodiments of the present disclosure.

FIG. 53 illustrates an example of a food discount coupon displayed on an electronic device according to various embodiments of the present disclosure.

FIG. 54 illustrates an example of minutes displayed on an electronic device according to various embodiments of the present disclosure.

FIG. 55 illustrates an example of acquisition of full contents from preview contents using additional information according to various embodiments of the present disclosure.

FIG. 56 illustrates an example of acquisition of an additional discount content further to a basic discount coupon using additional information according to various embodiments of the present disclosure.

FIG. 57 illustrates an example of use of stored contents using additional information according to various embodiments of the present disclosure.

FIG. 58 is a flowchart illustrating a method of generating a beacon on the basis of location by an electronic device according to various embodiments of the present disclosure.

FIG. 59 is a flowchart illustrating a method of performing a control operation according to the received beacon by an electronic device according to various embodiments of the present disclosure.

FIG. 60 is a flowchart illustrating a method of performing a geo-tagging operation to the received beacon by an electronic device according to various embodiments of the present disclosure.

### DETAILED DESCRIPTION

Hereinafter, various embodiments of the present disclosure will be described with reference to the accompanying drawings. The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications, equivalents, and/or alternatives of the present disclosure. In the description of the drawings, identical or similar reference numerals are used to designate identical or similar elements.

As used in various embodiments of the present disclosure, the expression “include” or “may include” refers to the existence of a corresponding function, operation, or element, and does not exclude one or more additional functions, operations, or elements. Further, as used in various embodiments of the present disclosure, the terms “include”, “have”, and their conjugates are intended merely to denote a certain feature, numeral, step, operation, element, component, or a combination thereof, and should not be construed to initially exclude the existence of or a possibility of addition of one or more other features, numerals, steps, operations, elements, components, or combinations thereof.

Further, as used in various embodiments of the present disclosure, the expression “or” includes any or all combinations of words enumerated together. For example, the expression “A or B” may include A, may include B, or may include both A and B. In various embodiments of the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices. For example, a first element could be termed a second element, and similarly, a second element could be also termed a first element without departing from the present disclosure.

In the case where an element is referred to as being “connected” or “accessed” to other elements, it should be understood that not only the element is directly connected or accessed to the other elements, but also another element may exist between them. Meanwhile, in the case where an element is referred to as being “directly connected to” or “directly accessing” other elements, it should be understood that there is no element therebetween.

The terms as used in various embodiments of the present disclosure are used merely to describe a certain embodiment and are not intended to limit the present disclosure. As used herein, the singular forms are intended to include the plural forms as well, unless the context clearly indicates otherwise.

Unless defined otherwise, all terms used herein, including technical and scientific terms, have the same meaning as commonly understood by those of skill in the art to which various embodiments of the present disclosure pertains. Such terms as those defined in a generally used dictionary are to be interpreted to have the meanings equal to the contextual meanings in the relevant field of art, and are not to be interpreted to have ideal or excessively formal meanings unless clearly defined in various embodiments of the present disclosure.

An electronic device according to various embodiments of the present disclosure may be a device including a communication function. For example, the electronic device may include at least one of a smartphone, a tablet Personal Computer (PC), a mobile phone, a video phone, an electronic book (e-book) reader, a desktop PC, a laptop PC, a netbook computer, a Personal Digital Assistant (PDA), a Portable Multimedia Player (PMP), an MP3 player, a mobile medical appliance, a camera, and a wearable device (e.g. a Head-Mounted-Device (HMD) such as electronic glasses, electronic clothes, an electronic bracelet, an electronic necklace, an electronic appcessory, electronic tattoos, or a smartwatch).

According to some embodiments, the electronic device may be a smart home appliance with a communication function. The smart home appliance as an example of the electronic device may include at least one of, for example, a television, a Digital Video Disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic picture frame.

According to some embodiments, the electronic device may include at least one of various medical appliances (e.g. Magnetic Resonance Angiography (MRA), Magnetic Resonance Imaging (MRI), Computed Tomography (CT) machine, and an ultrasonic machine), navigation devices, Global Positioning System (GPS) receivers, Event Data Recorders (EDRs), Flight Data Recorders (FDRs), automotive infortainment devices, electronic equipments for ships (e.g. navigation equipments for ships, gyrocompasses, or the like), avionics, security devices, head units for vehicles, industrial or home robots, Automatic Teller Machines (ATM) of banking facilities, and Point Of Sales (POSs) of shops.

According to some embodiments, the electronic device may include at least one of a part of furniture or a building/structure having a communication function, an electronic board, an electronic signature receiving device, a projector, and various kinds of measuring instruments (e.g., a water meter, an electric meter, a gas meter, a radio wave meter, and the like). The electronic device according to various embodiments of the present disclosure may be a combination of one or more of the aforementioned various devices. Also, the electronic device according to the present disclosure may be a flexible device. Further, it will be apparent to those skilled in the art that the electronic device according to various embodiments of the present disclosure is not limited to the aforementioned devices.

Hereinafter, an electronic device according to various embodiments of the present disclosure will be described with reference to the accompanying drawings. The term “user” as used in various embodiments of the present disclosure may indicate a person who uses an electronic device or a device (e.g., artificial intelligence electronic device) that uses an electronic device.

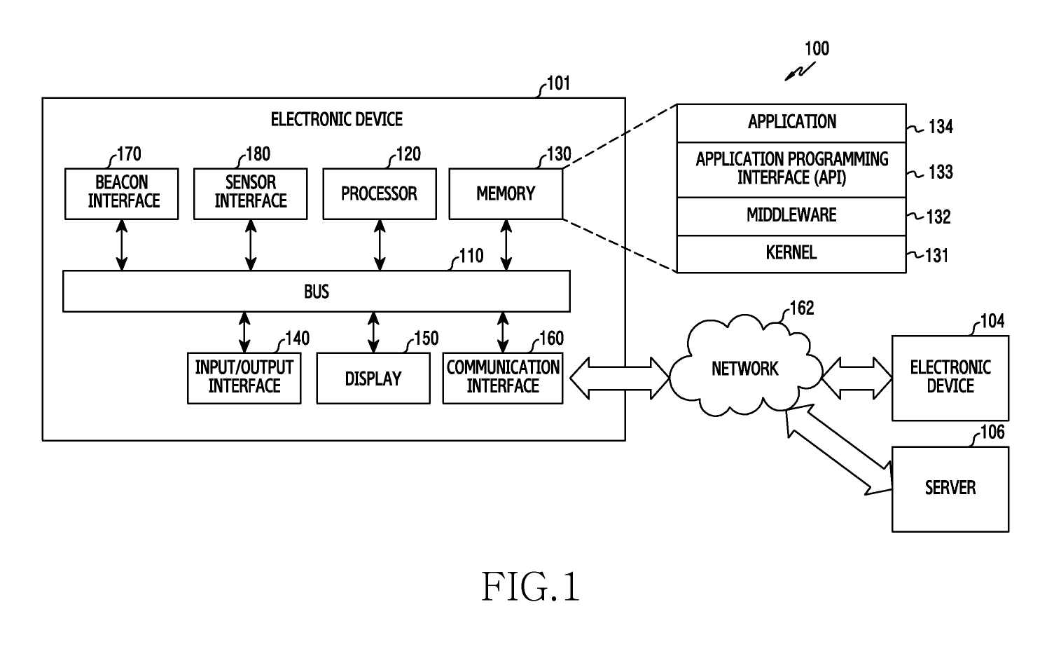

FIG. 1 illustrates a network environment 100 including an electronic device 101 according to various embodiments of the present disclosure. Referring to FIG. 1, the electronic device 101 may include a bus 110, a processor 120, a memory 130, an input/output interface 140, a display 150, a communication interface 160, a beacon interface 170, and a sensor interface 180.

The beacon interface 170, which is an element for transmitting or receiving a beacon signal, may either be included in the communication interface 160 or be a separate element, and may interwork with the processor 120. The sensor interface 180, which is an element for receiving information from various sensors, such as a motion sensor, a location sensor, a fingerprint sensor, an acceleration sensor, a geomagnetic sensor, and a heart rate monitor, may interwork with the processor 120. The bus 110 may be a circuit which interconnects the above-described elements and delivers a communication (e.g., a control message) between the above-described elements.

For example, the processor 120 may receive instructions from the aforementioned other elements (e.g., the memory 130, the input/output interface 140, the display 150, and the communication interface 160) through the bus 110, decipher the received instructions, and perform calculation or data processing according to the deciphered instructions.

The memory 130 may store commands or data received from or created by the processor 120 or other elements (e.g., the input/output interface 140, the display 150, or the communication interface 160). The memory 130 may include programming modules, such as a kernel 131, middleware 132, an Application Programming Interface (API) 133, and an application 134. The aforementioned programming modules may be formed of software, firmware, hardware, or a combination of at least two thereof.

The kernel 131 may control or manage system resources (e.g., the bus 110, the processor 120, or the memory 130) used for executing an operation or a function implemented in the remaining other programming modules, for example, the middleware 132, the API 133, or the application 134. In addition, the kernel 131 may provide an interface through which the middleware 132, the API 133, or the application 134 may control or manage the individual elements of the electronic device 101 while accessing the individual elements.

The middleware 132 may perform a relay function of allowing the API 133 or the application 134 to communicate with the kernel 131 to exchange data therewith. Furthermore, in regard to task requests received from the applications 134, the middleware 132 may perform a control (e.g., scheduling or load balancing) for the task requests, using a method of allocating at least one of the applications 134 a priority for using the system resources (e.g., the bus 110, the processor 120, and the memory 130) of the electronic device 101.

The API 133 is an interface through which the application 134 may control functions provided by the kernel 131 or the middleware 132, and may include at least one interface or function (e.g., command) for file control, window control, image processing, or text control.

According to various embodiments of the present disclosure, the applications 134 may include a Short Message Service (SMS)/Multimedia Message Service (MMS) application, an e-mail application, a calendar application, an alarm application, a health care application (e.g., an application for measuring an amount of exercise or blood sugar), and an environmental information application (e.g., an application for providing atmospheric pressure, humidity, temperature, and the like). Additionally or alternately, the application 134 may be an application related to the exchange of information between the electronic device 101 and an external electronic device (e.g., an electronic device 104). The application related to the exchange of information may include, for example, a notification relay application for transferring particular pieces of information to the external electronic device or a device management application for managing the external electronic device.

For example, the notification relay application may include a function of transferring, to the external electronic device (e.g., the electronic device 104), notification information generated in other applications of the electronic device 101 (e.g., an SMS/MMS application, an e-mail application, a health management application, an environmental information application, and the like). Additionally or alternatively, the notification relay application may receive notification information from, for example, the external electronic device (e.g., the electronic device 104) and provide the received notification information to a user. For example, the device management application may manage (e.g., install, delete, or update) functions for at least a part of the external electronic device (e.g., the electronic device 104) communicating with the electronic device 101 (e.g., turning on/off the external electronic device itself (or some elements thereof) or adjusting the brightness (or resolution) of a display), applications operating in the external electronic device, or services (e.g., a telephone call service or a message service) provided from the external electronic device.

According to various embodiments of the present disclosure, the applications 134 may include an application predetermined according to the attribute (e.g., the type) of the external electronic device (e.g., the electronic device 104). For example, in cases where the external electronic device is an MP3 player, the applications 134 may include an application related to the reproduction of music. Similarly, in cases where the external electronic device is a mobile medical appliance, the applications 134 may include an application related to health care. According to one embodiment, the applications 134 may include at least one of an application designated to the electronic device 101 and an application received from the external electronic device (e.g., a server 106 or the electronic device 104).

The input/output interface 140 may transfer commands or data input from a user through an input/output device (e.g., the sensor, a keyboard, or a touch screen) to, for example, the processor 120, the memory 130, or the communication interface 160 through the bus 110. For example, the input/output interface 140 may provide, to the processor 120, data for a user's touch input through the touch screen. Furthermore, through the input/output device (e.g., a speaker or a display), the input/output interface 140 may output commands or data received from the processor 120, the memory 130, or the communication interface 160 through the bus 110. For example, the input/output interface 140 may output voice data, processed through the processor 120, to a user through a speaker.

The display 150 may display various pieces of information (e.g., multimedia data or text data) to a user. The communication interface 160 may connect communication between the electronic device 101 and the external electronic device (e.g., the electronic device 104 or the server 106). For example, the communication interface 160 may be connected to a network 162 through wireless or wired communication to communicate with the external device. The wireless communication may include at least one of, for example, Wi-Fi (Wireless Fidelity), Bluetooth (BT), Near Field Communication (NFC), Global Positioning System (GPS) and cellular communication (e.g., Long Term Evolution (LTE), LTE-A, Code Division Multiple Access (CDMA), Wideband CDMA (WCDMA), Universal Mobile Telecommunication System (UMTS), Wireless Broadband (WiBro), and Global System for Mobile communication (GSM)). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment of the present disclosure, the network 162 may be a telecommunication network. The communication network may include at least one of a computer network, the Internet, the Internet of things, and a telephone network. According to an embodiment of the present disclosure, at least one of the applications 134, the application programming interface 133, the middleware 132, the kernel 131, and the communication interface 160 may support a protocol (e.g., transport layer protocol, data link layer protocol, or physical layer protocol) for communication between the electronic device 101 and an external device.

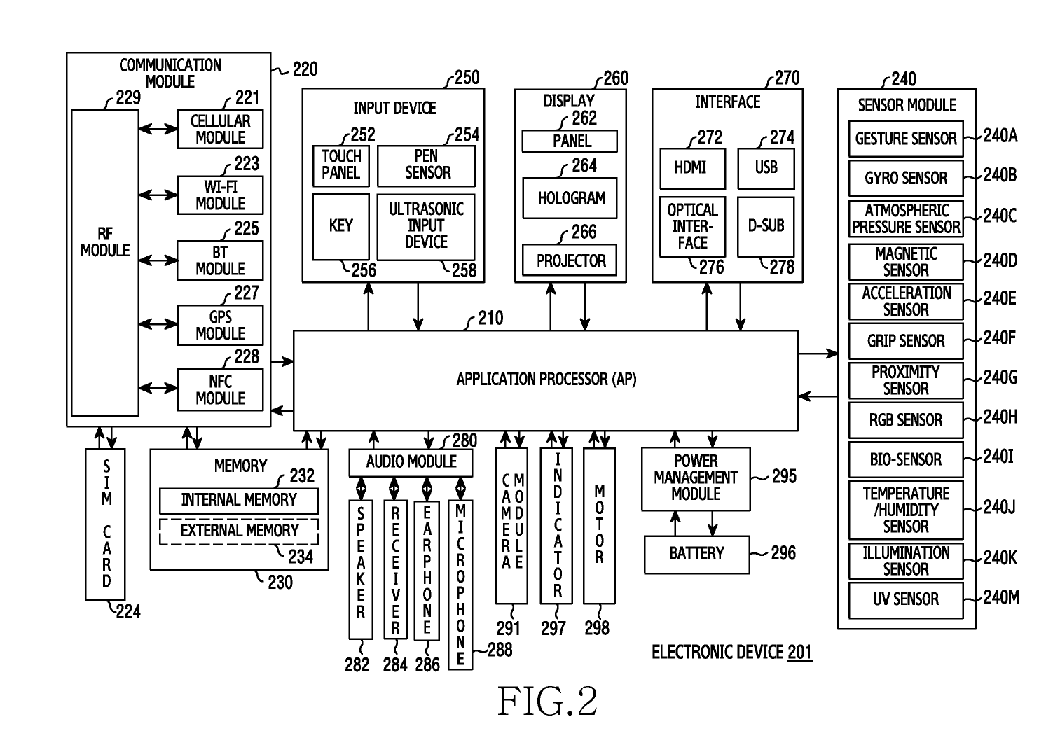

FIG. 2 is a block diagram of an electronic device 201 according to various embodiments of the present disclosure. The electronic device 201 may configure, for example, the whole or a part of the electronic device 101 illustrated in FIG. 1. Referring to FIG. 2, the electronic device 201 may include at least one Application Processor (AP) 210, a communication module 220, a Subscriber Identifier Module (SIM) card 224, a memory 230, a sensor module 240, an input device 250, a display 260, an interface 270, an audio module 280, a camera module 291, a power management module 295, a battery 296, an indicator 297, and a motor 298.

The AP 210 may control a plurality of hardware or software elements connected to the AP 210 by driving an operating system or an application program and process various types of data including multimedia data and perform calculations. The AP 210 may be implemented by, for example, a System on Chip (SoC). According to one embodiment, the AP 210 may further include a Graphic Processing Unit (GPU; not shown).

The communication module 220 (e.g., the communication interface 160) may perform data transmission/reception in communication between the electronic device 201 (e.g., the electronic device 101) and other electronic devices (e.g., the electronic device 104 and the server 106) connected thereto through a network. According to one embodiment, the communication module 220 may include a cellular module 221, a Wi-Fi module 223, a BT module 225, a GPS module 227, an NFC module 228, and a radio frequency (RF) module 229.

The cellular module 221 may provide a voice call, a video call, a Short Message Service (SMS), or an Internet service through a communication network (e.g., LTE, LTE-A, CDMA, WCDMA, UMTS, WiBro, OR GSM). Furthermore, the cellular module 221 may distinguish and authenticate electronic devices within a communication network using, for example, a subscriber identification module (for example, the SIM card 224). According to one embodiment, the cellular module 221 may perform at least some functions which the AP 210 may provide. For example, the cellular module 221 may perform at least some of the multimedia control functions.

According to an embodiment of the present disclosure, the cellular module 221 may include a communication processor (CP). Furthermore, the cellular module 221 may be implemented by, for example, an SoC. Although the elements such as the cellular module 221 (e.g., a communication processor), the memory 230, and the power management module 295 are illustrated to be separate from the AP 210 in FIG. 2, the AP 210 may include at least some (e.g., the cellular module 221) of the aforementioned elements in an embodiment.

According to an embodiment of the present disclosure, the AP 210 or the cellular module 221 (e.g., communication processor) may load a command or data received from at least one of a non-volatile memory and any other element connected to each of the AP 210 and the cellular module 221 into a volatile memory and may process the command or data loaded into the volatile memory. Furthermore, the AP 210 or the cellular module 221 may store data received from or generated by at least one of other elements in a non-volatile memory.

Each of the Wi-Fi module 223, the BT module 225, the GPS module 227, and the NFC module 228 may include, for example, a processor for processing data transmitted or received through a corresponding module. Although FIG. 2 shows each of the cellular module 221, the Wi-Fi module 223, the BT module 225, the GPS module 227, and the NFC module 228 as being a separate block, at least some (e.g., two or more) of the cellular module 221, the Wi-Fi module 223, the BT module 225, the GPS module 227, and the NFC module 228 may be included in one integrated chip (IC) or one IC package. For example, at least some of the processors corresponding respectively to the cellular module 221, the Wi-Fi module 223, the BT module 225, the GPS module 227, and the NFC module 228 (e.g., the CP corresponding to the cellular module 221 and the Wi-Fi processor corresponding to the Wi-Fi module 223) may be implemented as one SoC.

The RF module 229 may transmit/receive data, for example, an RF signal. Although not shown in the drawing, the RF module 229 may, for example, include a transceiver, a power amp module (PAM), a frequency filter, a low noise amplifier (LNA), or the like. Further, the RF unit 229 may further include a component for transmitting/receiving an electromagnetic wave in a free space in radio communication, for example, a conductor, a conductive wire, or the like. Although FIG. 2 shows the cellular module 221, the Wi-Fi module 223, the BT module 225, the GPS module 227, and the NFC module 228 as sharing one RF module 229, at least one of the cellular module 221, the Wi-Fi module 223, the BT module 225, the GPS module 227, and the NFC module 228 may transmit and receive an RF signal through a separate RF module according to one embodiment.

The SIM card 224 may be a card including a subscriber identification module, and may be inserted into a slot formed in a particular portion of the electronic device. The SIM card 224 may include unique identification information (for example, an Integrated Circuit Card IDentifier (ICCID)) or subscriber information (for example, International Mobile Subscriber Identity (IMSI)).

The memory 230 (e.g., the memory 130) may include an internal memory 232 or an external memory 234. The internal memory 232 may include, for example, at least one of a volatile memory (e.g., a Dynamic RAM (DRAM), a Static RAM (SRAM), and a Synchronous Dynamic RAM (SDRAM)), and a non-volatile Memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a NAND flash memory, and an NOR flash memory).

According to one embodiment, the internal memory 232 may be a Solid State Drive (SSD). The external memory 234 may further include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 234 may be functionally connected to the electronic device 201 through various interfaces. According to one embodiment, the electronic device 201 may further include a storage device (or a storage medium) such as a hard disc drive.

The sensor module 240 may measure a physical quantity or detect an operation state of the electronic device 201 and convert the measured or detected information to an electric signal. The sensor module 240 may include at least one of, for example, a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, red, green, and blue (RGB) sensor), a bio-sensor 240I, a temperature/humidity sensor 240J, an illumination sensor 240K, and a Ultra Violet (UV) sensor 240M. Additionally or alternatively, the sensor module 240 may include, for example, an E-nose sensor (not illustrated), an electromyography (EMG) sensor (not illustrated), an electroencephalogram (EEG) sensor (not illustrated), an electrocardiogram (ECG) sensor (not illustrated), an Infrared (IR) sensor (not illustrated), an iris sensor (not illustrated), a fingerprint sensor (not illustrated), a geomagnetic sensor (not illustrated), and a heart rate monitor (not illustrated). The sensor module 240 may further include a control circuit for controlling one or more sensors included in the sensor module.

The input device 250 may include a touch panel 252, a (digital) pen sensor 254, a key 256, or an ultrasonic input device 258. The touch panel 252 that recognizes a touch input may, for example, include at least one of a capacitive touch panel, a resistive touch panel, an infrared touch panel, and an ultrasonic wave touch panel. Further, the touch panel 252 may further include a control circuit. The capacitive touch panel may be able to recognize physical contact or proximity. The touch panel 252 may further include a tactile layer. In this event, the touch panel 252 may provide a tactile response to the user.

The (digital) pen sensor 254 may be implemented, for example, using the same or similar method to receiving a user's touch input or using a separate detection sheet. The key 256 may include, for example, a physical button, an optical key, or a keypad. The ultrasonic input unit 258 may be a unit that can identify data by generating an ultrasonic signal through an input tool and detecting a sonic wave through a microphone (e.g., the microphone 288) in the electronic device 201 and may be capable of wireless detection. According to an embodiment, the electronic device 201 may receive a user input from an external device (for example, computer or server) connected thereto using the communication module 220.

The display 260 (e.g. the display 150) may include a panel 262, a hologram device 264, or a projector 266. The panel 262 may be, for example, a Liquid Crystal Display (LCD) and an Active Matrix Organic Light Emitting Diode (AM-OLED) display, and the like. The panel 262 may be implemented so as to be, for example, flexible, transparent, or wearable. The panel 262 may be integrated with the touch panel 252 to configure one module. The hologram device 264 may show a stereoscopic image in the air by using interference of light. The projector 266 may project light onto a screen to display an image. The screen may be located, for example, inside or outside the electronic device 201. According to one embodiment, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, in the communication interface 160 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280 may bilaterally convert a sound and an electric signal. At least some elements of the audio module 280 may be included in, for example, the input/output interface 140 illustrated in FIG. 1. The audio module 280 may process sound information input or output through, for example, the speaker 282, the receiver 284, the earphones 286, or the microphone 288.

The camera module 291 may be a device that can take both still and moving images and may include at least one image sensor (e.g., front sensor or rear sensor; not shown), a lens (not shown), an image signal processor (ISP) (not shown), or a flash (e.g., LED or xenon lamp; not shown) according to an embodiment of the present disclosure. The power management module 295 may manage power of the electronic device 201. Although not illustrated, the power management module 295 may include, for example, a Power Management Integrated Circuit (PMIC), a charger Integrated Circuit (IC), or a battery or fuel gauge.

The PMIC may be mounted, for example, in an integrated circuit or an SoC semiconductor. The charging methods may be classified into wired charging and wireless charging. The charger IC may charge a battery and prevent inflow of excessive voltage or excessive current from a charger. According to an embodiment, the charger IC may include a charger IC for at least one of the wired charging type or the wireless charging type. Examples of the wireless charging may include magnetic resonance charging, magnetic induction charging, and electromagnetic charging, and an additional circuit such as a coil loop, a resonance circuit, and a rectifier may be added for the wireless charging.

The battery gauge may measure, for example, a residual quantity of the battery 296, or a voltage, a current, or a temperature during the charging. The battery 296 may store or generate electricity, and may supply power to the electronic device 201 by using the stored or generated electricity. The battery 296 may include, for example, a rechargeable battery or a solar battery.

The indicator 297 may display a specific status of the electronic device 201 or a part (e.g. the AP 210) of electronic device, for example, a booting status, a message status, a charging status, and the like. The motor 298 can convert an electrical signal into a mechanical vibration. Although not illustrated, the electronic device 201 may include a processing unit (e.g., GPU) for supporting a mobile TV. The processing unit for supporting a mobile TV can process media data according to a standard of Digital Multimedia Broadcasting (DMB), Digital Video Broadcasting (DVB), media flow, or the like.

Each of the above described elements of the electronic device according to various embodiments of the present disclosure may include one or more components, and the name of a corresponding element may vary according to the type of electronic device. The electronic device according to various embodiments of the present disclosure may include at least one of the above described elements and may exclude some of the elements or further include other additional elements. Further, some of the elements of the electronic device according to various embodiments of the present disclosure may be coupled to form a single entity while performing the same functions as those of the corresponding elements before the coupling.

Hereinafter, a method for providing a beacon additional service of an electronic device and the electronic device for the same according to various embodiments of the present disclosure will be described in detail. Herein, the beacon additional service may be referred to as another predetermined name.

The electronic device according to various embodiments of the present disclosure may be various types of electronic devices, such as a smart phone or a tablet PC, and may include the elements illustrated in FIGS. 1 and 2.

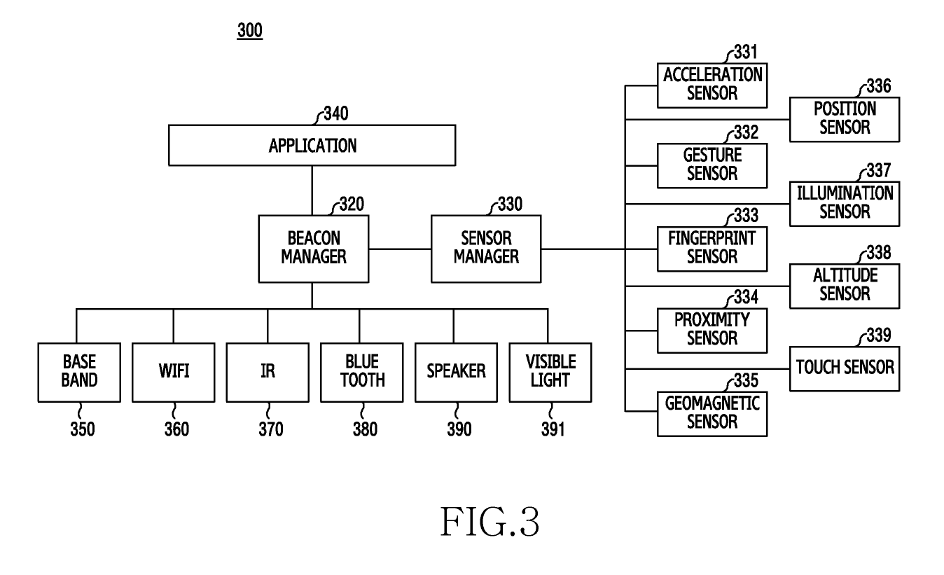

FIG. 3 is a block diagram showing some elements of an electronic device 300 according to various embodiments of the present disclosure. Referring to FIG. 3, the electronic device 300 may include a beacon manager 320, a sensor manager 330, an application 340, a baseband module 350, a WiFi module 360, an infrared module 370, a Bluetooth module 380, and a speaker 390. Also, the electronic device may further include a visible light module 391 for communication using visible rays (e.g. LED light).

The sensor manager 330 may manage various sensors including an acceleration sensor 331, a gesture sensor 332, a fingerprint sensor 333, a proximity sensor 334, a geomagnetic sensor 335, a position sensor 336, an illumination sensor 337, an altitude sensor 338, and a touch sensor 339, and may either be integrated with the beacon manager 320 into one element or interwork with the beacon manager 320 as an element separated therefrom.

According to the execution of the application 340, the beacon manager 320 may operate at least one (e.g., the baseband module) of the modules described above, and the operated module may output, to the beacon manager 320, a beacon signal received through a wireless network. The beacon manager 320 may dynamically control the operation of transmitting or receiving a beacon signal, on the basis of various sensor information input through the sensor manager 330.

The beacon manager 320 may interwork with the application 340 to control the operation of transmitting or receiving a beacon signal or generate a beacon signal by itself. The beacon manager 320 may be included in the application to manage a beacon operation of each application or may exist outside the application to manage beacon operations of multiple applications. Moreover, the beacon manager 320 may be included in each of the modules, such as the baseband module 350, the WiFi module 360, the infrared module 370, the Bluetooth module 380, the speaker 390, and the visible light module 391. Further, the beacon manager 320 may interwork with or included in the processor 120 shown in FIG. 1.

The beacon transmission/reception operation is controlled by a control command generated by the beacon manager 320, and the beacon signal is transmitted or received through a module which can transmit or receive the beacon. The module which can transmit or receive the beacon signal may include the baseband module, the WiFi module, the InfRared (IR) module, the Bluetooth module, the speaker, and the visible light module.

The baseband module can transmit or receive a beacon signal, which can used for communication in a mobile network, such as GSM, UMTS, and LTE, and the WiFi module can transmit or receive a beacon signal which satisfies the 802.11 communication standard.

The IR module may transmit or receive a beacon signal using an infrared sensor, the Bluetooth module may transmit or receive a beacon signal satisfying a Bluetooth communication standard, and the speaker, which transmits or receives a signal through sound, may transmit or receive a beacon signal including particular information in inaudible sound or audible sound. The beacon signal may be transmitted or received through various modules, as well as the modules described above, and the modules may be allowed to transmit a beacon signal or receive a beacon signal.

In controlling the beacon operation, the beacon manager 320 may use various sensor information received from the sensor manager 330. The sensor manager 330 is a module for managing sensor values collected by various sensors and for using a sensor value with a low electric power.

Sensors managed by the sensor manager 330 include an acceleration sensor, a geomagnetic sensor, a gyro sensor, a position sensor including a Global Positioning System (GPS), a gesture (motion) sensor, an illumination sensor, a fingerprint sensor, an altitude sensor, a proximity sensor, a touch sensor, a camera sensor, a microphone sensor, a Heart Rate Monitor (HRM) sensor, an oxygen saturation sensor, a stress measurement sensor, and a brainwave sensor. In addition to the sensors mentioned above, various sensors may be managed.

Further, in various embodiments of the present disclosure, either a sensor value may be obtained from the sensor manager 330 or the sensor manager 330 may not exist. Moreover, it may be unnecessary to manage the sensor manager 330. That is, the beacon manager 320 may directly receive a sensor value from each sensor by itself to use the sensor value in controlling the beacon operation.

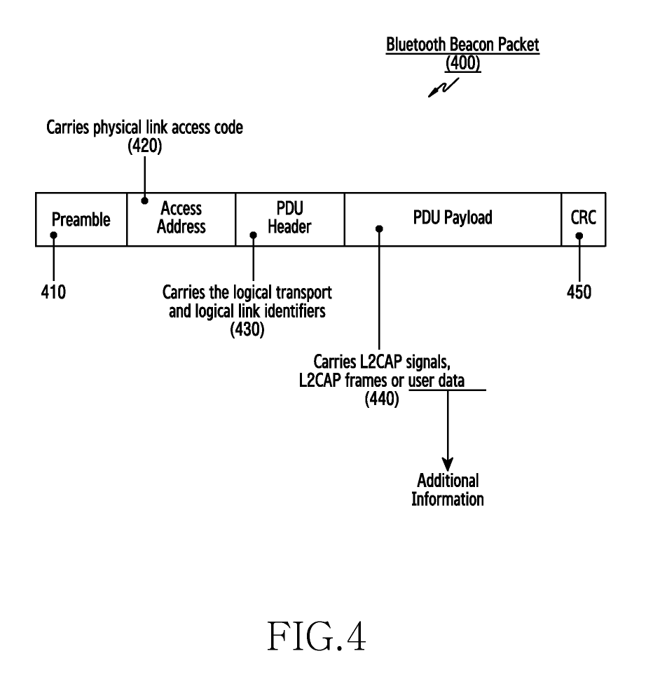

FIG. 4 illustrates the structure of a beacon packet 400 to which various embodiments of the present disclosure are applied. Referring to FIG. 4, the beacon packet 400 may include a preamble 410, an access address 420, a Packet Data Unit (PDU) header 430, a PDU payload 440, and a Cyclic Redundancy Check (CRC) 450.

The preamble 410 may include information relating to frequency synchronization, symbol timing estimation, and automatic gain control, the access address 420 may include information relating to a physical link access code, and the PDU header 430 may include information relating to logical transport and logical link identifiers.

The PDU payload 440 may include information relating to a Logical link Control and Adaptation Protocol (L2CAP) signal, L2CAP frames, or user data, and the CRC 450 may include information relating to data transmission error detection.

Further, the user data may be, for example, additional information to enable an electronic device of a user, who has visited a particular place, such as a venue, a restaurant, or a conference room, to access a particular site or a particular network and additionally acquire various contents. Here, the additional information may be called another name and may include data other than the user data in the payload within the beacon packet. Further, the acquisition may imply various operations including content downloading, content viewing, and streaming reception.

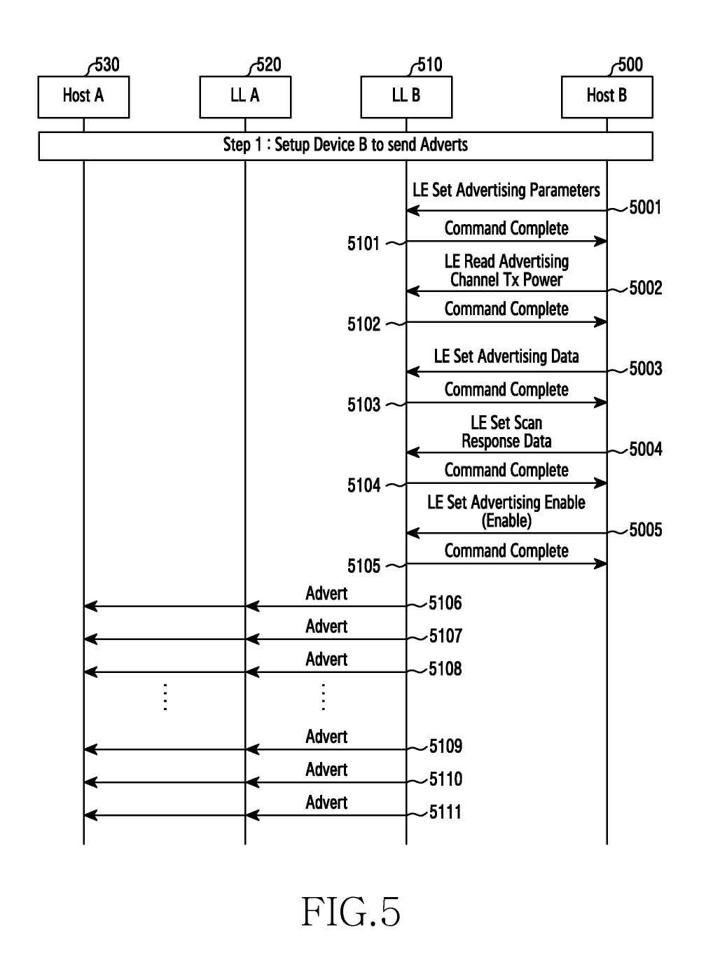

FIG. 5 illustrates an example transmission process of a beacon signal according to various embodiments of the present disclosure. Referring to FIG. 5, host B 500, which is one of various types of electronic devices, such as a smart phone and tablet PC, generates a beacon signal and transmits (e.g. through advertising) the beacon signal to host A 530, which is another electronic device.

In order to generate the beacon signal, the host B 500 sequentially performs operations of “set advertising parameters” 5001, “read advertising channel Tx power” 5002, “set advertising data” 5003, “set scan response data” 5004, and “set advertising enable” 5005 with respect to Link Layer B (LLB) 510 which corresponds to a beacon communication module.

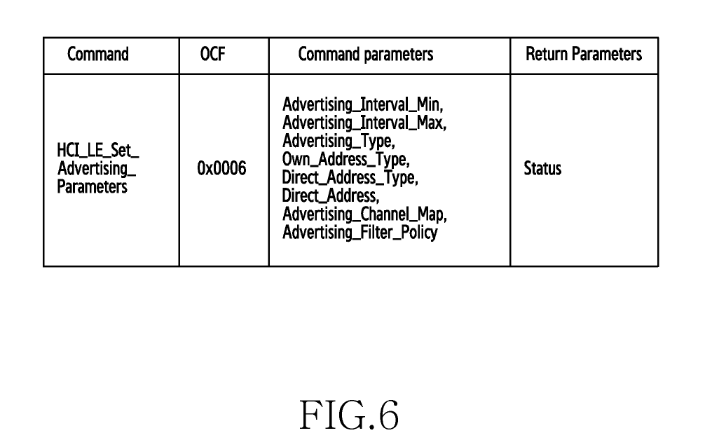

The link layer B 510 performs operations of “command complete” 5101, 5102, 5103, 5104, and 5105 in response to the above operations, and performs transmission (e.g. advertising) 5106 to 5111 of the beacon signal generated through the above process to surrounding terminals (e.g., by Link Layer A 520). The “set advertising parameters” operation 5001 is an operation for setting values included in advertising parameters and allows, for example, a transmission period of the beacon signal to be set in an advertising interval field thereof and a public device address or a random device address for receiving the beacon signal to be set in a direction address field thereof, as shown in FIG. 6.

The “read advertising channel Tx power” operation 5002 is an operation for reading the transmission power level used in order to transmit an advertising channel packet. The “set advertising data” operation 5003 is an operation for setting data to be transmitted through a beacon signal.

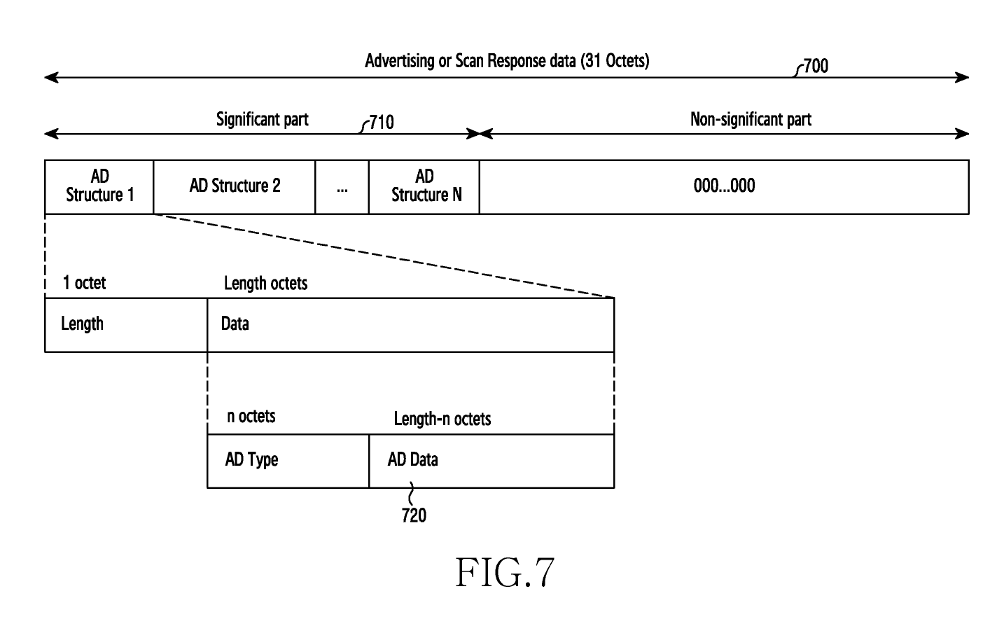

As shown in FIG. 7, the advertising or scan response data 700 is configured by 31 octets (or bytes), and the significant part 710 in FIG. 7 is transmitted through a beacon signal while the non-significant part filled with null data is not transmitted, in order to achieve the data length of 31 octets.

The ADvertising (AD) data 720 may include, for example, service UUIDs, local name, flags, manufacturer specific data, TX power level, security manager Out Of Band (OOB), security manager TK Value, slave connection interval range, service solicitation, and service data.

The manufacturer specific data, which is a field into which contents specified by a manufacturer are to be included, may include various contents, such as advertisement and URL, when transmitted, and may request start or stop of advertising in the “set advertising enable” operation 5005.

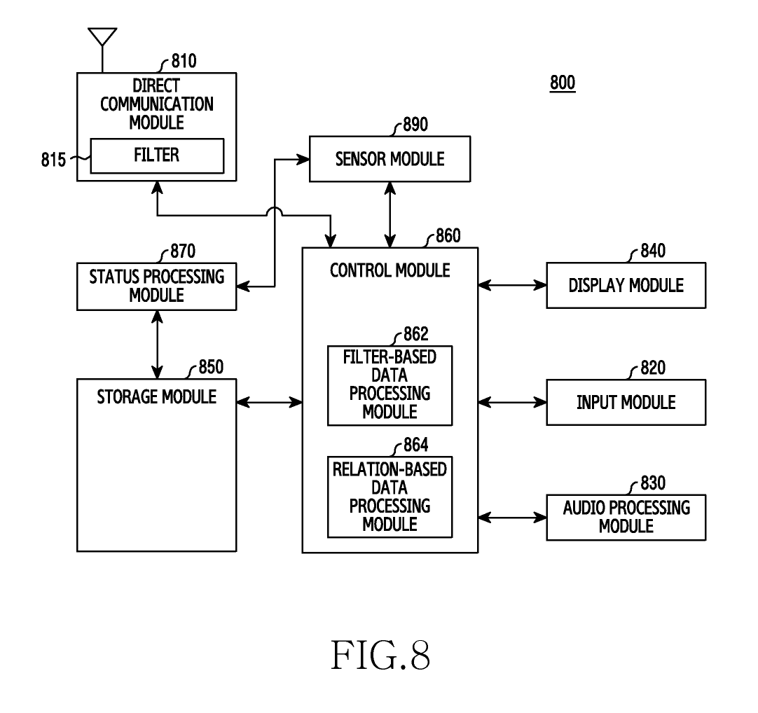

FIG. 8 is a block diagram showing some elements of an example electronic device 800 for filtering a beacon signal according to various embodiments of the present disclosure. Referring to FIG. 8, the electronic device 800 may include a direct communication module 810, a control module 860, a storage module 850, a status processing module 870, an input module 820, an audio processing module 830, a display module 840, and a sensor module 890. The electronic device 800 may further include other communication modules corresponding to the communication support type of the device, for example, a mobile communication module or a wired communication module.

Referring to FIG. 8, an example mobile electronic device 800 may be a device including a communication function. The communication module for providing a communication function in the electronic device may establish a communication between the electronic device 800 and another electronic device. The communication module 160 may support a predetermined communication protocol (for example, Wireless Fidelity (Wifi), Bluetooth (BT), Near Field Communication (NFC)) or predetermined network communication (for example, Internet, a Local Area Network (LAN), a Wire Area Network (WAN), telecommunication network, cellular network, satellite network, POTS (plain old telephone service), or the like.

The communication module may include a direct communication (or direct wireless communication) module 810. In the Device to Device (D2D) communication technology for direct wireless communication, data may be directly transmitted or received between devices without passing through a network. The direct communication module 810 may enable electronic devices to directly exchange data without passing through a base station. The direct communication module 810 may include at least one of a Long Term Evolution (LTE)-direct communication module, a WiFi-direct communication module, a BlueTooth (BT) communication module, a FlashLinQ communication module, an eye communication module proposed by Engineer and Electronics and Telecommunications Research Institute (ETRI), a 3GPP D2D (ProSe) communication module, a communication module applying a communication scheme defined by IEEE802.11aq, and a communication module applying a communication scheme defined by IEEE802.15PAC.

The electronic device 800 may establish a communication channel with at least one other electronic device capable of performing direct communication, using the direct communication module 810. The electronic device 800 may transmit or receive data on the basis of at least one of relation-based data processing and filter-based data processing. The relation-based data processing scheme may be a scheme in which data to be transmitted is divided into predetermined fragments and the entire data or a particular event is transmitted to another electronic device that receives the divided fragments. The filter-based data processing scheme may be a scheme for operating a filter in which pre-defined information is disposed in order to filter the data.

The input module 820 may process various input signals of the electronic device 800. The input module 820 may include various input devices which are embedded in the electronic device 800 or can be compatibly connected to the electronic device 800. For example, the input module 820 may include a physical element, such as a key button, a side key, a home key, or a power key. Further, the input module 820 may include may include touch type key buttons and keypad and a touch screen. Further, the input module 820 may include an element, such as a keyboard or a mouse, which is connected an external device connection interface arranged on the electronic device 800. The input module 820 as described above may generate an input signal for requesting activation or deactivation of a direct connection function on the basis of the direct communication module 810. For example, when the electronic device 800 provides a predetermined application operated on the basis of the direct communication module 810, the input module 820 may generate an input signal for requesting selection and activation of a corresponding application in response to a user control. Here, the input signal may be generated in various forms corresponding to the type of the input module 820. For example, the input signal may include a key input signal, a touch sensor-based touch gesture, or a motion sensor-based motion gesture.

The input module 820 may receive various input signals relating to the generation of the filter 815. The input module 820 may provide the received input signal to the control module 860. The input module 820 may generate (or process) an input signal for selecting a particular filter 815, an input signal for removing the selected filter 815, or an input signal relating to correction of information of the filter 815. When the electronic device 800 synthetically provides a relation-based data processing function or a filter-based data processing function, the input module 820 may generate a signal for selecting at least one of the functions described above in response to a user control.

The display unit 840 may output a screen relating to a management operation of the electronic device 800. For example, the display module 840 may provide a screen for making the filter 815, a screen for selecting the filter 815, a screen for displaying information of the filter 815 being applied, a screen for displaying a list of all filters 815, and a screen for describing characteristics of filters 815. According to various embodiments, in relation to the relation-based data processing function of the electronic device 800, the display module 840 may display at least one among a screen displaying received data fragments, a screen displaying the entire data generated by a combination of data fragments, information of another electronic device providing the data fragments, and information of a data file provided by another electronic device.

The display module 840 may output, through at least one among an image and a text, information on what data processing scheme is being applied during the execution of the direct connection function. The output image or text may be provided through a pop-up window which is temporarily or repeatedly output, or displayed through a particular icon or indicator in a status bar area. The display module 840 may output at least one among an image or text indicating relation-based data processing, an image or text indicating filter-based data processing, and an image or text indicating optimal condition data processing. Here, the image or text may be displayed in different ways relating to the processing schemes.

According to various embodiments, the display module 840 may include a display panel, a touch panel, or a touch sheet. For example, the display module 840 may operate as an input module. The touch panel or touch sheet may employ at least one among various touch schemes capable of detecting a hand touch, an electronic pen touch, or a general pen touch. For example, the touch panel or touch sheet may employ an electromagnetic induction scheme, a capacitance scheme, or a resistive scheme.

The audio processing module 830 may process audio information of the electronic device 800. The audio processing module 830 may output audio information stored in the electronic device 800 or audio information received from the outside. The audio processing module 830 may collect particular audio information in relation to the communication function or recording function of the electronic device 800. The audio processing module 830 may output, using the direct communication module 810, a guide sound or a sound effect for reporting discovery of another electronic device. The audio processing module 830 may output a guide sound or sound effect reporting activation of the direct connection function. Further, the audio processing module 830 may output various sound or sound effects according to the data transmission/reception status. The output of the guide sound or sound effect may be omitted according to the user configuration change or design purpose.

The storage module 850 may store data (e.g. audio contents, video contents, or text contents) operated in relation to various embodiments of the present disclosure. For example, the storage module 850 may store at least one among advertisement contents (such as coupon), music contents, image contents, movie contents, broadcast contents, photograph contents, fiction contents, and game contents. The data stored in the storage module 850 may be stored when the electronic device 800 is designed. According to one embodiment, the data stored in the storage module 850 may be received from another electronic device. According to various embodiments, the data stored in the storage module 850 may include contents generated by the electronic device 800.

The storage module 850 may store various information and programs in relation to the operation of the electronic device 800. For example, the storage module 850 may include information and a software module in relation to the relation-based data processing. The storage module 850 may store information and programs according to the filter-based data processing.

The storage module 850 may store at least one direct connection application supporting the direct connection function. The stored application may be an application for requesting activation of the direct communication module 810. For example, the direct connection application may be a game application which is executed through a communication channel established on the basis of the direct communication module 810. The direct connection application may be a data sharing application, a data broadcast application, or a data search application. Further, the direct connection application may be another electronic device search application or a particular file search application.

The storage module 850 may transmit stored data to the direct communication module 810 in response to a request from the control module 860. The data transmitted to the direct communication module 810 or particular information corresponding to the data may be transmitted through a broadcast scheme, a multi-cast scheme, or a unicast scheme. Further, the data may be transmitted to another electronic device to which a communication channel has been established. The data received through the direct communication module 810 may be stored in the storage module 850 according to the control of the control module 860.

The storage module 850 may store at least one filter and filter selection software module supporting filter-based data processing. The storage module 850 may store schedule information supporting at least one filter application.

The storage module 850 may be configured by various types of memories. The storage module 850 may, for example, include at least one of a volatile memory (e.g., a dynamic random access memory (DRAM), a static RAM (SRAM), or a synchronous dynamic RAM (SDRAM)) and a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory). According to various embodiments, the storage module 850 may be a Solid State Drive (SSD). The storage module 850 may further include, for example, a Compact Flash (CF), a Secure Digital (SD), a Micro Secure Digital (Micro-SD), a Mini Secure Digital (Mini-SD), an extreme Digital (xD), a memory stick, or the like.

The electronic device 800 having the above-described implementation may include the status processing module 870. The status processing module 870 supports filter-based data processing and may be implemented by a separate hardware module. The direct communication module 810 may be implemented in the form including at least one filter 815. The direct communication module 810 may include the implementation of a storage medium supporting storage of the filter 815 and may include a processor supporting the operation of the filter 815 stored in the storage medium. The filter 815 may be included in the status processing module 870 and may be disposed in the control module 860 according to the design scheme.

The electronic device 800 may select the filter 815 to be applied to the direct communication module 810 on the basis of the status information collected by the status processing module 870, and perform direct communication connection and discovery on the basis of the selected filter 815. The direct connection function may be a function of performing at least one among a function of transmitting data to another electronic device and a function of receiving data from another electronic device through the direct communication module 810 capable of transmitting data without passing through a network. The direct communication discovery (D2D discovery) function may include a function of discovering another electronic device using the direct communication module 810.

The status information collected by the status processing module 870 may include at least one among environment information, preference information, and schedule information. The electronic device 800 may apply a predetermined filter 815 to data transmission and reception on the basis of the collected status information. At this time, the electronic device 800 may generate a filter 815 corresponding to particular information provided by the status processing module 870 or apply one of pre-generated filters 815 to the operation of the direct communication module 810.

The environment information may include at least one among current time information, position or movement information of the electronic device 800, and information on another electronic device with which the electronic device 800 can establish a communication channel. The status processing module 870 may generate preference information on the basis of the history of using the electronic device by a user. The preference information may include at least one among application type information on applications having been activated at least once or more than a predetermined number of times, information of data transmitted or received through an application, application activation time information, information on connection with another electronic device through an application, and information on the type of data transmitted to or received from another electronic device through an application. The schedule information may be made by the user or automatically generated from contents included in a transmitted or received message or e-mail. In some examples, the status information may include not only the environment information, the preference information, and the schedule information as described above, but also alarm information, type information of a predetermined application, activation of which a user has requested, and various information generated during the operation of the predetermined application, such as application operation time and application operation place.

According to various embodiments of the present disclosure, the electronic device 800 may include various sensor module 890 and collect status information using the sensor modules. For example, the electronic device 800 may include a position information collecting module connected to at least one of the status processing module 870 and the control module 860, an acceleration sensor, a gyro sensor, a geomagnetic sensor, an altitude sensor, a pressure sensor, a temperature sensor, and a humidity sensor. Further, the sensor module 890 may include at least one of an atmospheric pressure sensor, a magnetic sensor, a grip sensor, a proximity sensor, a Red, Greed, and Blue (RGB) sensor, a bio sensor, an illumination sensor, and an Ultra Violet (UV) sensor. The sensor module 890 may measure a physical quantity or detect an operation state of the electronic device 800 and convert the measured or detected information to an electric signal. According to various embodiments of the present disclosure, the sensor module 890 may include a E-nose sensor, an electromyography (EMG) sensor, an electroencephalogram (EEG) sensor, an electrocardiogram (ECG) sensor, or a fingerprint sensor. The sensor module 890 may further include a control circuit for controlling one or more sensors included in the sensor module.

The control module 860 may include at least one among a filter-based data processing module 862 and a relation-based data processing module 864. The data processing module 862 and 864 may include at least one combination or two or more combinations of a hardware module, a middleware module, a firmware module, and a software module.

When the electronic device 800 manages the data processing modules 862 and 864 as described above, the storage module 850 may store, in the form of modules, commands or routines supporting the data processing modules 862 and 864. According to one embodiment, when the electronic device 800 supports the data transmission and reception through relation-based data processing, the control module 860 may include the relation-based data processing module 864 while the storage module 850 may store a software module supporting the relation-based data processing. According to one embodiment, when the electronic device 800 supports the data transmission and reception through filter-based data processing, the control module 860 may include the filter-based data processing module 862. Accordingly, the storage module 850 may store filters and a filter selection unit supporting the filter-based data processing. The control module 860 shown in FIG. 8 may be configured to include one processing module as described above.

According to various embodiments of the present disclosure, the configuration of the control module 860 described with reference to FIG. 8 may be implemented to include a plurality of processing modules according to the design scheme.

According to various embodiments, when the electronic device 800 is designed to support both the relation-based data processing and the filter-based data processing, the control module 860 may include both the relation-based data processing module 864 and the filter-based data processing module 862. Accordingly, the storage module 850 may store at least one filter and filter selection software module supporting filter-based data processing, and a software module including routines supporting relation-based data processing. Further, the storage module 850 may store a software module or schedule information configured to differently apply the relation-based data processing routine according to the selected filter. Otherwise, the storage module 850 may store a software module or schedule information including routines providing different filters according to the relation-based data processing schemes.

Each processing module of the control module 860 may be implemented as an independent processor or be implemented through allocation of a task or thread by one processor. In this operation, the processor or task may synthetically or sequentially manage schemes relating to pre-defined schedule information or program routines. According to one embodiment, the control module 860 may manage the filter-based data processing module 862 to first select filters satisfying the current status or status according to pre-configured schedule information. Further, the control module 860 may control the operation of the relation-based data processing module 864, using at least one selected filter.

The schedule information, parameters, or software module may be implanted in a particular hardware module in an embedded form or be placed in a memory arranged in a particular hardware module, instead of being stored in the storage module 850. For example, in various embodiments of the present disclosure, the particular processing module may be implemented in the form in which it is included in the direct communication module 810. Otherwise, at least a part of the particular processing module may be implemented as a separate hardware module disposed between the direct communication module 810 and the control module 860.

When a request for activation of the direct connection application among the applications stored in the storage module 850 is generated, the control module 860 may control the operation of the status processing module 870 and the direct communication module 810. In this event, the control module 860 may select at least one filter 815 to be applied to the direct communication module 810 in relation to the operation of the status processing module 870. Further, the control module 860 may control processing of data received by the direct communication module 810 on the basis of the selected filter 815 or may transmit data on the basis of the selected filter 815. When at least one filter 815 is disposed in the direct communication module 810 or the status processing module 870, the control module 860 may process the data filtered by the filter 815.

For example, when the at least one filter 815 is disposed in the direct communication module 810 and used for processing of received data, the control module 860 may maintain the current function operation state or sleep state of the electronic device 800 up to before data matching the filter 815 is found or received. Further, when the data matching the filter 815 has been received, the control module 860 may perform processing according to the reception of the data, for example, may output notification of the data reception to the display module 840 or store the received data in the storage module 850. In this operation, before the reception of the data matching the filter 815, the electronic device 800 may collect the status information of the electronic device 800 and process the direct connection function without the operation of changing the function operation state, such as awakening from the sleeping state by the control module 860. When data matching the filter 815 is received in a predetermined function operation state, the control module 860 may perform a background processing to process the received data. For example, when receiving filtered data in a video reproduction state, the control module 860 may process the filtered data through background processing while maintaining the video reproduction state.

In this event, the control module 860 may apply at least one filter 815 to the direct communication module 810 in relation to the status information collected by the status processing module 870. According to one embodiment, the status processing module 870 may apply a predetermined filter 815 to the direct communication module 810 in relation to the collected status information. Otherwise, the direct communication module 810 may select a predetermined filter 815 in relation to the status information collected by the status processing module 870.

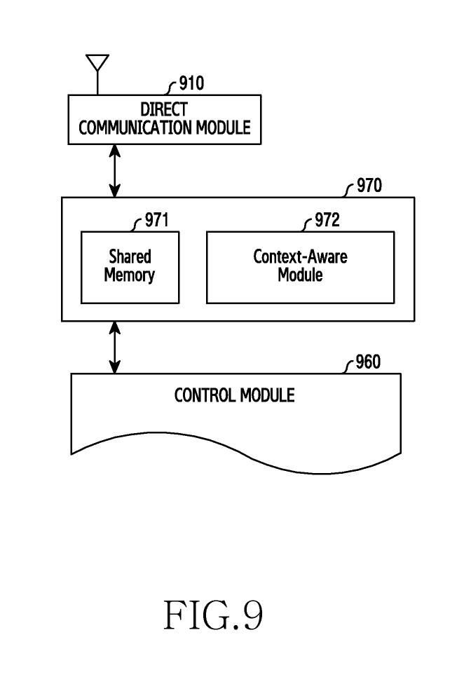

FIG. 9 schematically illustrates the configuration of a status processing module 970 according to various embodiments of the present disclosure. Referring to FIG. 9, the status processing module 970 may include a shared memory 971 and a context-aware module 972. The status processing module 970 may be implemented in the form in which it is included in a direct communication module 910 or a control module 960.

The shared memory 971 may temporarily store the data received by the direct communication module 910. Further, the shared memory 971 may temporarily store data to be transmitted through the direct communication module 910. The shared memory 971 supports data reading or writing of the direct communication module 910 and may support data reading or writing of the control module 960. The status processing module 970 may perform scheduling in order to prevent occurrence of violation on the sharing in relation to the data reading or writing operation using the shared memory 971. The shared memory 971 may store file information broadcasted by another electronic device, file information to be transmitted to another electronic device, and at least one filter. The shared memory 971 may temporarily store the status information collected by the context-aware module 972. The temporarily stored status information may be used as reference information for selecting a particular filter to be applied to the direct communication module 910. Here, when the selection of the filter is performed by the control module 960, the control module 960 may identify the status information stored in the shared memory 971, select a corresponding filter, and apply the selected filter to the direct communication module 910. According to one embodiment, when the status processing module 970 is designed to select the filter, the status information stored in the shared memory 971 may be used as reference information in selecting the filter by the context-aware module 972.

The context-aware module 972 may collect the status information of the electronic device 800. The context-aware module 972 may apply a predetermined filter to the direct communication module 910 on the basis of collected status information. According to various embodiments, when a filter is disposed in the direct communication module 910, the context-aware module 972 may select a particular filter within the direct communication module 910 on the basis of the status information.

The context-aware module 972 may have an authority to apply a particular filter to the direct communication module 910 in relation to status information. When at least one filter is stored in the direct communication module 910, the context-aware module 972 may control the direct communication module 910 without control of the control module 960 to select a particular filter according to the status information. Through the above process, the context-aware module 972 may support the status processing module 970 to control the direct communication module 910, without breaking or interrupting the state of the control module 960 which is in either a sleep state or a state of operating a particular application.

For example, a user may want to receive predetermined data. In this operation, the occurrence of the data reception may be an event which satisfies user needs rather than generating inconvenience, such as interference. In contrast, in the operation of transmitting the predetermined data stored in the storage module 850 to another electronic device, if an interruption is generated in an electronic device operation, the user may recognize the generation of the interruption as inconvenience. The electronic device 800 according to various embodiments of the present disclosure may prevent the particular operation state or sleep state of the control module 960 from changing. For example, the electronic device 800 may support direct access of the status processing module 970 to the storage module 850 of the context-aware module 972 and support data reading and writing operations according to the direct access. In the case of the direct access to the storage module 850, the control module 960 does not perform a control operation and thus can maintain the previous function operation state or sleep state even during the data processing operation. The data reading and writing operations may include at least one operation among an operation of reading a filter stored in the storage module 850, a reading operation in the operation of transmitting particular data, and an operation of writing data received by the direct communication module 910 in the storage module 850.

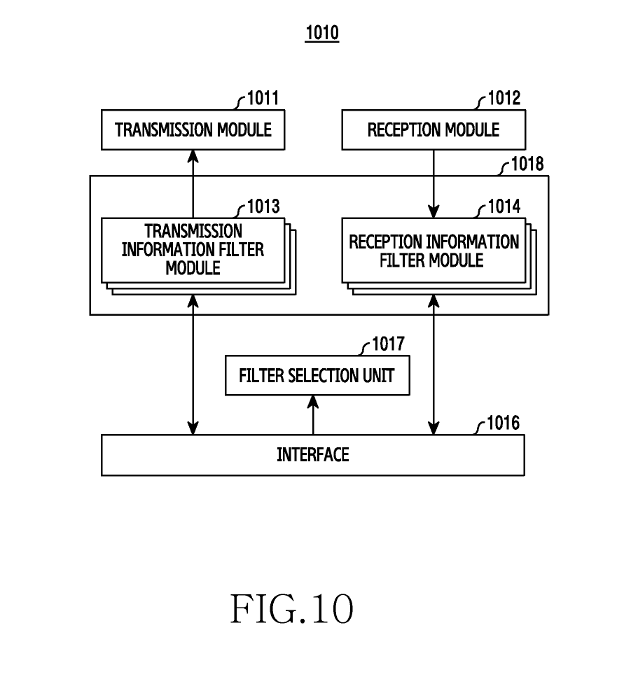

FIG. 10 schematically illustrates the configuration of a direct communication module 1010 according to various embodiments of the present disclosure. Referring to FIG. 10, the direct communication module 1010 may include a transmission module 1011, a reception module 1012, a filter module 1018, an interface 1016, or a filter selection unit 1017. According to one embodiment, the filter module 1018 may include at least one among a transmission information filter module 1013 and a reception information filter module 1014. According to one embodiment, the direct communication module 1010 may be configured to include the transmission module 1011 and the reception module 1012. According to one embodiment, the transmission information filter module 1013, the reception information filter module 1014, the interface 1016, and the filter selection unit 1017 may be configured to be included in the status processing module 870. Otherwise, the transmission information filter module 1013, the reception information filter module 1014, the interface 1016, and the filter selection unit 1017 may be configured to be included in the control module 960. Hereinafter, an embodiment in which the direct communication module 1010 includes all the elements described above will be described.

The transmission module 1011 may output information relating to search of particular contents desired by a user or information for requesting provision of particular contents. The transmission module 1011 may output search information for searching for another electronic device having predetermined data, such as music contents, movie contents, text contents, coupon, or other information. The transmission module 1011 may output predetermined transmission information through transmission information filter module 1013. For example, when a filter requesting a particular music file is disposed in the transmission information filter module 1013, the transmission module 1011 may output information for searching for another electronic device having the particular music file according to a broadcast scheme, a multicast scheme, or an advertising scheme. When a filter requesting a particular coupon is disposed in the transmission information filter module 1013, the transmission module 1011 may transmit information for searching for another electronic device providing the particular coupon according to a broadcast scheme, etc.

The reception module 1012 may receive requested contents relating to the filter from another electronic device through the transmission module 1011. The contents received by the reception module 1012 may be stored in the storage module 850. For example, when multiple other electronic devices possessing the requested contents exist, the reception module 1012 may receive the contents from an electronic device selected among the multiple electronic devices. According to one embodiment, the reception module 1012 may select at least one electronic device having a data transmission environment exceeding a predetermined level or an electronic device having the best data transmission environment. Otherwise, the reception module 1012 may first select another electronic device which has ever transmitted or received contents before.

The reception module 1012 may receive data requesting predetermined contents from another electronic device. In a state of having received the request for the predetermined contents from another electronic device, when the contents have been stored in the storage module 850, the transmission module 1011 may automatically transmit the contents to the another electronic device. In this event, in relation to the design scheme, the transmission of the contents by the transmission module 1011 may be performed through the control of the status processing module 870 or the direct control of the direct communication module 910 without intervention of the control module 960.

The transmission information filter module 1013 may include at least one filter selected in relation to the operation of the transmission module 1011. The transmission information filter module 1013 may include information including the data type and data name of data to be transmitted through the direct communication module 910. For example, the transmission information filter module 1013 may include at least one filter among a weather information request filter, a traffic information request filter, a parking lot empty slot information request filter, a battery charging station position information request filter, a restaurant position information request filter, a game participation request filter, a particular content information request filter, a shop information filter, a business type filter, and an application filter. In the case of including multiple filters, the transmission information filter module 1013 may include a switch enabling selection of a predetermined filter. Information placed in the transmission information filter module 1013 may be placed or recorded by a user using the input module 820. In this operation, the transmission information filter module 1013 may request the control module 960 to output an input window supporting input of a particular filename when applying a music file request filter or a move file request filter. In some embodiments, the particular filename may be automatically input on the basis of the search information history reflecting the recent search by the user.

The reception information filter module 1014 may include at least one filter selected in relation to the operation of the reception module 1012. The reception information filter module 1014 may include information including the data type or particular data name to be provided to another electronic device through the direct communication module 810. The reception information filter module 1014 may include a filter to be applied correspondingly to the type of an application on the basis of the direct communication module 810 when the application is activated. For example, the reception information filter module 1014 may include at least one among a music file providing filter to be applied when a music application is executed and a movie file providing filter to be applied when a video application is executed. The filter information placed in the music file providing filter or the movie file providing filter may be extracted from the corresponding file and defined in advance. Otherwise, the filter information placed in the filter may be recorded or corrected by a user. In the case of including multiple filters, the reception information filter module 1014 may include a switch enabling selection of a predetermined filter.

The filter selection unit 1017 may select at least one filter included in the transmission information filter module 1013 in accordance with a predetermined condition. For example, the filter selection unit 1017 may first select a filter supporting a corresponding function among a plurality of filters included in the transmission information filter module 1013 at the time of operating a particular application on the basis of the activated direct communication module 910. The filter selection unit 1017 may select a particular music file request filter when a music player is activated or a particular movie file request filter when a video player is activated.

The filter selection unit 1017 may select a time-related filter, a place-related filter, or a device matching filter correspondingly to the time, place, or device characteristic. For example, the filter selection unit 1017 may select a filter relating to a predetermined time point when it becomes the predetermined time point. The filter selection unit 1017 may identify the current position of the electronic device 800 and select a predetermined place-related filter when the current position is a position relating to the predetermined filter. When it becomes a predetermined time point in a state where the electronic device 800 is located at a predetermined position, the filter selection unit 1017 may select a device matching filter. The time-related filter, the place-related filter, and the device matching filter selected by the filter selection unit 1017 may be placed in at least one of the reception information filter module 1014 and the transmission information filter module 1013 in relation to the corresponding filter characteristic.

The time-related filter may be a filter supporting processing of data to be received or transmitted at a predetermined time point. For example, the time-related filter may include a filter relating to transmission or reception of music information selected at 7 am, a food information transmission/reception filter selected at 12 pm, a cultural life information reception filter selected at 7 pm, or a particular public transportation information reception filter. Further, the time-related filter may include a movie content transmission/reception filter selected at 2 pm or an advertisement information transmission/reception filter selected at 6 pm.

The place-related filter may include a filter which has been pre-defined and can be selected at a predetermined place or a filter generated by a user. The place-related filter may include various filters corresponding to places, including a home broadcast information reception filter, an office broadcast information transmission or reception filter, a coupon information transmission/reception filter, a local guide information transmission/reception filter, a restaurant information transmission/reception filter, a move information transmission/reception filter, or a parking-related information reception filter.

According to one embodiment, the place-related filter may include a security filter which differently defines a list of contents to be provide to another electronic device correspondingly to the degree of approach to another electronic device. The degree of approach to another electronic device may be determined on the basis of the intensity of transmission/reception signals between the direct communication module 910 and another electronic device and through transmission or reception of position information of each device. In relation to selection of a particular filter at a particular place, the electronic device 800 may include a position information collection module (not shown) supporting collection of position information. The position information collection module may be connect to the control module 960 to provide position information thereto or be connect to the status processing module 970 to provide collected position information to the status processing module 970.

The device matching filter may include an another electronic device search transmission and reception filter for other electronic device registered in a phone book, an another electronic device search transmission and reception filter for other electronic device registered in a messenger program, and an another electronic device search transmission and reception filter for other electronic device ever having transmitted or received a message. The device matching filter may include a transmission filter for searching for another electronic device having a pre-defined name or a name input by a user and a reception filter for receiving an electronic device having a predetermined name found through search. The device matching filter may operate in association with a place-related filter or a time-related filter. For example, the device matching filter may be used as a filter relating to search for a predetermined device in at least one a status among predetermined status having predetermined time points and predetermined places, respectively.

The electronic device 800 may provide a filter generating screen in relation to making or generation of a filter. The filter generation screen may include an input box into which at least one among filter application time information, filter application place information, filter application another electronic device information, or filter characteristic definition information can be input. A user may generate a filter by inputting at least one among a transmission or reception scheme, place, and time in relation to sharing of predetermined data. According to one embodiment, the data sharing may include music sharing, movie sharing, coupon sharing, report or notification sharing, or traffic information sharing. In one embodiment, the generated filter may be stored in the storage module 850 or loaded in the direct communication module 910. Among filters stored in the storage module 850, a filter relating to information collected by the status processing module 970 is selected and is provided to the direct communication module 910.

The interface 1016 may enable signal transmission between the direct communication module 910 and the status processing module 970. Further, according to one embodiment, the interface 1016 may enable signal transmission between the direct communication module 910 and the control module 960. The interface 1016 may transmit a signal relating to filter replacement or filter correction of the transmission information filter module 1013 and the reception information filter module 1014. The interface 1016 may transmit data transmitted by the control module 960 to the transmission information filter module 1013. The interface 1016 may transmit data, which is received by the reception module 1012 and filtered by the reception information filter module 1014, to the control module 960.

According to various embodiments, the electronic device 800 may include at least one filter having filer information relating to selection of at least one among a transmission/reception module for transmitting or receiving data using a communication channel on the basis of a wireless communication, data transmitted through the communication channel formed by the transmission module 1011, data received through the communication channel formed by the reception module 1012.

According to various embodiments, the filter may be applied to at least one among the reception information filter module 1014 for selecting data to be received through the reception module 1012 and the transmission information filter module 1013 for selecting data to be transmissible through the transmission module 1011.

According to various embodiments, the electronic device 800 may further include a filter selection unit 1017 for selecting filter information for data selection of at least one of the transmission information filter module 1013 and the reception information filter module 1014 according to at least one among time, place, and information of another electronic device connected through the direct wireless communication.

According to various embodiments, the electronic device 800 may further include a control module configured to control at least one among the transmission module 1011, the reception module 1012, and the filter selection unit 1017.

According to various embodiments, the control module 960 may change the operation state of the control module 960 when data filtered by a filter placed in the transmission information filter module 1013 is received through the reception module 1012. Further, when the data filtered by a filter placed in the reception information filter module 1014 is received through the reception module 1012 or contents corresponding to the received data is transmitted through the transmission module 1011, the control module 960 may maintain the previous operation state of the control module 960.

According to various embodiments, the control module 960 may set devices transmitting the data filtered by the filter as candidates to be connected through the wireless communication.

According to various embodiments, the electronic device 800 may further include a display module 840 for displaying at least one piece of data received by the reception information filter module 1014.

According to various embodiments, the electronic device 800 may further include a sensor module 890 including at least one sensor generating a particular sensor signal corresponding to the status information of the electronic device 800 and a status processing module 970 for identifying the status information on the basis of a signal generated by the sensor module 890 and making a control to apply the at least one filter 815 to the transmission information filter module 1013 or the reception information filter module 1014 according to the status information.

According to various embodiments, the filter 815 may have at least one grade corresponding to the degree of allowance for access thereto by another device.

A machine-readable device storing commands therein may include a configuration of a storage medium configured to, when the commands are executed by at least one processor, make the at least one processor perform at least one operation including at least one among a first data processing operation, which selects at least one piece of data among data transmitted and received on the basis of the wireless communication through a filter having particular information placed therein, and a second data processing operation, which makes a control to sequentially broadcast or respond data fragments to another electronic device on the basis of the wireless communication or provide a particular event or contents to another electronic device responding to at least some data fragments.

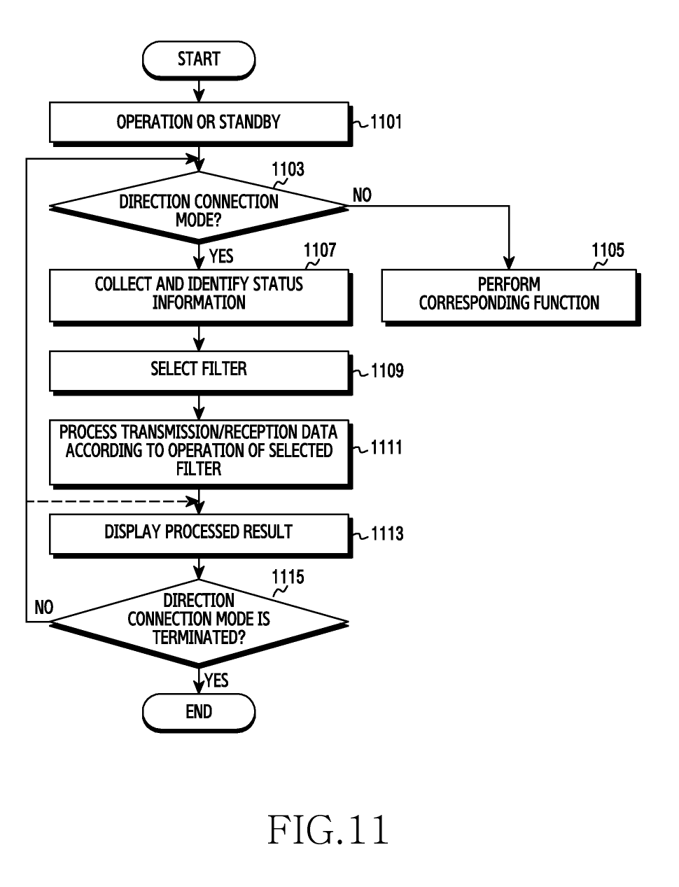

FIG. 11 is a flowchart showing an example filter-based data processing method according to various embodiments of the present disclosure.

In various embodiments of the present disclosure, in operation 1101, for example, the control module 960 may operate a predetermined function according to predetermined schedule information or a predetermined function according to a user request. Otherwise, the control module 960 may perform a function standby in operation 1101. According to one embodiment, the control module 960 may output a standby screen, activate a function according to a request, or control outputting of a screen of an activated function to the display module 840. According to one embodiment, the control module 960 may maintain the sleep state of the display module having the turn-off state.

In operation 1103, for example, the control module 960 may determine whether an event relating to direct connection/discovery mode activation is generated. In this operation, when an event relating to direct connection/discovery mode activation is not generated, the control module 960 may proceed to operation 1105. In operation 1105, for example, the control module 960 may control execution of a pre-configured function or a predetermined function. According to one embodiment, the control module 960 may maintain the activation of the function being performed in operation 1101. An input event relating to the activation of the direct connection/discovery mode may include an event relating to selection and activation of a predetermined application operating on the basis of the direct communication module 910. For example, the electronic device 800 may provide a screen, which enables selection of an application on the basis of the direct communication module 910, through the display module 840. According to one embodiment, the electronic device 800 may output icons or menu items corresponding to respective applications to the display module 840. When a touch event relating to selection of an application is generated, the control module 960 may recognize the touch event as an event relating to the direct connection/discovery mode activation.

In operation 1103, for example, when an operation of a predetermined filter is requested, the control module 960 may recognize this request as an event relating to direct connection/discovery mode activation. As described above, the electronic device 800 may operate a time-related filter or a place-related filter. In this operation, in a status corresponding to configured time or place, the control module 960 may perform a direct connection/discovery function according to application of the filter. According to various embodiments, the control module 960 may automatically activate a direct connection/discovery mode. When the direct connection/discovery mode is automatically activated, operation 1103 may be omitted.

In operation 1107, for example, the control module 960 can identify the status information when an event relating to direct connection/discovery mode activation is generated. According to one embodiment, the status processing module 970 may collect status information of the electronic device 800 by using at least one sensor correspondingly to the direct connection/discovery mode activation or by identifying pre-stored schedule information or current time. When the direct connection/discovery mode is automatically activated, the control module 960 may perform a status information identification operation in real time or at a predetermined cycle in operation 1107.

In operation 1109, for example, the control module 960 may select a filter according to status information. According to one embodiment, the control module 960 may select at least one among a transmission information filter and a reception information filter in relation to the type information of a particular application having request the direct connection/discovery mode activation. Otherwise, the status processing module 970 may select a filter according to the status information. Otherwise, the direct communication module 910 may select a filter according to the status information. According to various embodiments, the direct communication module 910 may receive status information from the status processing module 970. The direct communication module 910 may have a software module mounted therein, which performs selection of a predetermined filter according to the status information.

In operation 1111, for example, the control module 960 may operate the selected filter to process transmission/reception data. According to one embodiment, the control module 960 may select a traffic information reception filter in operation 1109 and may receive traffic information from another electronic device placed adjacent thereto in operation 1111. In operation 1113, for example, the control module 960 may control outputting of a result according to the data processing to the display module 840. According to one embodiment, the control module 960 may control outputting of traffic information to the display module 840.

According to one embodiment, when a near distance game participant recruiting filter is selected in the filter selection operation in operation 1109, the control module 960 may broadcast recruitment of participants in a particular game in operation 1111. Further, when receiving a reply relating to the game participation from another electronic device, the control module 960 may establish a communication channel with another electronic device and perform a control relating to the game play while outputting a corresponding screen in operation 1113.

In operation 1115, for example, the control module 960 may identify the generation of an input event relating to mode termination. When an input event relating to the mode termination is not generated, the control module 960 may proceed to operation 1103. Otherwise, the control module 960 may perform a control to maintain operation 1113. The input event relating to the mode termination may include a request for termination of a particular game or a request for termination of an application on the basis of the direct communication module 910.

According to various embodiments, a method of transmitting or receiving data using a wireless communication may include the operations of: selecting a transmission filter that filters data to be transmitted on the basis of wireless communication or a reception filter that filters data to be received on the basis of a wireless communication; and transmitting the data filtered by the transmission filter or receiving the data filtered by the reception filter.

According to various embodiments, the operation of selecting may further include an operation of selecting filter information for data selection of at least one of the transmission filter and the reception filter according to at least one among time, place, and information of another electronic device connected through the direct wireless communication.

According to various embodiments, the method may further include an operation of changing the operation state of the control module 960 when the data filtered by the transmission filter is received.

According to various embodiments, the method may further include an operation of maintaining a previous operation state of the control module 960 when the data filtered by the reception filter is received or when contents corresponding to the received data are transmitted.

According to various embodiments, the method may further include the operations of: collecting a predetermined sensor signal generated according to a status of the electronic device 800; collecting status information on the basis of the collected sensor signal; and selecting a predetermined filter according to the collected status information.

According to various embodiments, the method may further include at least one operation among the operations of: setting the filter information as a grade of unsearchable by another electronic device; setting the filter information as a grade utilizing predetermined security level for reception thereof; and setting the filter information as a grade enabling automatic transmission thereof.

According to various embodiments, the method may further include an operation of setting devices transmitting the data filtered by the filter as candidates to be connected through the wireless communication.

According to various embodiments, the method may further include an operation of displaying at least one piece of data which is received after being filtered by the reception filter.

According to various embodiments, the method may further include the operations of: dividing the filter information into data fragments; and sequentially broadcasting the data fragments and providing a predetermined event or contents to another electronic device which responds to the broadcasting or some of the broadcasted data fragments.

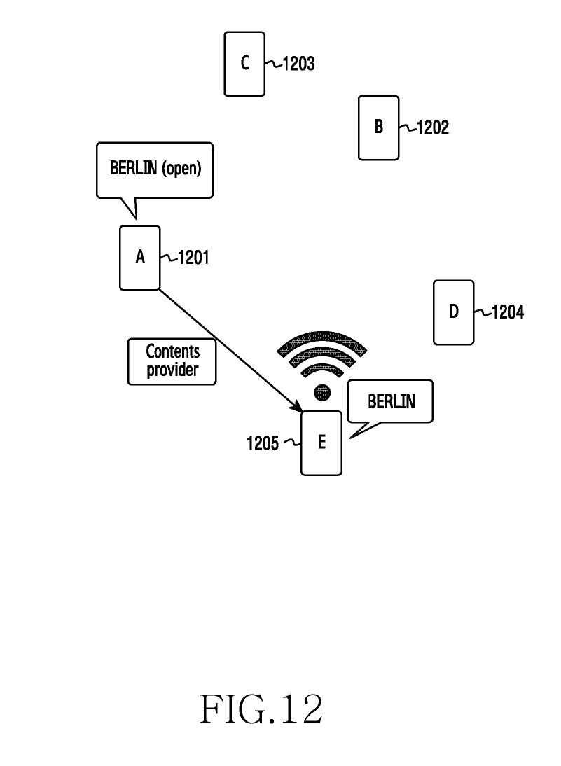

FIG. 12 illustrates filter-based data transmission or reception according to various embodiments of the present disclosure. In the following description, each of electronic devices 1201, 1202, 1203, 1204, and 1205 may be a device including a direct communication module which enables direct wireless communication (Device to Device communication; D2D communication) without passing through a network or operation of a base station. Each of such electronic devices 1201, 1202, 1203, 1204, and 1205 may be a device including the elements described above with reference to FIGS. 8 to 10.

Referring to FIG. 12, first to fifth electronic devices 1201, 1202, 1203, 1204, and 1205 may be arranged within a predetermined range. The predetermined range may be an area in which a communication channel can be established between the first to fifth electronic devices on the basis of the direct communication module 910 without operation of a base station. Each of the first to fifth electronic devices 1201, 1202, 1203, 1204, and 1205 may include a direct communication module 910 and may have a communication operation standby state.

Meanwhile, according to one embodiment, the fifth electronic device 1205 may enter the predetermined range in which the first to fourth electronic devices 1201, 1202, 1203, and 1204 are located. The fifth electronic device 1205 may request transmission of a particular file by activating the direct communication module 910 (of FIG. 9) while entering the predetermined range in which the other electronic devices are located. For example, the fifth electronic device 1205 may request transmission of at least one file relating to a movie entitled “Berlin”. The fifth electronic device 1205 may apply a filter requesting the movie entitled “Berlin” to the transmission information filter module 1013. For example, the fifth electronic device 1205 may apply a filter requesting a file including a text “Berlin” in a filename or contents thereof to the transmission information filter module 1013. The fifth electronic device 1205 may broadcast the request for the file through the transmission module 1011 in real time or at a predetermined cycle after the application to the transmission information filter module 1013.

The first to fourth electronic devices 1201, 1202, 1203, and 1204 may receive a request for transmission of the movie entitled “Berlin” from the fifth electronic device 1205. Among the electronic devices, the first electronic device 1201 may transmit the movie file entitled “Berlin” to the fifth electronic device 1205 when it has found the movie file in the storage module. In this event, the first electronic device 1201 may automatically establish a communication channel with the fifth electronic device 1205 in response to the request from the fifth electronic device 1205 and automatically transmit the move file.

According to one embodiment, the movie entitled “Berlin” may be stored in another electronic device as well as the first electronic device 1201. Then, the fifth electronic device 1205 may select an electronic device from which it will receive the movie file among the first to fourth electronic devices 1201, 1202, 1203, and 1204 according to at least one predetermined condition. For example, the at least one condition may include at least one among the movement status of the devices, previous communication history between devices, user appointment, and wireless environment between devices. The previous communication history condition may be used to first select an electronic device having received data from or transmitted data to the fifth electronic device 1205 when the electronic device is included in the first to fourth electronic devices 1201, 1202, 1203, and 1204. In relation to the user appointment condition, the fifth electronic device 1205 may output, to the display module 840, a list of the first to fourth electronic devices 1201, 1202, 1203, and 1204 connected on the basis of the direct communication module 910. The wireless environment condition may be used to select an electronic device currently having the best wireless environment in relation to the fifth electronic device 1205. The wireless environment condition may include a wireless signal reception intensity, a data rate, or an error rate. At least one of the predetermined conditions as described above may be as an optimal condition for grouping of one or more other electronic devices into a data transmission/reception candidate group or select another electronic device to which data is to be transmitted.

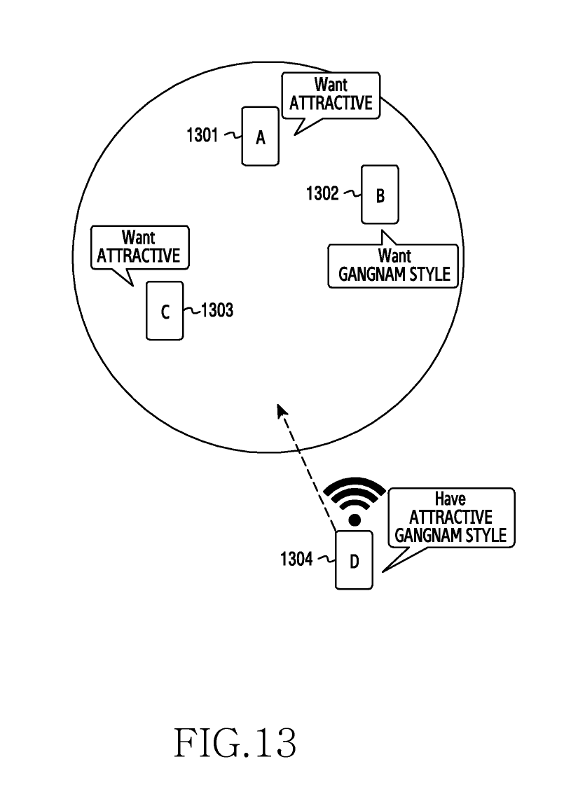

FIG. 13 illustrates filter-based data transmission or reception according to another embodiment among various embodiments of the present disclosure. In the following description, each of electronic devices 1301, 1302, 1303, and 1304 may be a device including a direct communication module which enables direct wireless communication (Device to Device communication; D2D communication) without passing through a network or operation of a base station. Each of such electronic devices may be a device including the elements described above with reference to FIGS. 8 to 10.

Referring to FIG. 13, the first to third electronic devices 1301, 1302, and 1303 may form a predetermined group on the basis of a mobile wireless access point. Further, the fourth electronic device 1304 may enter a predetermined area in which the predetermined group of electronic devices is located. Then, the first to fourth electronic devices 1301, 1302, 1303, and 1304 may transmit or receive information on desired data to each other to share information on what electronic device wants to receive the data, what data the electronic device wants to receive, what electronic device has the data, and what data the electronic device has, etc. In this operation, the first to third electronic devices 1301, 1302, and 1303 may pre-configure a reception information filter module 1014 and a transmission information filter module 1013. A filter including information of a list of data which a user of the electronic device wants to receive may be disposed or recorded in the reception information filter module 1014. A filter including information of a list of data which the electronic device can transmit may be disposed or recorded in the transmission information filter module 1013.

Referring to the illustrated figure, the first electronic device 1301 and the third electronic device 1303 operate a reception information filter (e.g., “Want”) which indicates a desire to receive a file having a filename “Attractive,” corresponding to filter information. The second electronic device 1302 operates a reception information filter (e.g., “Want”) in which information desiring to receive a file having a filename “Gangnam style,” corresponding to filter information is disposed. The fourth electronic device 1304 operates a transmission information filter (e.g., “Have”) which already possesses files “attractive” and “Gangnam style,” and further indicates the capability of providing the files to other terminals.

Once the fourth electronic device 1304 enters the group of the first to third electronic devices 1301, 1302, and 1303 and transmits or receives information on the filter through the direct communication module 910, the information as described above can be shared. For example, the “Gangnam style” file stored in the fourth electronic device 1304 may be automatically transmitted to the second electronic device 1302. For example, the “attractive” file stored in the fourth electronic device 1304 may be automatically transmitted to the first electronic device 1301 or the third electronic device 1303. The first to fourth electronic devices 1301, 1302, 1303, and 1304 may broadcast information of a configured filter at a predetermined cycle or in real time.

According to one embodiment, when the file transmission scheme is set as “transmission according to selection after notification”, the fourth electronic device 1304 may output information indicating that a particular electronic device requests for transmission of a particular file. The fourth electronic device 1304 may transmit data corresponding to the file when the user allows the transmission of the file. According to one embodiment, the transmission or reception of the data may be performed in accordance with payment of a predetermined credit. As used herein, the credit may be a standardized content payment means, such as electronic money or electronic coin. For example, the first electronic device 1301 may express an intention to pay a predetermined credit while requesting the fourth electronic device 1304 to transmit the “attractive” file. Otherwise, the first electronic device 1301 may request the transmission of the “attractive” file while paying/transmitting a predetermined credit determined by the fourth electronic device 1304. The fourth electronic device 1304 may automatically transmit the “attractive” file without a separate allowance operation to the first electronic device 1301 having paid a predetermined credit.

The embodiment described above corresponds to an example in which a filename is defined as filter information. Here, the filter information may be defined using a predetermined category. For example, the filter information may be defined as “music,” “movie,” or “book.” For example, when the first electronic device 1301 configures “music” in the reception information filter, the electronic device 1301 may automatically receive at least a part of music files which other electronic devices have. Otherwise, the first electronic device may receive at least a part of a list of the music files which other electronic devices have, and may output the received part in the form of a list. Then, a user may identify the list and select a file, which the user wants to receive, from the list. The first electronic device 1301 may perform a process of receiving files selected by the user from the other electronic devices. In this operation, the first electronic device 1301 may select a particular electronic device from a data transmission/reception group generated by a plurality of other electronic devices having a file which the first electronic device wants to receive, and may receive a file from the selected electronic device.

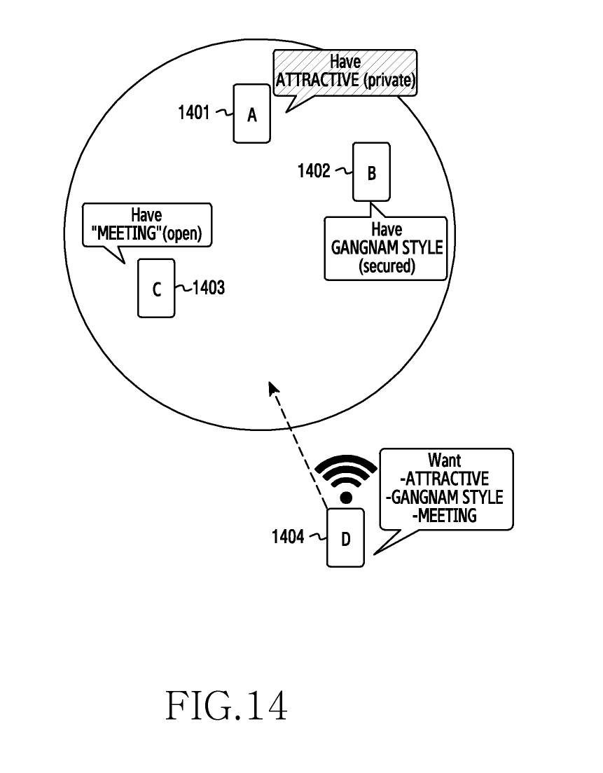

FIG. 14 illustrates filter-based data transmission or reception according to another example embodiment among various embodiments of the present disclosure.

In the following description, each of electronic devices 1401, 1402, 1403, and 1404 may be a device including a direct communication module which enables direct wireless communication (Device to Device communication; D2D communication) without passing through a network or operation of a base station. Each of such electronic devices 1401, 1402, 1403, and 1404 may be a device including the elements described above with reference to FIGS. 8 to 10.

Referring to FIG. 14, the fourth electronic device 1404 may enter a predetermined group formed by arranging the first to third electronic devices 1401, 1402, and 1403 in a predetermined range or using a mobile wireless access point. The entry operation of the fourth electronic device 1404 may be an operation of activating the direct communication module 810 and performing a predetermined broadcast within the distance range of the direct communication module 810. In the operation of configuring a reception information filter, the first to third electronic devices 1401, 1402, and 1403 may configure grades for data. For example, the first to third electronic devices 1401, 1402, and 1403 may configure first to third grades for data.

According to one embodiment, a filter indicating possession of a file having a filename “Attractive” configured to be the first grade (e.g., “Private”) may be set in the first electronic device 1401. The grade may be set correspondingly to user's desire or may be automatically allocated when a corresponding file has a unique characteristic, e.g. Digital Right Management (DRM) configuration characteristic.

The first grade may be a grade set to prevent other electronic devices from identifying whether the corresponding file is stored in the first electronic device 1401. The first grade may be a grade for controlling to prevent a corresponding file from being transmitted to another electronic device. When a filter having the first grade is set, the first electronic device 1401 may be controlled to be prevented from broadcasting file information of the first grade.

A filter reporting possession of a file having a filename “Gangnam style” configured to be a second grade (e.g., “Secured”) may be set in the second electronic device 1402. The second grade may be a grade utilizing a pre-defined security operation. For example, the second grade may be a grade which requests execution of a security process, such as input of a pre-defined password, in response to occurrence of a request for access to a stored content and allows access to the content stored in the electronic device when the execution or resolution of the security process is successful.

A filter indicating possession of a file having a filename “meeting” configured to be a third grade (e.g., “Open”) may be set in the third electronic device 1403. The third grade may be a grade set to allow other electronic devices to search for the corresponding file, request for transmission of the file in response to desire, and receive the file.

When the fourth electronic device 1404 comes to be capable of performing communication by entering a predetermined range in which the first to third electronic devices 1401, 1402, and 1403 are arranged, the fourth electronic device 1404 can receive information of each filter from the first to third electronic devices 1401, 1402, and 1403. In this event, the first electronic device 1401 may not provide information on the “Attractive” file. The fourth electronic device 1404 may receive information on the “Gangnam style” file provided by the second electronic device 1402, together with information indicating that the file has a grade of “secured,” and may display the information through an image or a text having a predetermined form on the display module 840. The fourth electronic device 1404 may receive and display information on the “meeting” file on the third electronic device 1403.

On an assumption that the fourth electronic device 1404 has a transmission information filter which desires files named “Attractive,” “Gangnam style,” and “meeting,” the fourth electronic device 1404 may automatically receive the “meeting” file from the third electronic device 1403 or receive the file according to confirmation or allowance of the third electronic device 1403. According to one embodiment, in relation to the reception of the “Gangnam style” file, the fourth electronic device 1404 may transmit a predetermined passcode to the second electronic device 1402. When the passcode provided by the fourth electronic device 1404 coincides with a pre-configured passcode, the second electronic device 1402 may transmit the “Gangnam style” file to the fourth electronic device 1404. In some embodiments, search and transmission of the “attractive” file may not be performed according to the grade of the file. The fourth electronic device 1404 may receive a passcode through a separate message from the second electronic device 1402. Otherwise, when the fourth electronic device 1404 has an experience of a previous communication with the second electronic device 1402, the fourth electronic device 1404 may automatically transmit a pre-stored passcode to the second electronic device 1402 on the basis of the previous communication experience. Otherwise, the user may input a passcode by himself or herself.

Upon receiving particular passcode information together with a file transmission request from the fourth electronic device 1404, the second electronic device 1402 having the “Gangnam style” file may compare the received passcode information with pre-defined passcode information. Further, when the compared passcodes coincide with each other, the second electronic device 1402 may automatically transmit the “Gangnam style” file to the fourth electronic device 1404 or output a pop-up window for inquiring whether to allow the transmission after notifying a user of the coinciding.

According to various embodiments, when the electronic devices described above support filter-based data processing, the type or name of data to be transmitted or received may be automatically set using a filter configured by a user or a filter selected according to status information. The electronic devices may share data with other surrounding electronic devices by broadcasting information recorded in corresponding filters using the direct communication module 810.

According to one embodiment, when “jazz festival” is configured in schedule information of a particular electronic device or when a particular musician has been searched for more than a predetermined number of times, the electronic devices may automatically record schedule information or search information as filter information and may perform broadcast relating to the data sharing on the basis of the recorded filter information. Further, when a predetermined place and time have been recorded in schedule information and it is determined that an electronic device is located in the place and at the time, the electronic device can share information on the place with other electronic devices connected on the basis of the direct communication module 810. The electronic devices may broadcast position information, position tag, etc. of the predetermined place, and receive and store or display information of a photograph or text corresponding to the place from other electronic devices on the basis of the direct communication module 810.

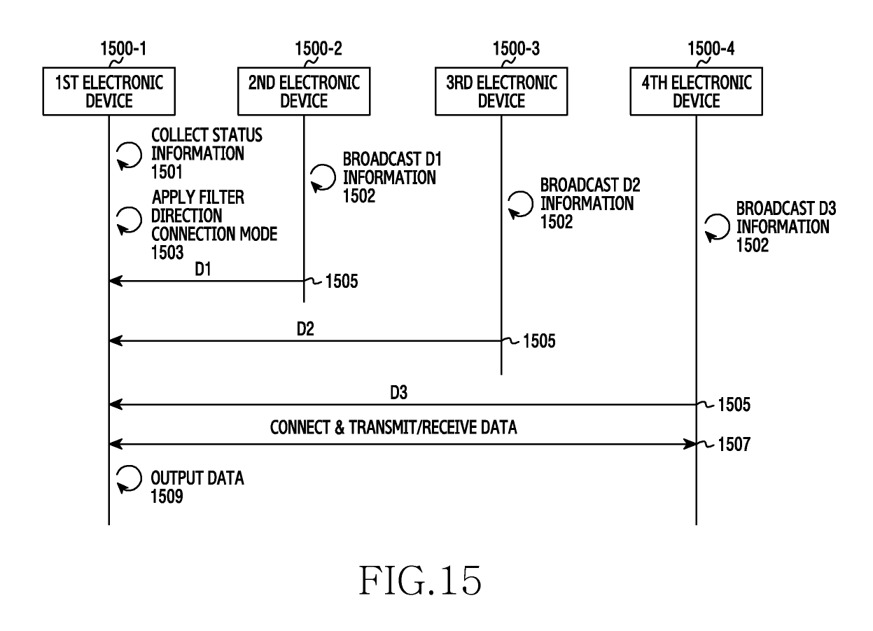

FIG. 15 illustrates a reception information filter operation according to various embodiments of the present disclosure. In the following description, each of electronic devices 1500-1, 1500-2, 1500-3, and 1500-4 may be a device including a direct communication module which enables direct wireless communication (Device to Device communication; D2D communication) without passing through a network or operation of a base station. Each of such electronic devices 1500-1, 1500-2, 1500-3, and 1500-4 may be a device including the elements described above with reference to FIGS. 8 to 10.

Referring to FIG. 15, in operation 1501, for example, the first electronic device 1500-1 may select a predefined filter in relation to the status information collected by the situation processing module 970 at a predetermined time and predetermined place. For example, the first electronic device 1500-1 may collect pre-configured schedule information to be performed at the current time. Otherwise, the first electronic device 1500-1 may collect schedule information configured to be performed at the current place. When the status information has been collected, in operation 1503, the first electronic device 1500-1 applies the filter according to the status information and may enter a direct connection mode correspondingly to the application of the filter. According to one embodiment, the first electronic device 1500-1 may activate the direct communication module 910 to enable reception of data from other electronic devices.

In operation 1502, for example, the second electronic device 1500-2, the third electronic device 1500-3, or the fourth electronic device 1500-4 may broadcast particular data. According to various embodiments, in operation 1502, the second electronic device 1500-2 may broadcast D1 information, the third electronic device 1500-3 may broadcast D2 information, and the fourth electronic device 1500-4 may broadcast D3 information. In operation 1505, for example, the first electronic device 1500-1, in which the direct communication module 810 has been activated, may receive at least one among the D1 information broadcasted by the second electronic device 1500-2, the D2 information broadcasted by the third electronic device 1500-3, and the D3 information broadcasted by the fourth electronic device 1500-4.

In operation 1503, for example, the first electronic device 1500-1 may filter, using the configured filter, information received from other electronic devices. According to one embodiment, when the reception information filter is a traffic information filter, the first electronic device 1500-1 may collect traffic information provided by an electronic device for providing the traffic information among the other electronic devices, for example, D3 information provided by the fourth electronic device 1500-4. In relation to the application of a transmission information filter, the first electronic device 1500-1 may disregard D1 information provided by the second electronic device 1500-2 or D2 information provided by the third electronic device 1500-3.

In operation 1507, for example, when it is identified that the fourth electronic device 1500-4 is a device providing traffic information, the first electronic device 1500-1 may establish a communication channel with the fourth electronic device 1500-4. The first electronic device 1500-1 may receive real time traffic information from the fourth electronic device 1500-4. In operation 1507, the first electronic device 1500-1 may set at least some electronic devices among the other electronic devices transmitting the data into a device candidate group to be connected through wireless communication, using a filter. For example, the first electronic device 1500-1 may set a plurality of other electronic devices transmitting data defined by a filter as candidate devices to be connected through wireless communication relating to data reception.

In operation 1509, for example, the first electronic device 1500-1 may output, in a controlled manner, the received data to the display module. According to one embodiment, the first electronic device 1500-1 may output the received data in the form of at least one among a text, an image, and an audio signal. For example, the first electronic device 1500-1 may output the real time traffic information in the form of at least one of a text or an image to the display module 840. The first electronic device 1500-1 may output the received data as an audio signal to the audio processing module 830. The first electronic device 1500-1 may output vibration notifying of data reception.

In the operation described above, a scheme in which the fourth electronic device 1500-4 transmits real time traffic information by itself may be taken into consideration. However, in this case, the quantity of information broadcasted on the basis of the direct communication module 910 may be limitedly designed. For example, in the case of the D1 to D3 information, data having a size not exceeding a predetermined size may be broadcasted in relation to the type or name of information provided by each electronic device and identification information of the electronic device transmitting the information. In the design environment as described above, the first electronic device 1500-1 may receive information including identification information corresponding to data having a size not exceeding a predetermined size through a broadcast scheme. The first electronic device 1500-1 may identify the fourth electronic device 1500-4 providing the traffic information by identifying the data having a size not exceeding a predetermined size received through broadcasting. The first electronic device 1500-1 may establish a communication channel with the identified fourth electronic device 1500-4 or a server (e.g. application server) associated with the fourth electronic device 1500-4 and may transmit or receive data having a size not exceeding a predetermined size through the established communication channel.

According to another embodiment, in operation 1501, the first electronic device 1500-1 may collect schedule information, such as meeting, as status information. For example, the first electronic device 1500-1 may be located at a particular place recorded in the schedule information and may collect the corresponding location information as status information. For example, the first electronic device 1501-1 may select a device matching filter as the reception information filter in operation 1503. The device matching filter may include identification information of another electronic device as described above. When the device matching filter is applied and the first electronic device enters a direction connection mode, the first electronic device 1500-1 can receive information provided by other electronic devices. The first electronic device 1500-1 may filter information provided by other electronic devices, using the device matching filter of the direct communication module 910. For example, the device matching filter may be pre-defined by the fourth electronic device 1500-4. The first electronic device 1500-1 may disregard information provided by the second electronic device 1500-2 and the third electronic device 1500-3. When the D3 information provided by the fourth electronic device 1500-4 coincides with the information defined by the device matching filter, the first electronic device 1500-1 may establish connection with the fourth electronic device 1500-4 or a server (e.g. application server) associated with the fourth electronic device 1500-4 in relation to the transmission of the data having a size not exceeding a predetermined size in operation 1507.

According to one embodiment, upon receiving a communication connection request from the first electronic device 1500-1, the fourth electronic device 1500-4 may output, through the display module 840 or another output means, such as an audio processing module, information reporting that the first electronic device is located within a predetermined range. Further, when a communication channel with the fourth electronic device 1500-4 is formed or the fourth electronic device 1500-4 is discovered, the first electronic device 1500-1 may output, through the display module 840, etc., information reporting that the fourth electronic device 1500-4 is located within a predetermined range. For example, the first electronic device 1500-1 and the fourth electronic device 1500-4 may exchange the position information with each other to support each other to identify their current positions. Each of the first electronic device 1500-1 and the fourth electronic device 1500-4 includes a location information collecting module and may pre-store map information to enable outputting of collected location information and received location information onto a map. According to one embodiment, when a communication channel on the basis of the direct communication module 810 is established, the first electronic device 1500-1 and the fourth electronic device 1500-4 may automatically try a communication connection. According to one embodiment, the first electronic device 1500-1 and the fourth electronic device 1500-4 may transmit a message notifying of arrival to a counterpart device either automatically or after user's identification operation.

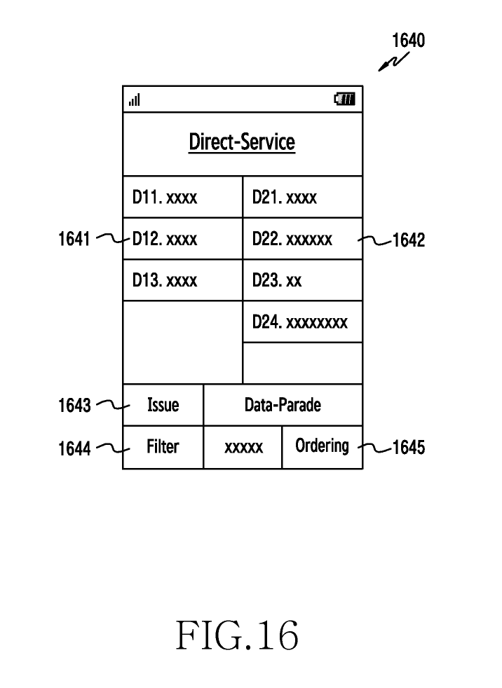

FIG. 16 illustrates an example of a screen that can be provided in a filter-based data processing operation according to various embodiments of the present disclosure. Referring to FIG. 16, at least one (hereinafter, referred to as the electronic device 800) among electronic devices according to various embodiments may output information indicating a direct service onto at least a part of a screen, for example, the upper end of the screen, at the time of entering the direct connection mode. The direct service may be changed to another name or image according to the designer's intention or user adjustment.

According to one embodiment, the electronic device 800 may receive predetermined data from other electronic devices located adjacently thereto as the electronic device enters the direct connection mode. When the electronic device 800 does not apply a particular filter, the electronic device 800 can receive all of various data broadcasted by other electronic devices. Even when the electronic device 800 applies a filter having information corresponding to a higher layer category recorded therein, the electronic device 800 can receive various data that can be divided into sub-categories within the same category.

Upon receiving multiple pieces of data which can be divided according to the categories as described above, the electronic device 800 divides the received data according to a predetermined standard and may output the divided data to the display module 840 so that the divided data can be identified. The figure shows an example of data which is divided into two kinds. For example, the display module 1640 may display first category data 1641 and second category data 1642. Although the figure shows an example of data divided into two kinds, various embodiments are not limited thereto. For example, in relation to the characteristics of the received data, the electronic device 800 may divide the data into more than two types of category data or into one type of category data.

The first category data 1641 may correspond to broadcast messages broadcasted by one or more other electronic devices disposed in shops. The second category data 1642 may correspond to messages broadcasted by an ordinary user. At least one type of data among the first category data 1641 and the second category data 1642 may be output together with schedule information included in the data on a screen. For example, messages belonging to the first category data 1641 may be output together with at least one letter relating to advertisement on the display module 1640 in the display operation. Similarly, messages belonging to the second category data 1642 may be output together with at least a part of letters corresponding to identification of another electronic device on the display module 1640 in the display operation. According to various embodiments, broadcast messages relating to advertisement, etc. may include an index value, which indicates that it is an advertisement and is recorded in a header thereof. According to one embodiment, ordinary user broadcast messages may include an index value, which indicates an ordinary user and is recorded in a header thereof.

According to one embodiment, the electronic device 800 may select information of a particular category among the collected data. Further, the electronic device 800 may output the collected particular category information as an “Issue” item. According to the illustrated example, the electronic device 800 may output information relating to “Parade” as an issue item 1643. The issue item 1643 may be information transmitted or received more frequently than a predetermined number of times in the area in which the electronic device 800 is located. For example, when the “Parade” information is most frequently transmitted among the information transmitted or received in the area in which the electronic device 800 is located, the display module 1640 may output “Parade” as the issue item 1643.

The filter item 1644 may be an item for providing information on a currently applied filter. For example, when the filter item 1644 is selected, the electronic device 800 may output a filter list enabling selection of another filter on the current screen or display the filter list through another window. The filter item 1644 may include either one filter item or multiple filter items in relation to user configuration or status information.

The ordering item 1645 may be an item relating to adjustment of the order. For example, when the ordering item is selected, at least one among the first category data 1641 and the second category data 1642 may be updated. Further, the electronic device 800 may update the issue item 1643 by analyzing the data newly received at the time point where the ordering item 1645 is selected.

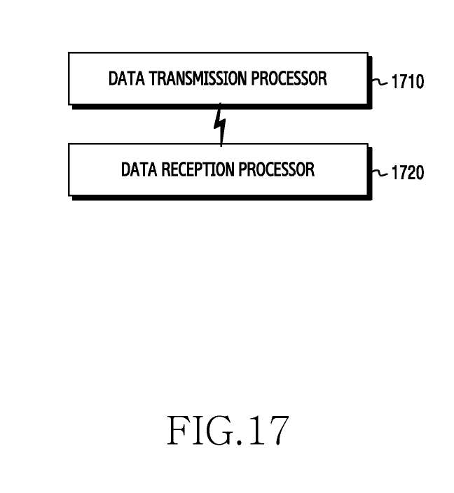

FIG. 17 illustrates an example relation-based data processing operation module 864 according to various embodiments of the present disclosure in more detail. Referring to FIG. 17, the relation-based data processing module 864 may include a data transmission processor 1710 or a data reception processor 1720. As described above, the relation-based data processing module 864 may be provided either separately from the control module 860 or together with other processing modules, for example, the filter-based data processing module 862. An electronic device to which the relation-based data processing module 864 can be applied may have the implementation as shown in FIG. 8. Otherwise, the electronic device may include the other elements except for the status processing module among the elements of the electronic device as described above.

For example, the implementation of the electronic device 800 to which the relation-based data processing module 864 is independently applied may include the direct communication module 810, the input module 820, the audio processing module 830, the display module 840, the storage module 850, and the control module 860 as shown in FIG. 8, and the control module 860 may include the relation-based data processing module 864. Further, the electronic device 800 to which the filter-based data processing module 862 is also applied may include the same elements of the electronic device as described above with reference to FIG. 8.

The data transmission processor 1710 may process the data transmission operation in the relation-based data processing operation. For example, the data transmission processor 1710 may control the direct communication module 810 to broadcast predetermined data stored in the storage module 850 at a predetermined cycle or in real time. In the case of the electronic device to which the relation-based data processing module 864 is applied, the direct communication module 810 may include the transmission module 1011 and the reception module 1012 among the elements illustrated in and described above with reference to FIG. 10. In the case of the electronic device 800 to which both the filter-based data processing module 862 and the relation-based data processing module 864 are applied, the direct communication module 810 may include all the elements illustrated in and described above with reference to FIG. 10.

The data transmission processor 1710 may output the data fragments stored in the storage module 850 at a predetermined cycle and repeatedly. The data fragments transmitted by the data transmission processor 1710 may be information, meaning of which is clarified when they have been integrated into one piece of integral data. As described above, when a broadcast function is performed on the basis of the direct communication module 810, the quantity of data which can be broadcasted may be limited. There is a case in which it is impossible to properly transfer meaning through one time of broadcasting. For example, when the fifth electronic device 1205 broadcasts data named “Berlin” as described above with reference to FIG. 12, the third electronic device 1203 having received the data may have various determinations in relation to the “Berlin.” For example, the meaning which the electronic device (e.g. the fifth electronic device 1205 of FIG. 12) of the transmitter side wants to transmit may be a latest movie entitled “Berlin.” In contrast, the electronic device (e.g. the third electronic device 1203 of FIG. 12) of the receiver side may recognize the “Berlin” as the capital city “Berlin” of the Federal Republic of Germany. According to one embodiment, the data transmission processor 1710 may divide data, which has predetermined meaning when multiple words or terms thereof have been assembled, before transmitting the data. For example, the data transmission processor may repeatedly transmit data including words “movie,” “Berlin,” and “year of 2013.”

According to one embodiment, the data reception processor 1720 may determine whether a response signal on the reception of the data from another electronic device having received the information described above is generated. The data reception processor 1720 may request the data transmission processor 1710 to transmit additional information to another electronic device having generated a response signal. According to one embodiment, the data reception processor 1720 may be requested to establish communication channels with all electronic devices having provided a response to the data transmitted by the data transmission processor 1710. When the channel establishment is requested, the data reception processor 1720 may establish communication channels with other electronic devices using the direct communication module 810. The data reception processor 1720 can transmit data (e.g. movie file, music file, letter message, or a word file) to anther electronic device through the established communication channel.

As described above, the relation-based data processing module 864 may receive some data fragments among multiple data fragments and transmit other data fragments to an electronic device having provided a corresponding response. For example, the relation-based data processing module 864 may be controlled to establish a communication channel in response to a request from an electronic device having received all the data fragments. The transmitter-side electronic device can achieve more effective data transmission since it can establish a communication channel with an electronic device having received all the transmitted data fragments. Also, the receiver-side electronic device can identify a transmitter-side electronic device capable of providing data which the user pays attention, through the data fragments. The receiver-side electronic device can find the transmitter-side electronic device without examining all the data.

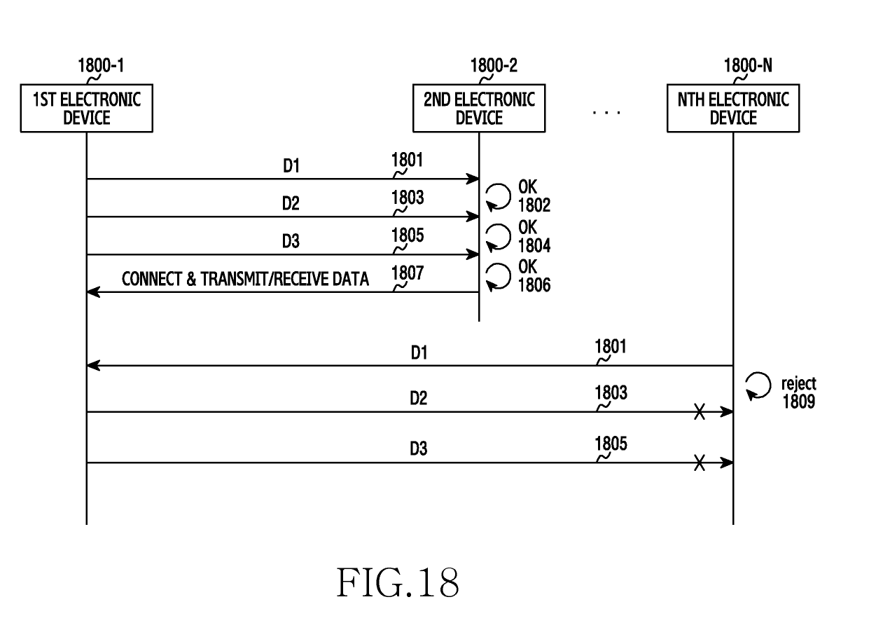

FIG. 18 illustrates a relation-based data processing method according to various embodiments of the present disclosure. In the following description, each of electronic devices 1800-1, 1800-2, ˜, and 1800-N may be a device including a direct communication module which enables direct wireless communication (Device to Device communication; D2D communication) without passing through a network or operation of a base station. Each of such electronic devices 1800-1, 1800-2, ˜, and 1800-N may be a device including at least one of the elements described above with reference to FIGS. 8 to 10.

Referring to FIG. 18, in operation 1801, for example a first electronic device 1800-1 may broadcast a first data fragment D1. In operation 1803, the first electronic device 1800-1 may broadcast a second data fragment D2. In operation 1805, the first electronic device 1800-1 may broadcast a third data fragment D3. The first electronic device 1800-1 may broadcast the first to third data fragments at a predetermined cycle or repeatedly. As described above, the transmitted data fragments may be various types of information, such as predetermined words, terms, or numbers. Further, the data fragments may be images having a predetermined size.

According to one embodiment, the second electronic device 1800-2 or the N-th electronic device 1800-N may receive at least one data fragment among the data fragments broadcasted by the first electronic device 1800-1 and output information related thereto on the display module 840. In operation 1802, for example, upon receiving the first data fragment D1 from the first electronic device 1800-1, the second electronic device 1800-2 may transmit a response signal (OK) corresponding to a user control to the first electronic device 1800-1. The response signal (OK) may be a response signal to each data fragment. Further, in operation 1804 and operation 1806, for example, upon receiving the second data fragment D2 and the third data fragment D3 from the first electronic device 1800-1, the second electronic device 1800-2 may transmit a response signal (OK) corresponding thereto to the first electronic device 1800-1 according to a user control.

For example, upon receiving at least one response signal for data fragments from the second electronic device 1800-2, the first electronic device 1800-1 may establish a communication channel with the second electronic device 1800-2 in operation 1807. The first electronic device 1800-1 may transmit particular data which it wants to transmit to the second electronic device 1800-2. Further, the first electronic device 1800-1 may receive particular data which it wants to receive from the second electronic device 1800-2.

In some embodiments, the first electronic device 1800-1 may not establish a separate communication channel with the N-th electronic device 1800-N having provided no response signal or a denial signal for the data fragments. Referring to FIG. 18, when the first electronic device 1800-1 broadcasts the first data fragment D1, the second data fragment D2, or the third data fragment D3, the N-th electronic device 1800-N may be in a state in which it can receive all the data fragments. However, with respect to the corresponding data fragment, the N-th electronic device 1800-N may transmit a denial response or no response to the first electronic device 1800-1 according to user control. Further, the N-th electronic device 1800-N may disregard the second data fragment D2 and the third data fragment D3 provided by the first electronic device 1800-1.

The data transmitted on the basis of communication connection may be a type different from that of the broadcasted data or may have a size different from that of the broadcasted data. For example, the data transmitted through communication connection may be a file having a size larger than or equal to a predetermined size, a large-capacity movie file, an advertisement file, an audio file, a particular coupon file, or an event win notification file.

In some embodiments, the first electronic device 1800-1 may be controlled to establish a communication channel with and transmit data to an electronic device having provided a response signal more than a predetermined number of times for the broadcasted data fragments or an electronic device having provided a response signal for a data fragment finally broadcasted among the multiple data fragments.

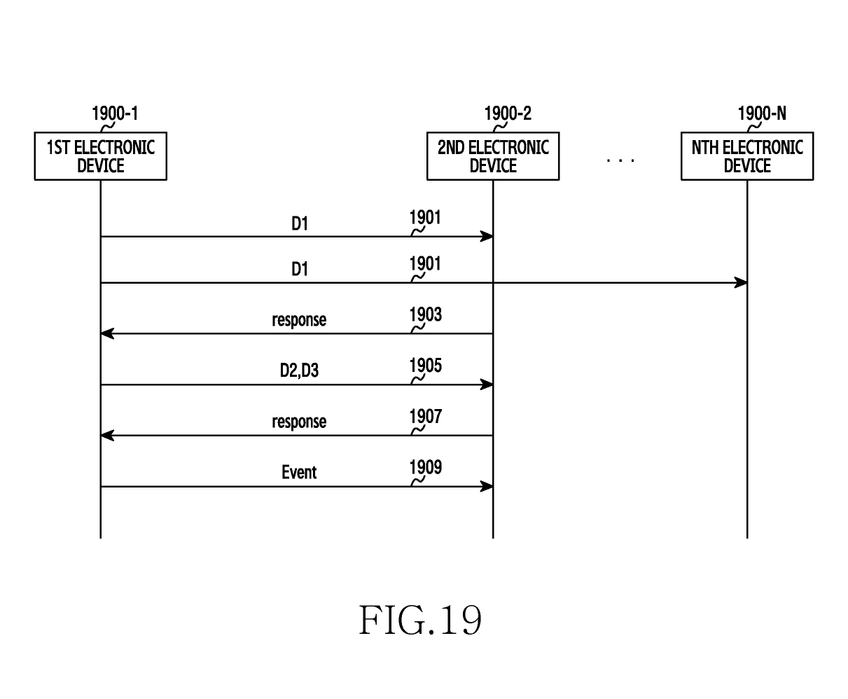

FIG. 19 illustrates a relation-based data processing method according to another embodiment among various embodiments of the present disclosure. In the following description, each of electronic devices 1900-1, 1900-2, ˜, and 1900-N may be a device including a direct communication module which enables direct wireless communication (Device to Device communication; D2D communication) without passing through a network or operation of a base station. Each of such electronic devices 1900-1, 1900-2, ˜, and 1900-N may be a device including at least one of the elements described above with reference to FIGS. 8 to 10.

Referring to FIG. 19, in operation 1901, for example a first electronic device 1900-1 may broadcast a first data fragment D1 to the second electronic device 1900-2 and the N-th electronic device 1900-N. Upon receiving the first data fragment D1, for example, the second electronic device 1900-2 may transmit a response thereto to the first electronic device 1900-1 in operation 1903. The response may be a response signal notifying of reception of all data. According to various embodiments, the second electronic device 1900-2 may output the received first data fragment D1 on the display module 840. The second electronic device 1900-2 may transmit a response signal to the first electronic device 1900-1 in response to a user control. In some embodiments, the N-th electronic device 1900-N may does not transmit any response.

When receiving a response from the second electronic device 1900-2, for example, the first electronic device 1900-1 may transmit the second data fragment D2 or the third data fragment D3 to the second electronic device 1900-2 in operation 1905. The second electronic device 1900-2 may output the received second data fragment D2 or third data fragment D3 on the display module 840. In operation 1907, for example, the second electronic device 1900-2 may transmit a response signal to the first electronic device 1900-1 in response to a user control. In operation 1909, for example, the first electronic device 1900-1 may provide event information to the second electronic device 1900-2 having provided the response signal.

The first electronic device 1900-1 may transmit the data fragments according to different transmission schemes, respectively. For example, the first electronic device 1900-1 may broadcast the first data fragment D1 so that a plurality of unspecified electronic devices can receive the first data fragment. Further, the first electronic device 1900-1 may transmit other data fragments to the second electronic device 1900-2 having provided the response signal to the first data fragment D1 according a multicast or unicast scheme. In this event, the first electronic device 1900-1 may not transmit the second data fragment D2 and the third data fragment D3 to the N-th electronic device 1800-N. For example, the first electronic device 1900-1 may repeatedly broadcast the first data fragment D1 and may provide the other data fragments to another electronic device which provides a response to the first data fragment. Moreover, the first electronic device 1900-1 may receive all the data fragments, establish a communication channel with another electronic device which has provided a response thereto, and transmit a particular type of data or predefined data to the electronic device through the communication channel.

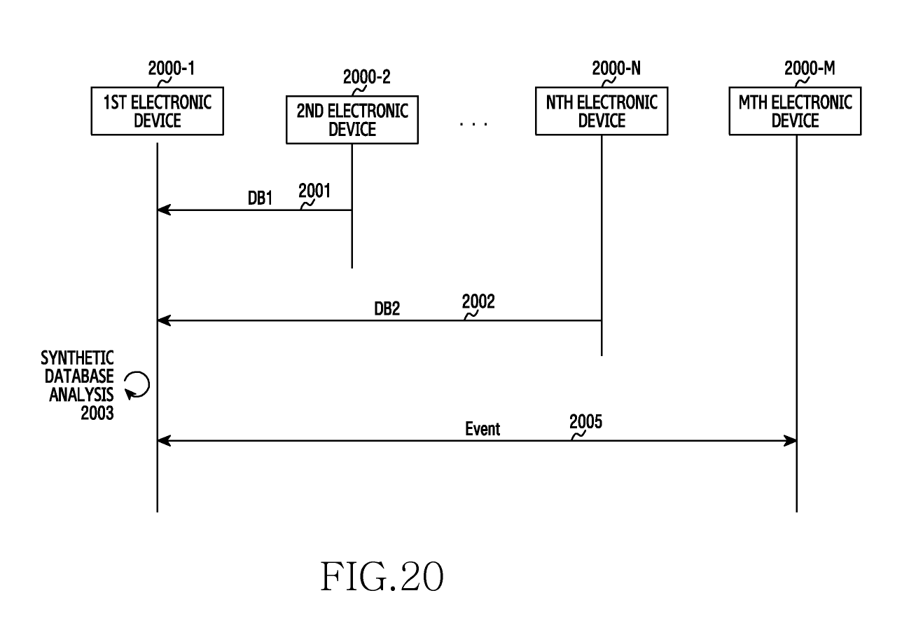

FIG. 20 illustrates a relation-based data processing method according to another embodiment among various embodiments of the present disclosure. In the following description, each of electronic devices 2000-1, 2000-2, ˜, 2000-N, and 2000-M may be a device including a direct communication module which enables direct wireless communication (Device to Device communication; D2D communication) without passing through a network or operation of a base station. Each of such electronic devices 2000-1, 2000-2, ˜, 2000-N, and 2000-M may be a device including at least one of the elements described above with reference to FIGS. 8 to 10.

Referring to FIG. 20, in operations 2001 and 2002, for example, the first electronic device 2000-1 may receive at least one among a first database DB1 and a second database DB2 from at least one among the second electronic device 2000-2 and the N-th electronic device 2000-N. According to one embodiment, the first electronic device 2000-1 may enter a direct connection mode and request the second electronic device 2000-2 to send the first database DB1. Further, the first electronic device 2000-1 may request the N-th electronic device 2000-N to provide the second database DB2. Otherwise, according to one embodiment, when the first electronic device 2000-1 enters the direct connection mode, at least one among the second electronic device 2000-2 and the N-th electronic device 2000-N may automatically share at least one among a first database DB1 and a second database DB2 with the first electronic device 2000-1. Meanwhile, the collection of the database by the first electronic device 2000-1 may be performed without the entry into the direct connection mode. For example, the first electronic device 2000-1 may activate a communication channel relating to the request for the database with the second electronic device 2000-2 to the N-th electronic device 2000-N at a predetermined cycle or according to a user request. The first electronic device 2000-1 may receive database from other electronic devices.

The first database DB1 and the second database DB2 may include particular information of other electronic devices collected by the second electronic device 2000-2 and the N-th electronic device 2000-N. According to one embodiment, the first database DB1 and the second database DB2 may include preference information of users of other electronic devices. Otherwise, the first database DB1 and the second database DB2 may include information on the electronic device which has provided the response signal and the data fragment for which the electronic device has provided the response signal. Otherwise, the first database DB1 and the second database DB2 may include information on the electronic device which has requested the data and the data which the electronic device has requested. The first database DB1 and the second database DB2 may include information on a transmission information filter and a reception information filter of other electronic devices. For example, the second electronic device 2000-2 and the N-th electronic device 2000-N may store data broadcasted by other electronic devices and data provided by other electronic devices in such a manner in which the data is distinguished according to each electronic device.

When at least one among the first database DB1 and the second database DB2 is received, for example, the first electronic device 2000-1 may analyze the received databases in operation 2003. For example, the first electronic device 2000-1 may compare at least one among type information and name information of data which itself possesses with a result of the data analysis. Through the result comparison, the first electronic device 2000-1 can select another electronic device which has a predetermined or higher probability of receiving event data to be transmitted. The first electronic device 2000-1 may transmit event data requested by the selected electronic device, for example, the M-th electronic device 2000-M, to the M-th electronic device 2000-M. Here, when the event data has a predetermined size or larger, the first electronic device 2000-1 may establish a communication channel with the M-th electronic device 2000-M and transmit the event data through the established communication channel.

According to one embodiment, the first electronic device 2000-1 may possess a hamburger coupon. When it is determined through the database analysis that the M-th electronic device 2000-M desires to receive the hamburger coupon, the first electronic device 2000-1 may provide the possessed hamburger coupon to the M-th electronic device 2000-M. The information on the M-th electronic device 2000-M may be collected in the operation of analyzing the database.

In the relation-based data processing scheme, the first electronic device 2000-1 may apply at least one filter. According to one embodiment, the first electronic device 2000-1 may select a filter in which filter information appointed according to predetermined time or predetermined place is recorded. The first electronic device 2000-1 may process the relation-based data on the basis of the selected filter. Here, the filter information may be configured by data fragments broadcasted as described above. The receiver-side electronic device (e.g. the M-th electronic device 2000-M) may select a filter in which filter information the electronic device wants to receive is recorded. The receiver-side electronic device (e.g. the M-th electronic device 2000-M) may identify the broadcast information filtered by the corresponding filter among the broadcast information provided by at least one transmitter-side electronic device (e.g. the first electronic device 2000-1 or the second electronic device 2000-2).

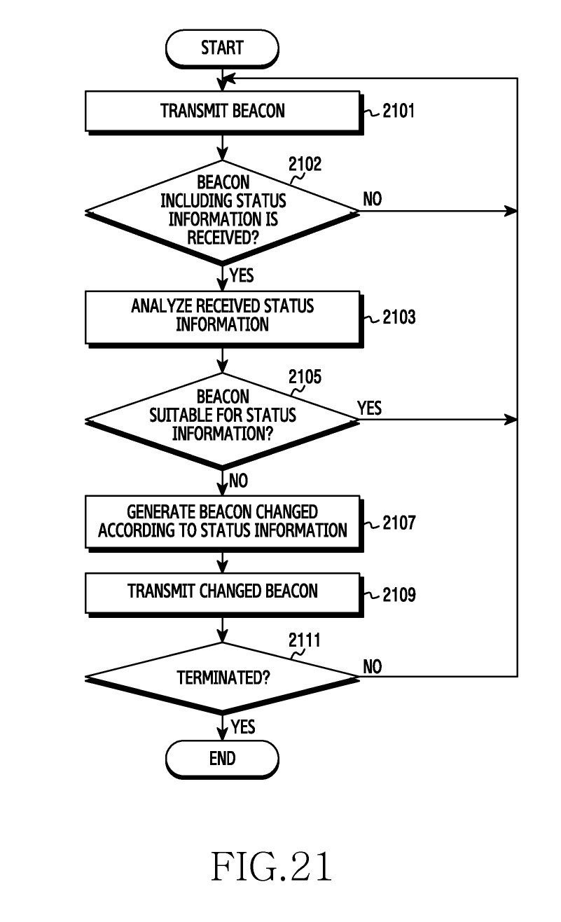

FIG. 21 is a flowchart illustrating a method of transmitting a beacon changed according to status information by a transmitter electronic device according to various embodiments of the present disclosure. Referring to FIG. 21, in operation 2101, the control module 960 may transmit a beacon to the second electronic device at an advertising event time point. Although the present embodiment is based on an assumption that the beacon is transmitted to a particular electronic device, a second electronic device, the present disclosure is not limited to the present embodiment, and the beacon may be transmitted to all electronic devices around the first electronic device. Further, in operation 2102, the control module 960 may determine whether a beacon including status information is received from the second electronic device.

When a beacon including status information is received from the second electronic device, the control module 960 may detect the reception in operation 2102 and analyze the received beacon in operation 2103. In other words, the control module 960 may analyze the status information included in the beacon. The status information may include a distance and speed between electronic devices, current time information, a state of an electronic device sending the beacon, and user information of a reception/transmission electronic device. Further, when receiving a beacon containing user information (e.g. user preference and activation information) from the second electronic device, the control module 960 may determine whether contents included in the currently transmitted beacon are contents suitable for the user of the second electronic device. Then, when change of the contents is desired, the control module 960 may change the beacon to a beacon including contents suitable for the user of the second electronic device and provide the changed beacon to the user of the second electronic device. For example, according to the distance between electronic devices, the control module 960 may change the beacon signal to enable reception of broad information and/or detailed information. Further, when the speed of the electronic device is rapid, that is, when the user moves at a high speed, the control module 960 may change the beacon signal to disable reception of the broadcast. Moreover, on the basis of the current time information, for example, in a commuting time, the control module 960 may change the beacon signal to enable reception of necessary information, such as traffic information. Thereafter, in operation 2105, the control module 960 may determine, based on the analysis described above, whether the beacon, which has been transmitted in operation 2101, is a beacon suitable for the status information of the second electronic device. Specifically, when the beacon transmitted in operation 2101 is a beacon suitable for the status information of the second electronic device, the control module 960 may detect it in operation 2105 and return to operation 2101 to go on transmitting the beacon which is being transmitted.

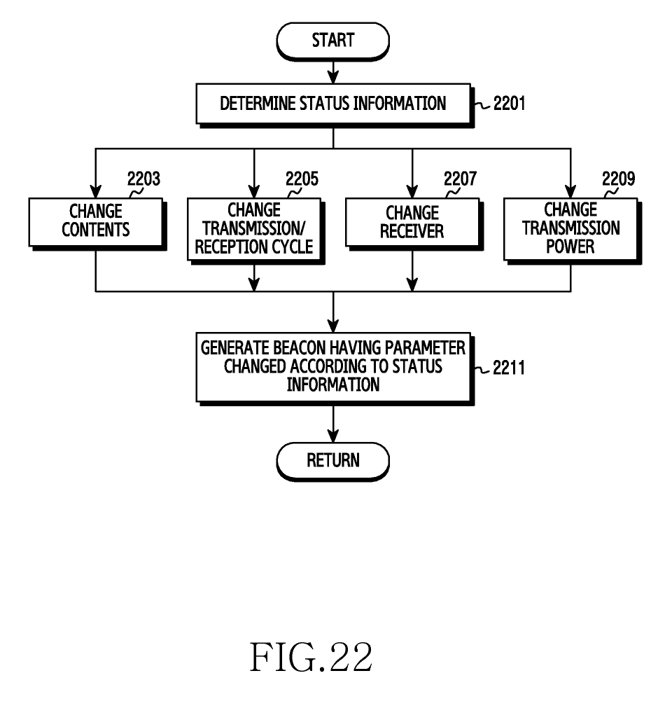

In contrast, when the beacon transmitted in operation 2101 is not a beacon suitable for the status information of the second electronic device, the control module 960 may generate a changed beacon according to the status information in operation 2107. For example, when the first electronic device advertises a beacon signal including a large amount of contents (e.g. text, image, audio, video, etc.), a particular electronic device, e.g. the second electronic device, among the electronic devices having received the beacon signal, may request a particular content (e.g. image) among the contents. In this case, the first electronic device may receive a beacon relating to a request for a particular content (information utilizing an image content) from the second electronic device. After receiving the beacon, the first electronic device may analyze the beacon signal relating to the request for the particular content, generate a beacon packet changed to include the particular content which the user of the second electronic device wants, and transmit the generated beacon packet to the second electronic device. Details of operation 2107 will be described with reference to FIG. 22.

FIG. 22 is a flowchart illustrating a method of generating a beacon changed depending on status information according to various embodiments of the present disclosure. Referring to FIG. 22, the control module 960 may determine the status information of the second electronic device in operation 2201. Through the determination as described above, the control module 960 may change parameter information corresponding to the status information of the second electronic device in operations 2203 to 2209. Specifically, the control module 960 may change the contents according to the status information. Here, the contents may include a text, an image, an audio, and a video, and may change the contents to include the content corresponding to the status information. Further, the control module 960 may change the transmission/reception cycle according to the status information in operation 2205. Specifically, the control module 960 may change the number of times by which a beacon is transmitted or received at a particular time, according to the status information. Further, in operation 2207, the control module 960 may change the subject to receive the beacon, according to the status information. Specifically, the control module 960 may change the receiver of the beacon to at least one subscriber among pre-registered subscribers, subscribers registered in a contact list, and subscribers connected through a Social Network Service (SNS) in operation 2207. Further, the control module 960 may change the transmission power according to the status information in operation 2209. In various embodiments of the present disclosure, the control module 960 may generate a beacon in which at least one among the parameters of operations 2203 to 2209 has been changed according to the status information. Thereafter, the control module 960 may generate a beacon in which parameters have been changed by execution of operations 2203 to 2209 according to the status information in operation 2211.

Referring again to FIG. 21, in operation 2109, the control module 960 may transmit the beacon (i.e. beacon in which parameters have been changed according to the status information) generated in operation 2107 to the second electronic device. Further, in operation 2111, the control module 960 may determine whether to terminate the process. When a command for termination is generated, the control module 960 may detect it and perform the operation to terminate the process in operation 2111. In contrast, when a command for termination is not generated, the control module 960 may return to operation 2101 to go on transmitting the beacon.

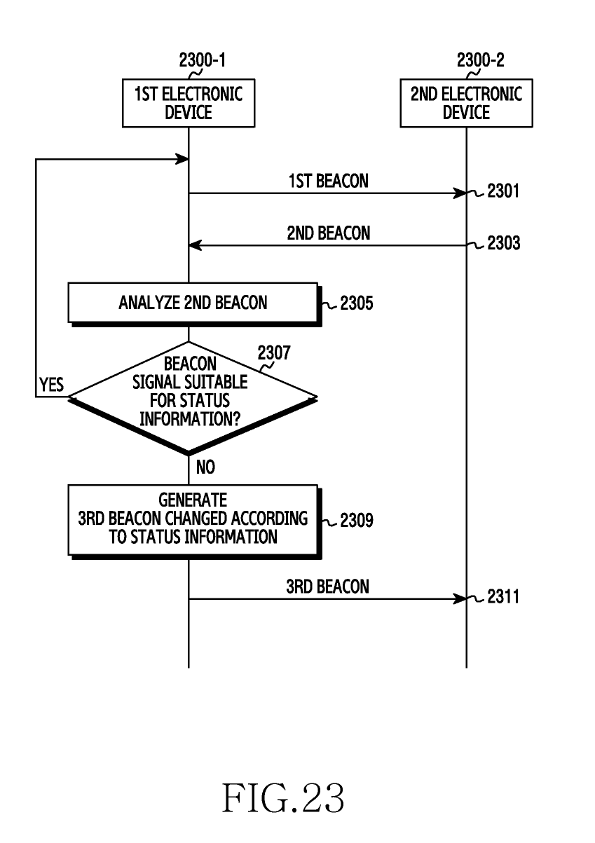

FIG. 23 is a signal flow diagram illustrating the signal flow between the first electronic device and the second electronic device according to various embodiments of the present disclosure. FIG. 23 will be described based on an assumption that a first electronic device 2300-1 is a transmission electronic device for transmitting a beacon signal and a second electronic device 2300-2 is a reception electronic device for receiving a beacon signal. The first electronic device may request a link layer to activate advertisement in order to enable transmission of a beacon signal, and transmit a beacon signal to the second electronic device when the advertisement is activated. Although the present embodiment is based on an assumption that the beacon signal is transmitted to the second electronic device, the present disclosure is not limited to the present embodiment, and the beacon signal may be transmitted to all electronic devices which are not determined as receivers thereof. Further, the second electronic device may be in a state where a scan mode allowing reception of the beacon signal is activated.

Specifically, in operation 2301, the first electronic device may transmit a first beacon to the second electronic device at an advertising event time point. Further, in operation 2303, the second electronic device may analyze the received first beacon, generate a second beacon for proper response thereto, and transmit the second beacon to the first electronic device. In other words, after the advertising event time point, the first electronic device may receive the second beacon from the second electronic device. The second beacon may include address information of the second electronic device and status information in a PDU thereof. For example, the status information may include information, such as preference of the second electronic device (e.g. state of the electronic device and user information of the electronic device) previously stored in the first electronic device. Further, the status information may include a request for additional information from the first electronic device. Thereafter, the first electronic device may receive the second beacon including status information and scan and analyze the received second beacon in operation 2305. In other words, the first electronic device may analyze the status information included in the second beacon. Thereafter, on the basis of the analyzed status information, in operation 2307, the first electronic device may determine whether the beacon signal transmitted to the second electronic device in operation 2301 is a beacon signal suitable for the status of the second electronic device. When it is not a beacon signal suitable for the status information, the first electronic device may generate a third beacon changed according to the status information in operation 2309. Further, in operation 2311, the first electronic device may transmit the third beacon to the second electronic device at an advertising event time point. As a result, the second electronic device can receive a beacon signal (i.e. the third beacon) suitable for the status information.

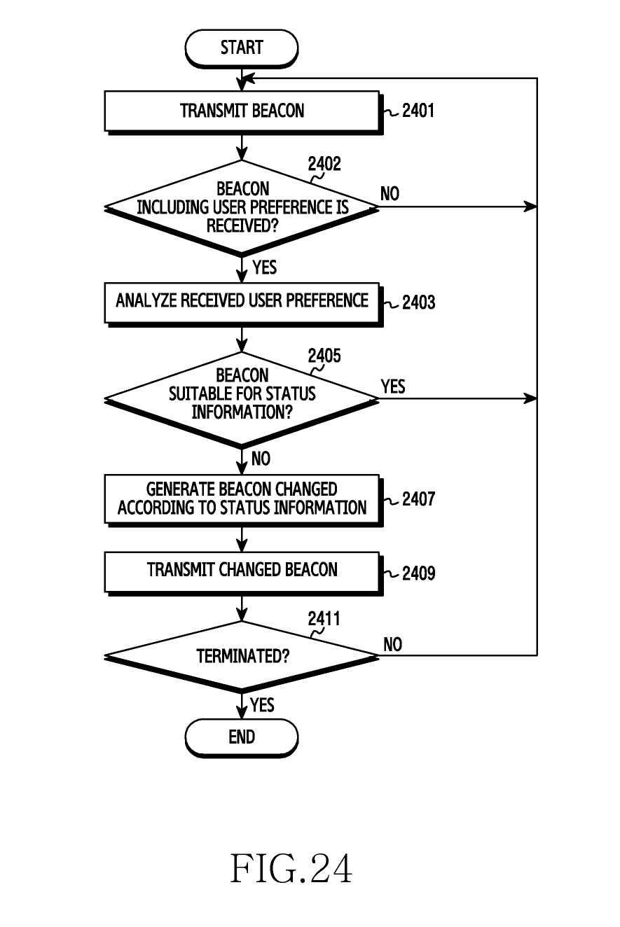

FIG. 24 is a flowchart illustrating a method of generating a beacon changed depending on status information according to various embodiments of the present disclosure. FIG. 24 will be described on the basis of an assumption that the status information is user preference. Referring to FIG. 24, in operation 2401, the control module 960 may transmit a beacon to the second electronic device at an advertising event time point. Although the present embodiment is based on an assumption that the beacon is transmitted to a particular electronic device, a second electronic device, the present disclosure is not limited to the present embodiment, and the beacon may be transmitted to all electronic devices surrounding the first electronic device. Further, in operation 2402, the control module 960 may determine whether a beacon including user preference of the second electronic device is received from the second electronic device. For example, the beacon transmitted by the first electronic device in operation 2401 may be a beacon not suitable for the preference of the user of the second electronic device. At this time, when the beacon received from the first electronic device is not suitable for the preference of the user of the second electronic device, the second electronic device may generate a beacon including information on the preference of the user of the second electronic device and transmit the generated beacon to the first electronic device. The present disclosure is not limited to the above implementation and the second electronic device may be in a state of periodically transmitting a beacon including the user preference of the second electronic device to the first electronic device.

When a beacon including preference information is received from the second electronic device, the control module 960 may detect the reception in operation 2402 and analyze the received beacon in operation 2403. In other words, the control module 960 may analyze the preference of the user of the second electronic device included in the beacon. The user preference may include a distance and speed between electronic devices, current time information, information of a reception/transmission electronic device, user information of a reception/transmission electronic device, preference information of a user, and activity information, and the control module 960 may generate a changed beacon according to the user preference. Further, when receiving a beacon containing user information (e.g. user preference and activation information) from the second electronic device, the control module 960 may determine whether contents included in the currently transmitted beacon are contents suitable for the user of the second electronic device. Then, when change of the contents is desired, the control module 960 may change the beacon to a beacon including contents suitable for the user of the second electronic device and provide the changed beacon to the user of the second electronic device. For example, according to the distance between electronic devices, the control module 960 may change the beacon signal to enable reception of broad information and/or detailed information. Further, when the speed of the electronic device is rapid, that is, when the user moves at a high speed, the control module 960 may change the beacon signal to disable reception of the broadcast. Moreover, on the basis of the current time information, for example, in a commuting time, the control module 960 may change the beacon signal to enable reception of necessary information, such as traffic information.

Thereafter, in operation 2405, the control module 960 may determine, based on the analysis described above, whether the beacon, which has been transmitted to the second electronic device in operation 2401, is a beacon suitable for the preference information of the second electronic device. Specifically, when the beacon transmitted to the second electronic device by the first electronic device in operation 2401 is a beacon signal suitable for the status information of the second electronic device, the control module 960 may detect it in operation 2405 and return to operation 2401 to go on transmitting the beacon which is being transmitted.

In contrast, when the beacon transmitted in operation 2401 is not a beacon signal suitable for the preference information of the second electronic device, the control module 960 may generate a beacon having a parameter changed according to the preference information in operation 2407. The parameter may include a content, a reception cycle, a receiving subject, and a transmission power. The control module 960 may perform an operation of changing at least one parameter among the content, the reception cycle, the receiving subject, and the transmission power according to the preference information and may generate a beacon signal having at least one changed parameter. Further, in operation 2409, the control module 960 may transmit the beacon generated on the basis of the parameter according to the user preference information in operation 2407 to the second electronic device.

For example, the following description is based on an assumption that the first electronic device according to an embodiment of the present disclosure is a shop electronic device which transmits advertisement information (e.g. coupon and/or discount information) to a user from a shop and the second electronic device is a user electronic device which receives advertisement information from the shop (i.e. first electronic device). While transmitting a beacon signal containing advertisement, the shop (i.e. first electronic device) may receive a beacon signal including preference information (e.g. personal information, i.e. VIP or VVIP, subscribed to the shop) from the user (i.e. second electronic device). The shop having received the beacon having the preference information included therein may generate a beacon packet having the changed coupon and/or discount information corresponding to the user preference (i.e. coupon and/or discount information corresponding to VIP if the user preference information corresponds to VIP) and transmit the generated beacon packet to the user. The advertisement includes coupon and discount information and may be used to have meaning different from the transmission (including broadcasting or advertising) of a beacon signal in the embodiments of the present disclosure.

Otherwise, in the case of transmitting a first beacon including discount event information for a particular product from a shop, shop B having received the first beacon may generate a second beacon including advertisement and/or discount event information for the same product and transmit the second beacon to a plurality of electronic devices.

Further, in operation 2411, the control module 960 may determine whether to terminate the process. When a command for termination is generated, the control module 960 may detect it and perform the operation to terminate the process in operation 2411. In contrast, when a command for termination is not generated, the control module 960 may return to operation 2401 to go on transmitting the beacon.

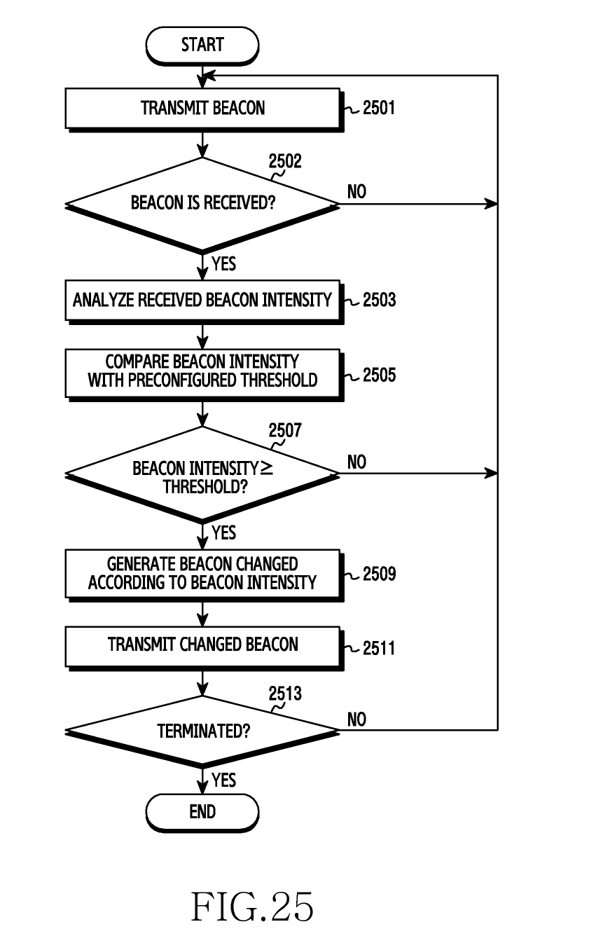

FIG. 25 is a flowchart illustrating an example method of generating a beacon changed depending on status information according to various embodiments of the present disclosure. FIG. 25 will be described on the basis of an assumption that the status information is beacon intensity information. Referring to FIG. 25, in operation 2501, the control module 960 may transmit a beacon to the second electronic device at an advertising event time point. Although the present embodiment is based on an assumption that the beacon is transmitted to a particular electronic device, a second electronic device, the present disclosure is not limited to the present embodiment, and the beacon may be transmitted to all electronic devices surrounding the first electronic device. Further, in operation 2502, the control module 960 may determine whether a beacon including status information is received from the second electronic device. When the beacon is received, the control module 960 may detect it in operation 2502 and analyze the intensity of the received beacon in operation 2503. The intensity of the beacon may be strong when the distance between the electronic devices is short and may be weak when the distance between the electronic devices is long. Then, in operation 2505, the control module 960 may compare the analyzed beacon intensity information with a preset threshold of the beacon intensity. On the basis of the comparison, in operation 2507, the control module 960 may determine whether the analyzed beacon intensity information exceeds the preset threshold of the beacon intensity. When the analyzed beacon intensity information does not exceed the threshold, that is, when it is determined that the distance between the electronic devices is long, the control module 960 may recognize the intensity of the beacon as weak and proceed to operation 2501 to transmit the beacon. In this event, the beacon may be the unchanged existing beacon.

In contrast, when the analyzed beacon intensity information exceeds the threshold, that is, when it is determined that the distance between the electronic devices is short, the control module 960 may recognize the intensity of the beacon as strong and proceed to operation 2409 in which the control module may generate a beacon having parameter information changed according to the beacon intensity. Specifically, the parameter may include a content, a reception cycle, a receiving subject, and a transmission power. The control module 960 may perform an operation of changing at least one parameter among the content, the reception cycle, the receiving subject, and the transmission power according to the beacon intensity information and may generate a beacon signal having at least one changed parameter. Further, in operation 2511, the control module 960 may transmit the beacon generated on the basis of the changed parameter information according to the beacon intensity in operation 2509 to the second electronic device.

For example, the following description is based on an assumption that the first electronic device according to various embodiments of the present disclosure is a shop electronic device which transmits advertisement information (e.g. advertisement information of the shop) to a user from a shop and the second electronic device is a user electronic device which receives advertisement information from the shop (i.e. first electronic device). While transmitting a beacon signal containing advertisement, the shop (i.e. first electronic device) may receive a beacon signal from the user (i.e. second electronic device). In this event, the information transmitted to the user may be general shop advertisement information (e.g. broad information such as discount sale information of the shop). If the intensity of the beacon signal becomes a predetermined intensity or higher, the shop electronic device may determine that the user electronic device is located near the shop, generate a beacon signal having changed coupon and/or discount information usable in the shop (i.e. beacon signal having changed coupon information usable in the shop according to the approach to the shop in the discount sale information of the shop), and transmit (including broadcasting or advertising) the generated beacon signal to the user electronic device. The advertisement includes coupon and discount information and may be used to have meaning different from the transmission (including broadcasting or advertising) of a beacon signal in the embodiments of the present disclosure.

Further, in operation 2513, the control module 960 may determine whether to terminate the process. When a command for termination is generated, the control module 960 may detect it and perform the operation to terminate the process in operation 2513. In contrast, when a command for termination is not generated, the control module 960 may return to operation 2501 to go on transmitting the beacon.

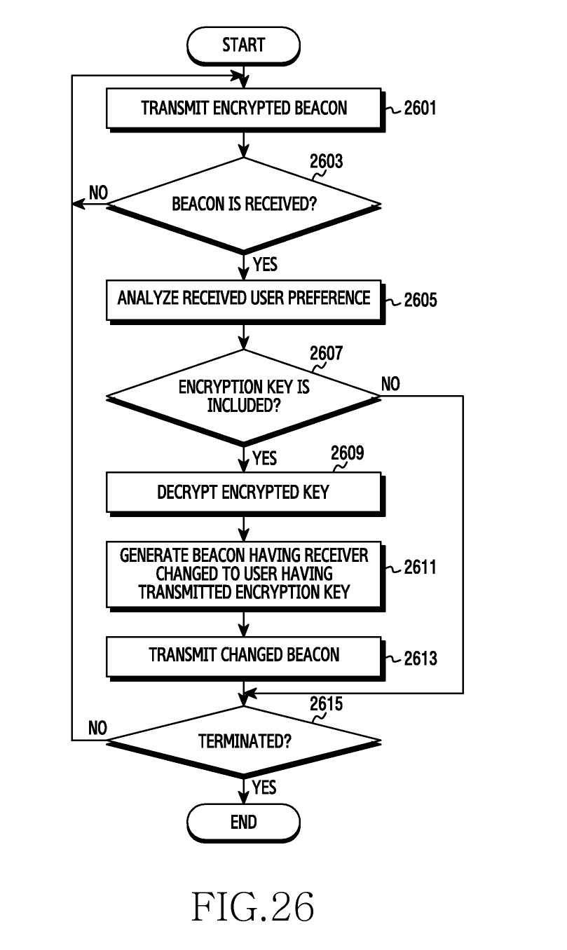

FIG. 26 is a flowchart illustrating a method of generating a beacon changed according to status information according to various embodiments of the present disclosure. Referring to FIG. 26, in operation 2601, the control module 960 may transmit an encrypted beacon which a particular receiver can open. Thereafter, in operation 2603, the control module 960 may determine whether a beacon is received from the second electronic device. Here, the beacon may be either in a state of including an encryption key or in a state of not including an encryption key. When receiving a beacon from the second electronic device, the control module 960 may detect it in operation 2603, analyze the received beacon in operation 2605, and determine whether the beacon includes an encryption key in operation 2607. When the beacon includes an encryption key, the control module 960 may detect it in operation 2607 and release the encryption key, which it has transmitted in operation 2601, in operation 2609. Further, in operation 2611, the control module 960 may generate a beacon in which a subject to receive the beacon is changed to the second electronic device having transmitted the encryption key, and then transmit the generated beacon to the second electronic device in operation 2613.

For example, in a state of transmitting an encrypted beacon which a particular user is allowed to open, when receiving a beacon from the particular user, the control 960 module may analyze the received beacon. Through the analysis, if the beacon includes an agreed key, i.e. a key allowing release of the encrypted beacon, the control module 960 may transmit open information to the corresponding user. Specifically, when a security content is desired to be transferred to multiple people in a particular space, when a beacon including promised key information is received from another electronic device while transmitting a beacon containing information indicating existence of the security content or a beacon signal containing the security content, the control module 960 may determine ID information of the electronic device having transmitted the beacon including the key information as a target of the next beacon, decrypt the encrypted content, and then transmit the decrypted content. Through the above operations, it is possible to achieve a high security level in the operation of sharing a security content, together with a smooth sharing.

Further, in operation 2615, the control module 960 may determine whether to terminate the process. When a command for termination is generated, the control module 960 may detect it and perform the operation to terminate the process in operation 2615. In contrast, when a command for termination is not generated, the control module 960 may return to operation 2601.

In contrast, when it is determined in operation 2607 that an encryption key is not included, the control module 960 may proceed to operation 2615 to determine whether to terminate.

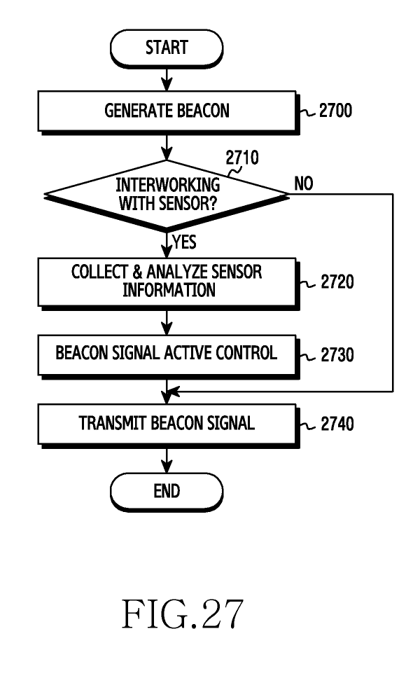

FIG. 27 is a flowchart illustrating a method of controlling a beacon signal by an electronic device according to various embodiments of the present disclosure. Referring to FIG. 27, in operation 2700, for example, a processor 120 of an electronic device, such as a smart phone or a tablet PC, may generate a beacon signal in response to a beacon signal received from surrounding devices, generate a beacon signal at a particular position, or generate a beacon signal by an application executed by a user.

In operation 2710, the processor 120 determines whether the beacon signal interworks with a sensor. As a result of the determination, when the beacon signal interworks with a sensor, the processor collects and analyzes sensor information in operation 2720, and actively controls the generated beacon signal in operation 2730.

For example, on the basis of the collected sensor information, the processor 120 may change the contents included in the beacon signal, change the transmission/reception cycle of the beacon signal, change the subject to receive the beacon signal, change the encryption of the beacon signal, or change the transmission power of the beacon signal.

The processor 120 transmits an actively controlled beacon signal as described above in operation 2740 or simply transmit the beacon signal when it does not interwork with the sensor as a result of the determination.

The beacon signal may be generated by three types of operations in large. First, a beacon may be generated in order to respond to another beacon received from another terminal. Second, a beacon may be generated at a particular position. For example, when it is programmed that a pre-configured beacon signal is to be transmitted (e.g. broadcasted) at a pre-configured area, a beacon signal may be generated when entering the particular area or being located in the particular area. Third, when an application is operated, a beacon signal may be generated according to the operation of the application.

The beacon signal may be generated by the beacon manager or by the application. It is determined whether the generated beacon signal interworks with sensor information. The beacon signal undergoes an active beacon control process when the beacon signal interworks with sensor information, while the beacon signal may be directly transmitted when the beacon signal does not interwork with the sensor information.

When the beacon signal interworks with the sensor information, the sensor information is collected, such that information of multiple sensors may be collected by the sensor manager or individual information may be collected from each of multiple sensor. A sensor measurement process for collecting the sensor information may be either performed after or independently performed before determining whether the beacon signal interworks with the sensor information.

For example, the sensor information may be previously collected through sensor measurement within the terminal regardless of whether the beacon signal is generated or not, so that the beacon manager can use the previously collected sensor information when the sensor information is utilized in order to control the beacon.

The collected sensor information may be sensor information measured by a sensor installed in a terminal or be sensor information measured by a device outside the terminal or an accessory connected to the terminal A process of actively controlling a beacon signal according to the collected sensor information includes the following operations.

The first operation is to change contents within a beacon signal, specifically, to change contents of a field value within a beacon signal. For example, contents included in advertisement data (AD data) 720 of FIG. 7 may be changed.

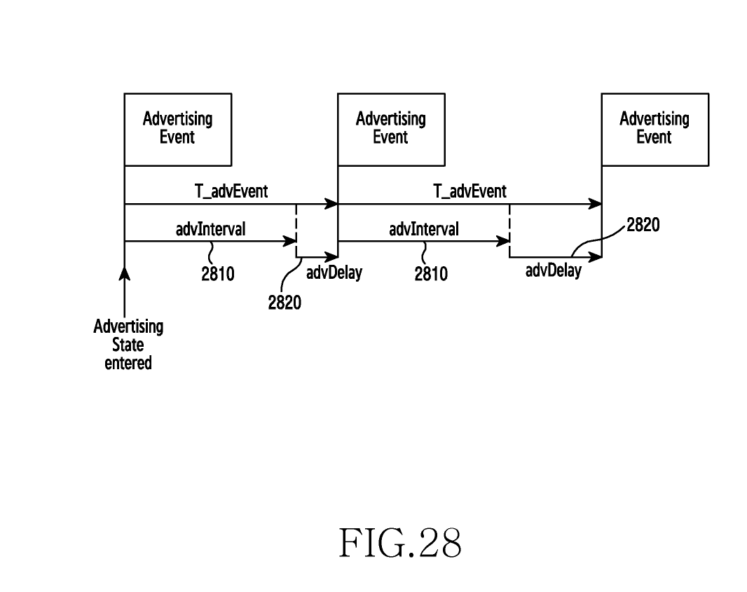

The second operation is to change a transmission/reception cycle. For example, as shown in FIG. 28, the transmission/reception cycle may be changed by changing an advertising interval (advInterval) 2810 and advertising delay (advDelay) 2820 for an advertising packet.

The value of the advertising interval (advInterval) should be larger than 100 ms in the case of scannable undirected event type or non-connectable undirected event type, and should be larger than 20 ms in the case of connectable undirected event type. The value of the advertising delay (advDelay) may be a randomly generated value among values from 0 ms to 10 ms.

By changing the advertising interval (advInterval) value and the advertising delay (advDelay) value as described above, the transmission/reception cycle of the beacon signal may be changed. For example, the number of times of transmission of the beacon signal may be changed to five times, 10 times, or 20 times per second. Further, the reception cycle of a beacon signal may be adjusted by changing the cycle of the scanning operation for receiving the beacon signal.

The third operation is to change the subject to receive the beacon signal, i.e. to change the subject to receive broadcast or advertisement. For example, on the basis of user information or terminal information registered in a phone book, a contact list, or a Social Network Service (SNS) within a terminal, the subject to receive the beacon signal may be limited to family, friends, and colleagues of the user of the terminal. In this event, device-related information, such as a MAC address of a counterpart terminal, may be received from a network server, etc.

The fourth operation is to change encryption change of a beacon signal, i.e. to encrypt and transmit a beacon signal, such that the degree of encryption may be changed according to the encryption level. When the beacon signal is not encrypted, all people can decode the beacon. When the beacon signal is encrypted, a user of the terminal having information for decrypting the encrypted beacon signal is allowed to decrypt the beacon signal.

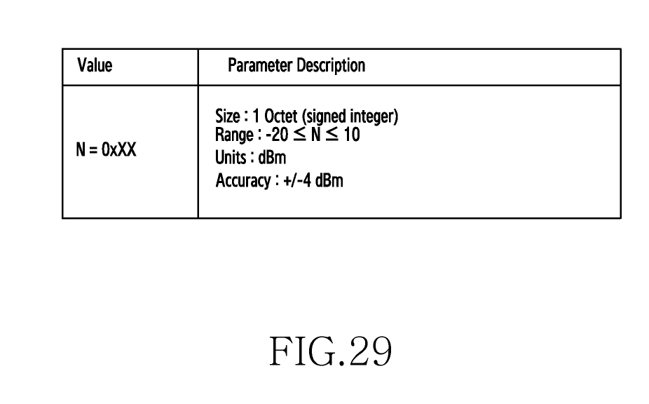

The fifth operation is to change the transmission power of the beacon signal. By changing the transmission power of the beacon signal, it is possible to change the range which the beacon signal can reach. The transmission power of the beacon signal may be, for example, determined within a range from −20 dBm to 10 dBm as shown in FIG. 29. The change of the transmission power may influence battery power consumption, interference to surrounding terminals, and the range of the beacon signal.

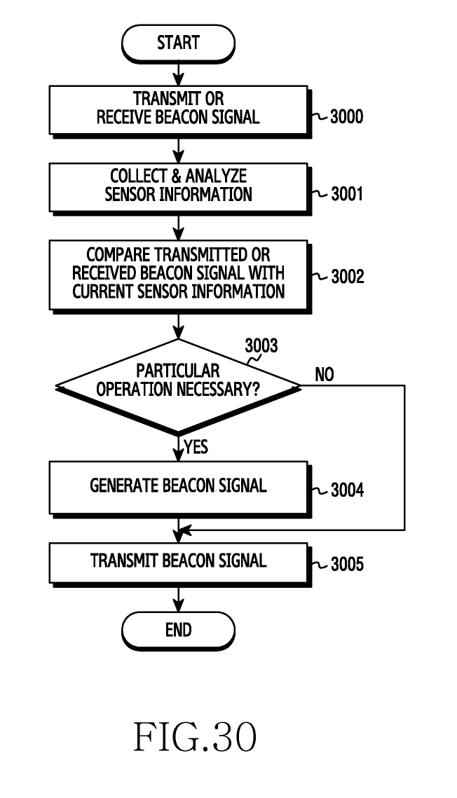

FIG. 30 is a flowchart illustrating a method of controlling a beacon signal by an electronic device according to another embodiment among various embodiments of the present disclosure. Referring to FIG. 30, for example, a processor 120 of an electronic device, such as a smart phone or a tablet PC, may transmit or receive a beacon signal in operation 3000, and collects and analyzes various sensor information in operation 3001.

The processor 120 analyzes the correlation between the transmitted or received beacon signal and the current sensor information by comparing them in operation 3002, and determines, on the basis of the correlation, whether a particular operation is necessary, in operation 3003.

As a result of the determination, when a particular operation is necessary, the processor actively controls generation of a beacon signal including contents suitable for the particular operation in operation 3004, and transmits the beacon signal in operation 3005. Various embodiments in relation thereto will be described in detail hereinafter.

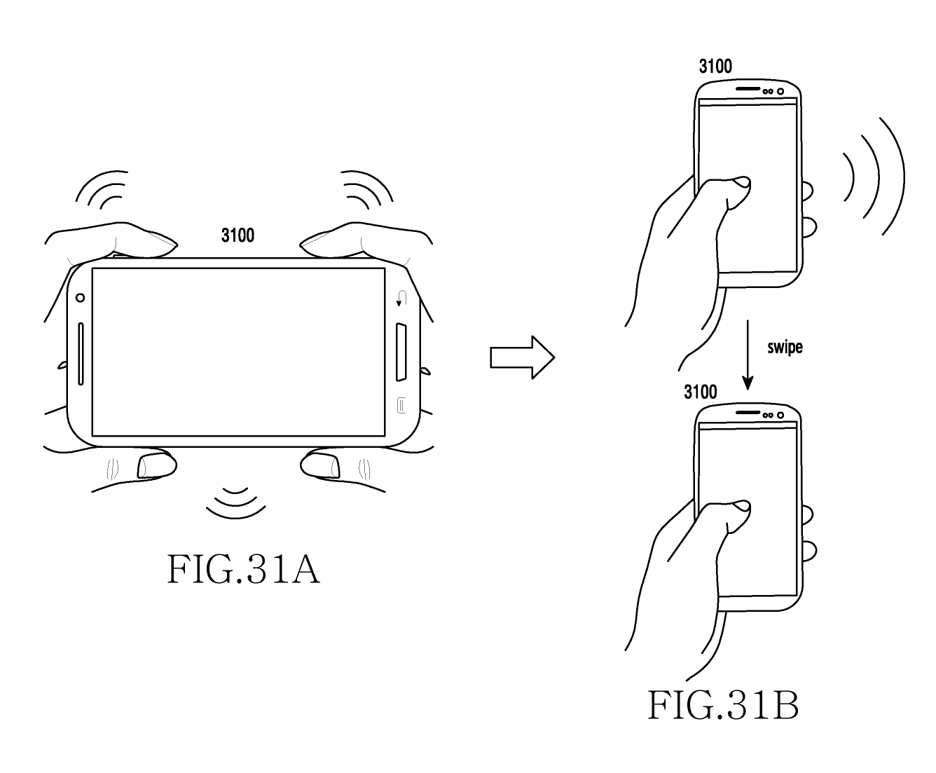

FIGS. 31A and 31B illustrate an example in which an electronic device according to various embodiments of the present disclosure controls a beacon signal on the basis of a motion sensor. Referring to FIGS. 31A and 31B, for example, when a user carrying a terminal 3100 enters a shop and is located in front of a product which the user wants to purchase, the processor 120 of the terminal collects and analyzes various sensor information.

For example, when a user's motion of taking a picture or a video by a camera is detected by a motion sensor, the processor 120 may actively generate and transmit a beacon signal relating to the camera on the basis of the motion information.

The transmitted beacon signal may be a beacon signal requesting information on a product photographed by the camera or a product shown in a preview image or may be a beacon signal requesting information on a product in front of the user regardless of the image taken by the camera.

Thereafter, when a motion for payment using a credit card by a user, for example, a motion of moving the terminal 3100 downward, as seen in FIG. 31A, or moving the terminal 3100 from the left to the right is detected (e.g., similar to a motion of swiping a card through a card payment terminal), as seen in FIG. 31B, the processor 120 of the terminal may actively generate a beacon signal relating to the card payment on the basis of corresponding motion information and the transmitted beacon signal.

For example, when a beacon signal transmitted within a pre-configured reference time (e.g., 30 minutes) is a beacon signal requesting product information and price, a beacon signal being currently transmitted is a beacon signal requesting a product price to be paid, and sensor information being currently received is motion information corresponding to card payment, the processor 120 may determine, on the basis of the correlation between the beacon signal transmitted within a pre-configured reference time or the beacon signal being currently transmitted and the sensor information being currently received, that the current operation is a card payment operation, and may automatically generate a beacon signal including contents corresponding to the card payment and then transmit the generated beacon signal.

Therefore, on the basis of the sensor information reflecting or corresponding to the motion (or gesture) of the terminal as described above, the processor may actively generate a beacon signal. In this event, if the beacon generated before the card payment motion (or gesture) is not a beacon requesting product information, another beacon signal different from the card payment may be generated thereafter.

Meanwhile, as another embodiment, using touch sensor information, when a touch input of the user is swiped in a particular direction, the direction in which the beacon signal is transmitted may be controlled. For example, the beacon signal may transmitted in the upward direction of the terminal when the touch input is swiped upward, and may be transmitted in the rightward direction of the terminal when the touch input is swiped from the left to the right.

Furthermore, interworking with a smart glass or a smart watch may be achieved. For example, information on the direction in which or an object to which a smart glass is oriented may be recognized on the basis of motion data or camera image data, and a beacon signal relating thereto may be then generated or transmitted in the corresponding direction.

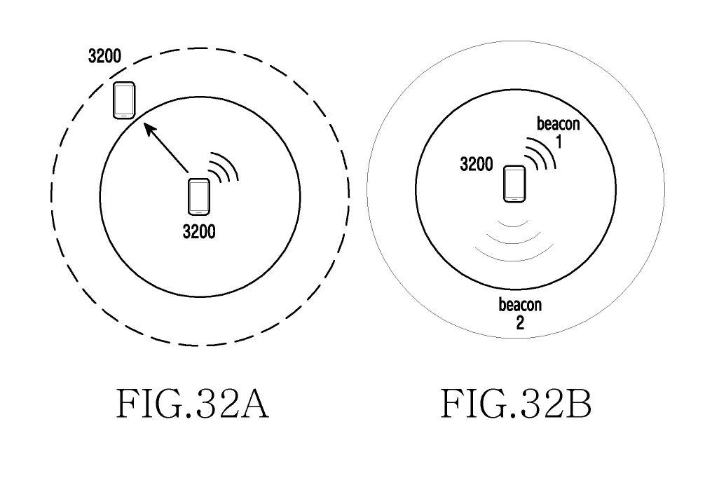

FIGS. 32A and 32B illustrate an example in which an electronic device according to various embodiments of the present disclosure controls a beacon signal on the basis of a position sensor. Referring to FIG. 32A, for example, when a terminal 3200 is located within a particular area (e.g., encircled by the solid line in FIG. 32A), the terminal 3200 generates and transmits (e.g., advertises) a beacon signal having a first cycle.

In this event, the processor 120 of the terminal 3200, which is receiving position information of the terminal 3200 from a position sensor (not shown), generates and transmits (e.g. advertises) a beacon signal having a second cycle when it escapes the particular area (into the area between the solid line and the dotted line in FIG. 32A). The second cycle may be slower than the first cycle and may include a cessation of transmission.

In another embodiment, the terminal 3200 may transmit an unencrypted beacon signal when it is located within a particular area (e.g., company) and may encrypt and transmit the beacon signal when it escapes the particular area. For example, when transmitting a beacon signal relating to company business, the terminal may not encrypt the beacon signal within the company and encrypt and transmit the beacon signal outside the company. The encrypted beacon signal as described above may be decrypted using a pre-defined decryption key or a key generated for decoding thereof.

In addition, referring to FIG. 32B, the arrival range of a beacon signal may be controlled according to a particular position or a particular status. For example, when a beacon signal should be sent to a far place, the beacon signal may be transmitted using a relatively storing transmission power of, for example, about −20 dBm. In contrast, when a beacon signal should be sent to a near place, the beacon signal may be transmitted using a relatively weak transmission power of, for example, about +10 dBm.

Further, two different types of beacon signals within a particular area may be alternately transmitted. Among the two different types of beacon signals, a first beacon signal may not relate to the range of the particular area, while a second beacon signal may relate to the range of the particular area. In this event, when the terminal 3200 escapes the particular area, such an escape may have an influence on the operation of the second beacon signal without having an influence on the operation of the first beacon signal.

The influence on the operation of the second beacon signal may include change of the transmission cycle, change of contents, change of the receiver, change of the transmission power, and change of encryption. Further, the range of the particular area may be defined by Geo-Fence.

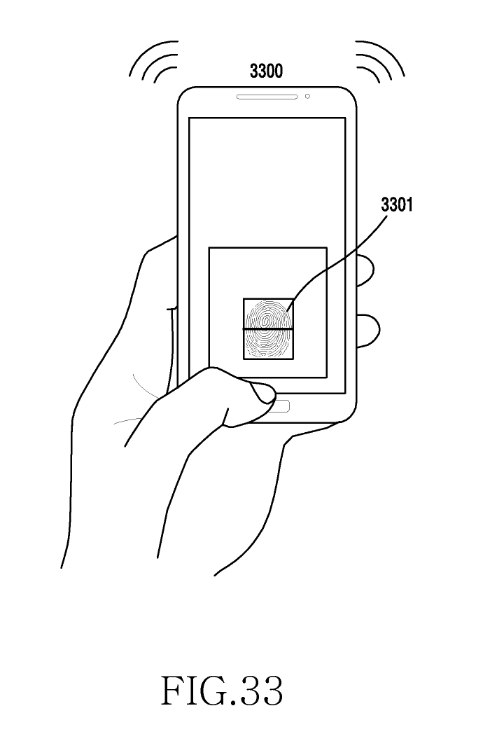

FIG. 33 illustrates an example in which an electronic device according to various embodiments of the present disclosure controls a beacon signal on the basis of a fingerprint sensor. Referring to FIG. 33, upon recognizing pre-configured fingerprint information 3301 of a user, the processor 120 of the terminal 3300 may generate and transmit a beacon signal relating to the fingerprint information 3301.

The beacon signal relating to the fingerprint information may be a beacon signal including the fingerprint information, a beacon signal including information authenticated using the fingerprint information, or a beacon signal encrypted using the fingerprint information.

Further, while transmitting a beacon signal including a predetermined content, when the fingerprint information 3301 is recognized, the processor may encrypt the beacon signal or appoint a subject to receive the beacon signal so that the beacon signal can be transmitted to a particular counterpart. Here, in order to appoint a subject to receive the beacon signal, the processor may include a MAC address of a receiver terminal in the transmitted beacon signal so that the receiver terminal can select and receive the beacon signal having a MAC address coinciding with the included MAC address.

Moreover, the fingerprint information may be used in a vehicle or a smart home. For example, when approaching a vehicle or being located in the vehicle, the processor may control the vehicle by transmitting a beacon signal authenticated on the basis of fingerprint information. Here, the controlling of a vehicle may be opening a door of the vehicle, adjusting an indoor system of the vehicle, and exchange of contents through interworking between the vehicle and the terminal.

Further, when approaching a house or being located in the house, the processor may control the house by transmitting a beacon signal authenticated on the basis of fingerprint information. Here, the controlling of a house may be opening a door of the house, controlling home electronic appliances of the house, and exchange of contents through interworking between the house and the terminal.

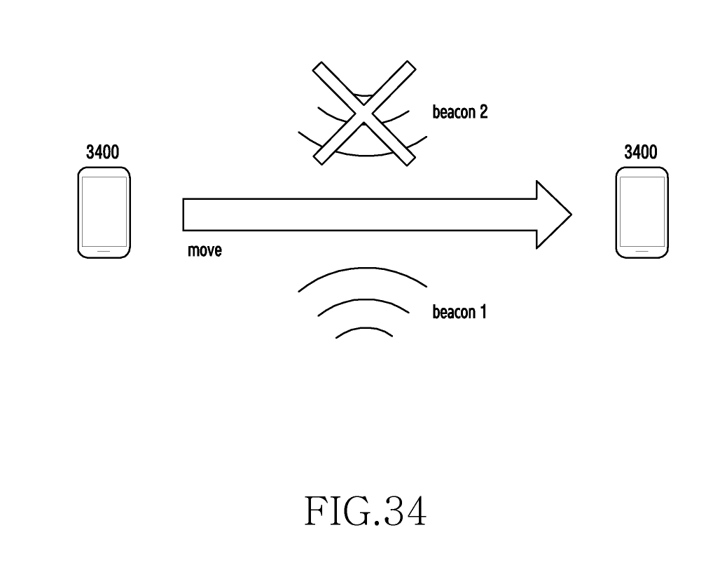

FIG. 34 illustrates an example in which an electronic device according to various embodiments of the present disclosure controls a beacon signal on the basis of an acceleration sensor. Referring to FIG. 34, the processor 120 of a terminal 3400 may measure movement of the terminal 3400 using an acceleration sensor (not shown). When it is determined that the terminal 3400 is moving at a speed higher than, lower than, or equal to a predetermined speed, the processor may control the operation of the terminal to transmit or receive a beacon.

For example, when the terminal 3400 is rapidly moving at a predetermined speed or faster, the terminal may selectively receive a necessary beacon signal (e.g. beacon 1 of FIG. 34) without receiving an unnecessary beacon signal (e.g. beacon 2 of FIG. 34). The necessary beacon signal may be a beacon signal including particular contents. Specifically, the terminal may selectively receive a beacon signal including advertisement without receiving a beacon signal relating to data having a large capacity.

As another example, the terminal may receive a beacon signal transmitted in a particular direction. For example, the terminal may receive a beacon signal received from the front side of the moving path without receiving a beacon signal received from the rear side of the moving path. As another example of the control of the operation of receiving the beacon signal, when a terminal moves at a predetermined speed or faster, the cycle of a scan operation for receiving a beacon signal may be changed. The changing of the scan operation may include accelerating or decelerating the scan cycle or stopping the scan operation.

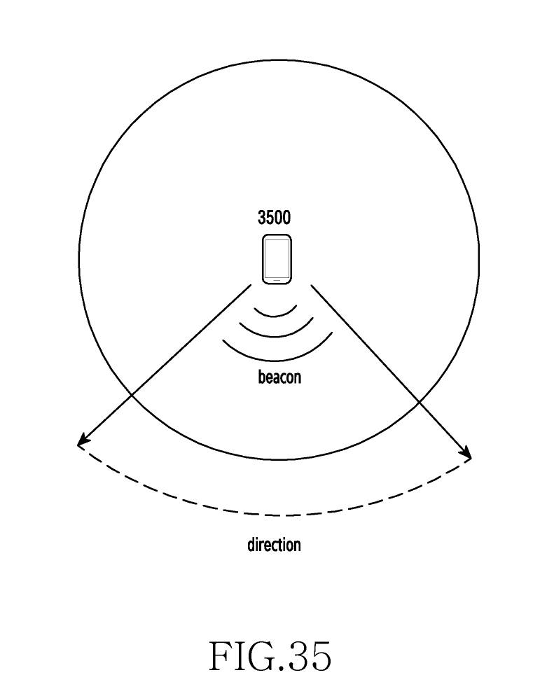

FIG. 35 illustrates an example in which an electronic device according to various embodiments of the present disclosure controls a beacon signal on the basis of a geomagnetic sensor. Referring to FIG. 35, the processor 120 of a terminal 3500 may measure the direction toward which the terminal 3500 is oriented, using a geomagnetic sensor (not shown). As a result, the terminal may transmit a beacon signal in a direction toward which the terminal is oriented or receive a beacon signal received from the direction toward which the terminal is oriented.

For example, when the terminal 3500 has entered a shop transmitting various beacon signals or a shop having a transmitter transmitting a plurality of beacon signals, the terminal receives beacon signals from all around. In this case, since most of the plurality of beacon signals may be unnecessary for a user of the terminal, the terminal may selectively receive beacon signals received from the direction toward which the user is oriented.

For example, a beacon signal received from the direction toward which the user is oriented may be identified using absolute position coordinates of the current position of the user and the position from which the beacon signal is transmitted, and a geomagnetic sensor value of the terminal. Further, a beacon receiver chip itself, such as WiFi or Bluetooth, may measure the direction of the received beacon signal.

Further, the direction toward which the user is oriented may be detected using an image input to a camera sensor. Moreover, using the geomagnetic sensor, the beacon signal may be controlled to be transmitted in the direction toward which the user is oriented. For example, when a user wants to transmit a beacon signal to a particular device, the direction in which the user is oriented toward the particular device may be detected using the geomagnetic sensor value of the terminal and the transmission module may be controlled to allow the beacon signal to be transmitted in the detected direction.

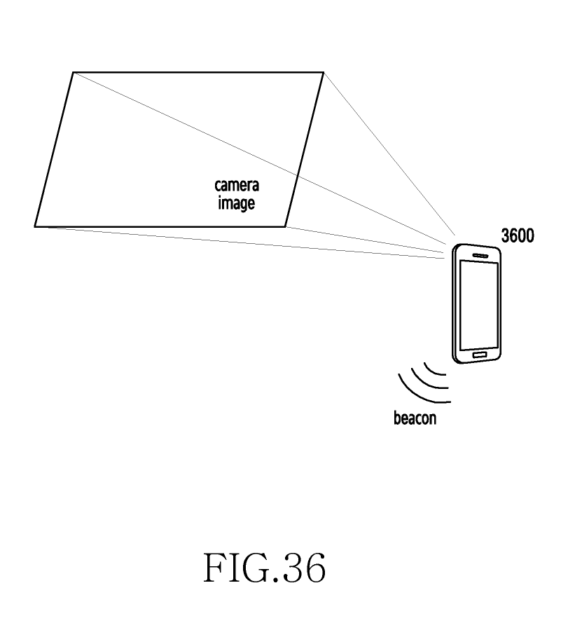

FIG. 36 illustrates an example in which an electronic device according to various embodiments of the present disclosure controls a beacon signal on the basis of a camera sensor. Referring to FIG. 36, when detecting use of a camera sensor (not shown), the processor 120 of a terminal 3600 may generate and transmit a beacon signal relating to the camera sensor. The camera sensor may be also called a camera or image sensor.

The beacon signal relating to the camera sensor may be, for example, a beacon signal reporting that the terminal 3600 is executing a camera shooting or capture, or a beacon signal relating to an image taken by a camera sensor. That is, an image or a video taken by a camera sensor may be included in the transmitted beacon signal or information relating to an image or a video taken by a camera sensor may be extracted and is then included in the transmitted beacon signal.

For example, the information relating to an image or a video taken by a camera sensor may be included in a beacon signal in order to request connection to a particular device by analyzing information of the particular device included in an image taken by a camera sensor of a terminal in response to taking of the particular device by the camera sensor by a user.

Further, as another example, the information relating to an image or a video taken by a camera sensor may be summarized information on the image taken by the camera sensor. For example, when a menu is shot by a camera sensor in a restaurant, the menu in an image thereof taken by the camera sensor may be recognized and a beacon signal including summarized information on the menu may be then transmitted.

Further, if food is photographed by the camera sensor, food information may be analyzed and summarized or a beacon signal including the analyzed information may be transmitted. When the image taken by the camera sensor is analyzed, information of the current position may be used together.

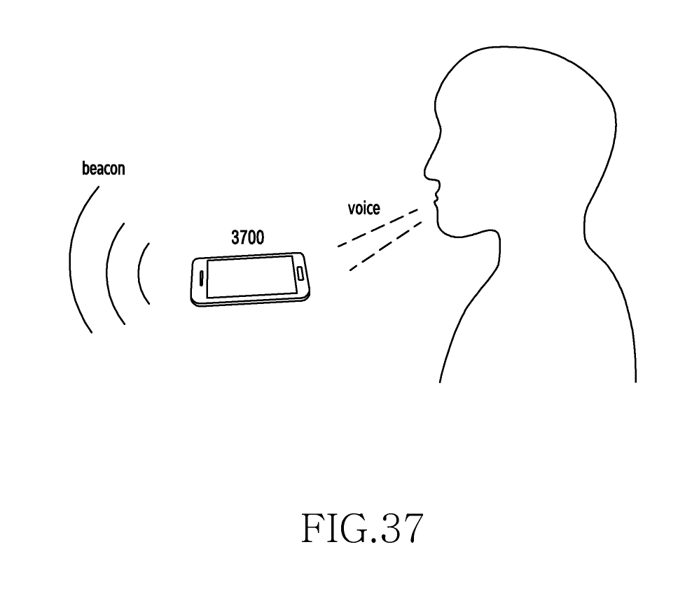

FIG. 37 illustrates an example in which an electronic device according to various embodiments of the present disclosure controls a beacon signal on the basis of a microphone sensor. Referring to FIG. 37, when detecting use of a microphone sensor (not shown), the processor 120 of a terminal 3700 may generate and transmit a beacon signal relating to the microphone sensor. The microphone sensor may be called a “mike” or “mic” sensor.

For example, the terminal 3700 may generate a beacon signal indicating “in recording utilizing a microphone sensor,” or a beacon signal relating to voice input through a microphone sensor. For example, the beacon signal relating to voice may include a beacon signal relating to authentication to authenticate a user by authenticating voice of the user input from the microphone sensor.

Further, a beacon signal being current transmitted may be encrypted or transmitted with a change security level. In other words, in a state of transmitting an unencrypted beacon signal, when a user is authenticated through a voice input of the user, the security level may be changed so that the beacon signal may be encrypted to be a beacon signal which a particular person is allowed to receive, or a subject to receive the beacon signal may be appointed.

Another example of the beacon signal relating to voice may include a beacon signal used for communication. A unidirectional service, such as push-to-talk service, may be provided using a beacon signal. For example if a user inputs voice through a microphone sensor, the voice may be converted to a digital signal and may be included in a beacon signal, which may be then transmitted to a counterpart.

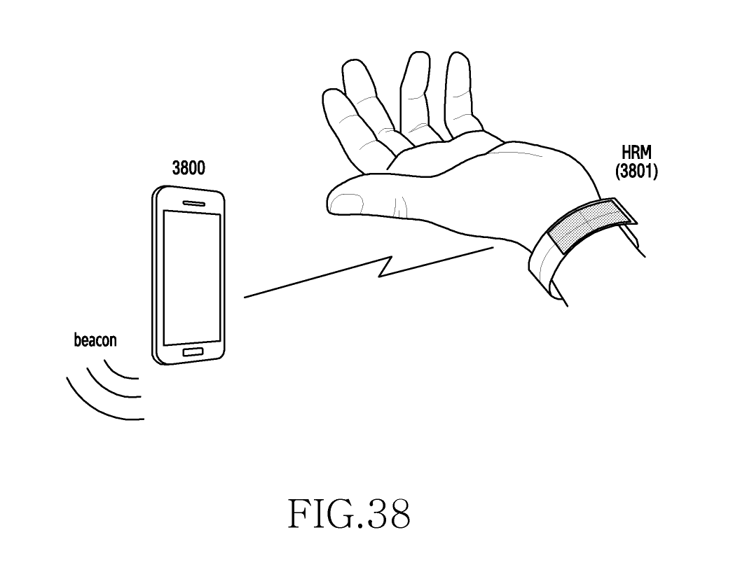

FIG. 38 illustrates an example in which an electronic device according to various embodiments of the present disclosure controls a beacon signal on the basis of a heart rate monitor. Referring to FIG. 38, when physical information of a user is collected from a Heart Rate Monitor (HRM) sensor 3801, the processor 120 of a terminal 3800 may generate and transmit a related beacon signal.

For example, using the HRM sensor 3801, it is possible to check a case where the heart rate of a user abruptly becomes very rapid or very slow even without the user taking exercise. When such a dangerous status is detected, the terminal 3800 may generate a beacon signal reporting the status and transmit the beacon signal to the surroundings.

Further, the beacon signal may be transmitted to a predetermined person. Moreover, the beacon signal may be transferred to a server (e.g. server in a police station) through a data network, such as a cellular or WiFi communication network, rather than a beacon signal. Like the HRM sensor 3801, the terminal 3800 may generate and transmit a beacon signal using a sensor for measuring biological and health information, such as an oxygen saturation measurement sensor or a stress measurement sensor.

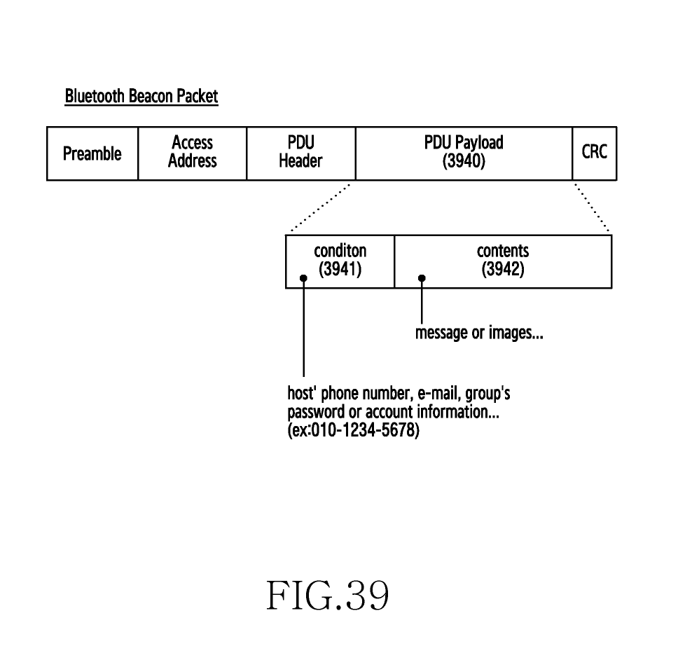

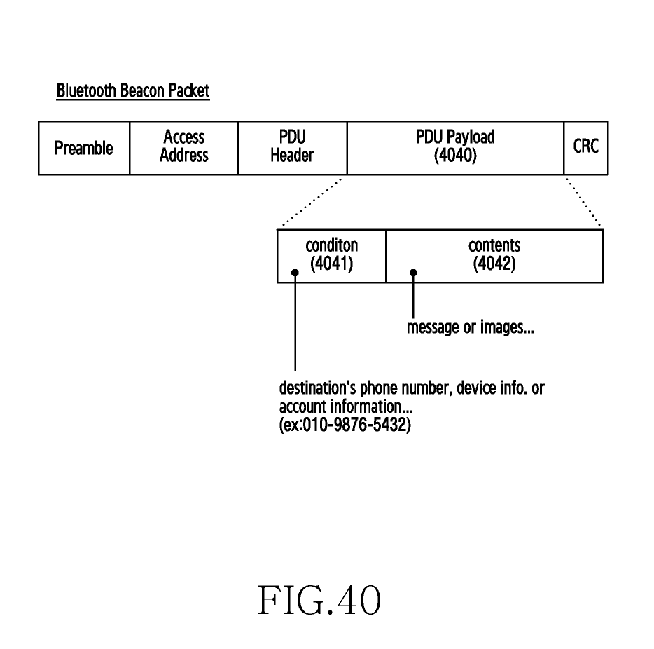

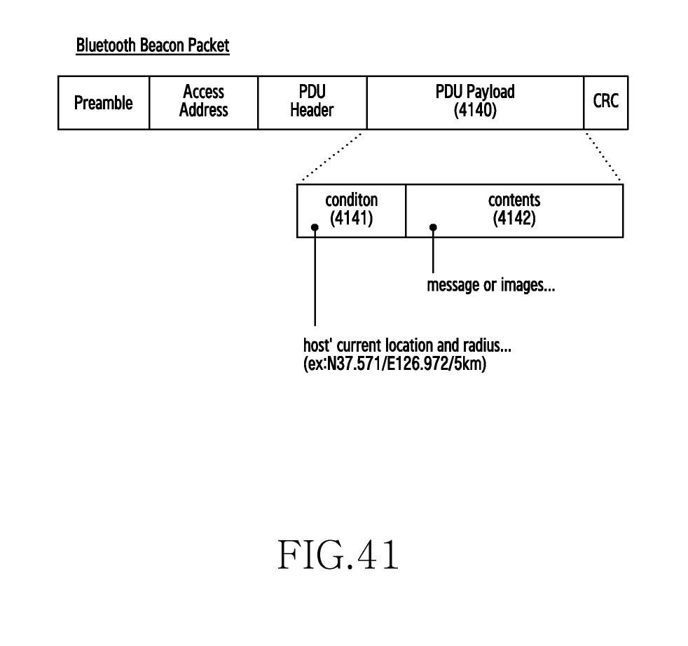

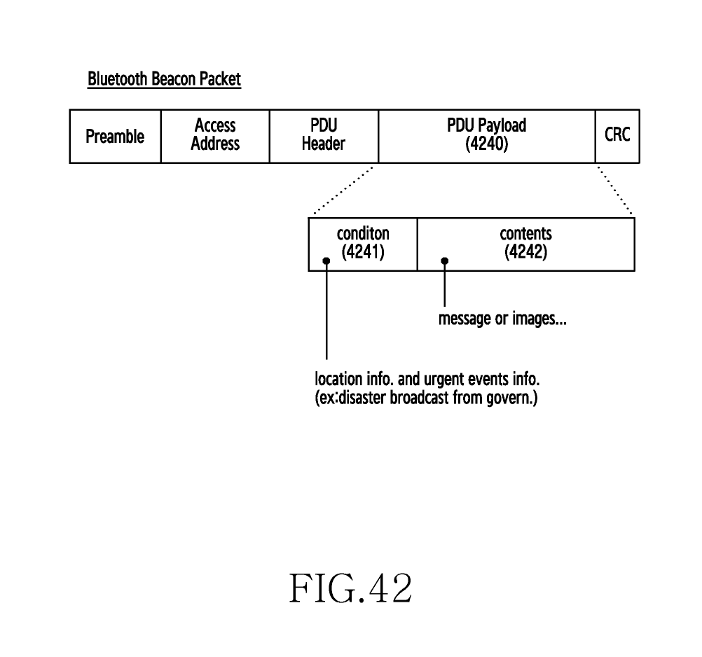

FIGS. 39 to 42 illustrate the structures of transfer condition information 3941, 4041, 4141, and 4241 included in a BLE beacon packet according to various embodiments of the present disclosure. As the first embodiment, referring to FIG. 39, a PDU payload 3940 within the BLE beacon packet may include contents 3942 including various messages or images. Further, the PDU payload 3940 may include relay condition information 3941 to enable an electronic device having received the BLE beacon packet to determine whether to relay the BLE beacon packet to another electronic device.

For example, the relay condition information 3941 may include a phone number (host's phone number), an email address, a group password, or Social Network Service (SNS) account information of an electronic device having initially transmitted the BLE beacon packet.

As the second embodiment, referring to FIG. 40, the PDU payload 4040 within the BLE beacon packet may include contents 4042 including various messages or images and relay condition information 4041. For example, the relay condition information 4041 may include a destination's phone number or device information as terminal identification information of an electronic device corresponding to a destination to receive the BLE beacon packet. Otherwise, the relay condition information may include SNS account information.

As the third embodiment, referring to FIG. 41, the PDU payload 4140 within the BLE beacon packet may include contents 4142 including various messages or images and relay condition information 4141. For example, the relay condition information 4141 may include a host's current location of an electronic device having initially transmitted the BLE beacon packet and radius information for limiting the transmission distance as information for limiting the area to which the BLE beacon packet should be delivered.

As the fourth embodiment, referring to FIG. 42, the PDU payload 4240 within the BLE beacon packet may include contents 4242 including various messages or images and relay condition information 4241. For example, the relay condition information 4241 may include location information and urgent event information relating to generation of an emergency situation or urgent situation.

The relay condition information may be included in a PDU payload of a BLE beacon packet as described above, a PDU header of a BLE beacon packet, or one of a preamble or access address of the BLE beacon packet.

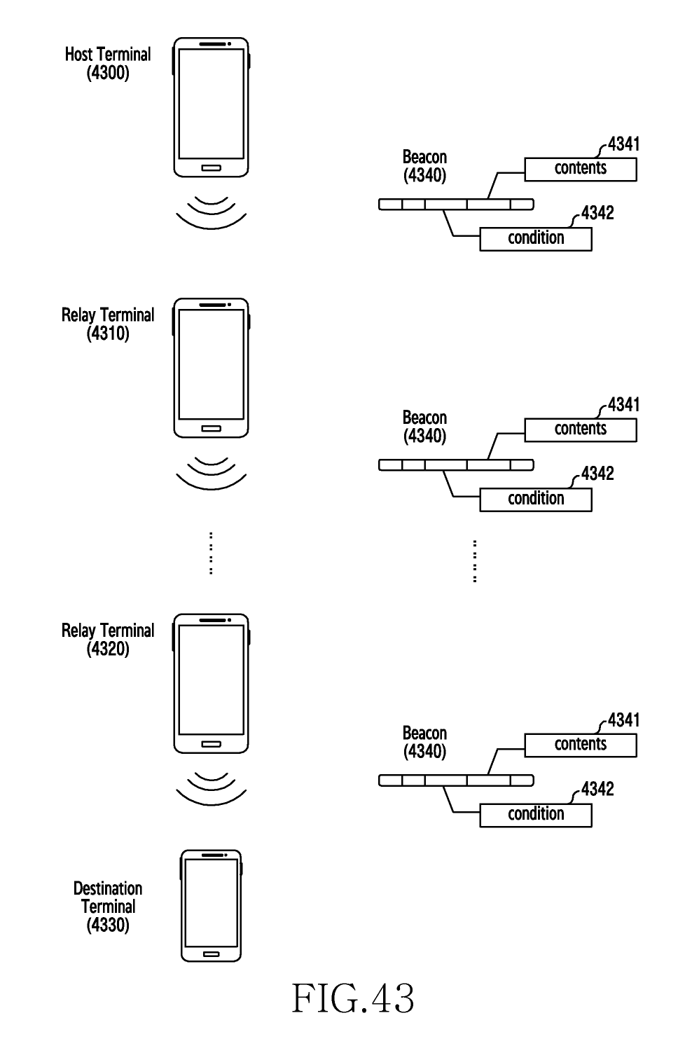

FIG. 43 illustrates an example beacon relay process according to various embodiments of the present disclosure. Referring to FIG. 43, an electronic device initially transmitting a beacon signal 4340 may be called a host terminal 4300, an electronic device which receives the beacon signal and relays the beacon signal to another electronic device may be called a relay terminal 4310 or 4320, and an electronic device which finally receives the beacon signal may be called a destination terminal 4330 or various other names.

The beacon signal 4340 may include various types of contents 4341, which the host terminal 4300 wants to relay through beacon communication, and relay condition information 4342 to be used for the relay terminal 4310 or 4320 in determining whether to relay the beacon signal to another electronic device, and the relay condition information 4342 may be called another predetermined name.

The contents 4341 is included in the PDU payload as described above, and the relay condition information 4342 may be included in the PDU payload, the PDU header, or one of a preamble or access address.

When the beacon signal 4340 initially transmitted from the host terminal 4300 is received by the first relay terminal 4310, the first relay terminal 4310 analyzes the relay condition information 4342 included in the beacon signal 4340 and determines whether to relay the received beacon signal 4340 to another electronic device. Further, when it is determined to relay the beacon signal, the first relay terminal 4310 transmits the beacon signal 4340 to another electronic device.

When the beacon signal 4340 transmitted from the first relay terminal 4310 is received by the second relay terminal 4320, second the relay terminal 4320 analyzes the relay condition information 4342 included in the beacon signal 4340 and determines whether to relay the received beacon signal 4340 to another electronic device. Further, when it is determined to relay the beacon signal, the second relay terminal 4320 transmits the beacon signal 4340 to another electronic device.

When the beacon signal 4340 transmitted from the second relay terminal 4320 is received by the destination terminal 4330, the destination terminal 4330 analyzes the relay condition information 4342 included in the beacon signal 4340 and determines whether to relay the received beacon signal 4340 to another electronic device. Further, when it is determined not to relay the beacon signal, the destination terminal does not transmit the beacon signal 4340 to another electronic device.

While passing through the communication path including the first relay terminal 4310, the second relay terminal 4320, and the destination terminal 4330, the contents 4341 included in the beacon signal 4340 may be reproduced either by each of the terminals 4310, 4320, and 4330 or by the destination terminal 4330 which finally receives the beacon signal 4340.

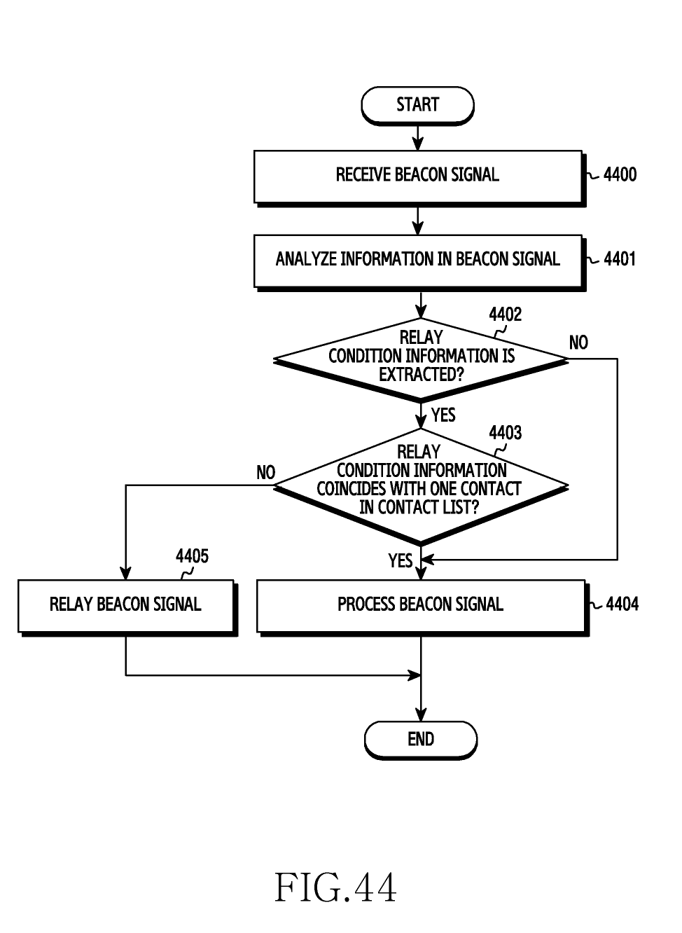

FIG. 44 is a flowchart illustrating a method of relaying a beacon signal by an electronic device according to another embodiment among various embodiments of the present disclosure. For example, it is assumed that a beacon receiver, which is usually included in various types of electronic devices, such as a smart phone or tablet PC, and a beacon manager 320 are included in the Bluetooth module 380 of FIG. 3 and the processor 120 of FIG. 1, respectively.

Referring to FIG. 44, the processor 120 receives a beacon signal through the Bluetooth module 380 in operation 4400 and analyzes information of the received beacon signal in operation 4401. When relay condition information is extracted from the analyzed information in operation 4402, the processor 120 determines, in operation 4403, whether the relay condition information coincides with one contact in a contact list stored in the electronic device.

For example, as described above with reference to FIG. 40, the relay condition information 4041 extracted from the PDU payload 4040 may be one of a phone number, email address, a group password, and SNS account information of the electronic device having initially transmitted the beacon signal.

When at least one contact in a contact list stored in the electronic device, for example, at least one of a phone number, email address, a group password, and SNS account information, coincides with the relay condition information, the processor 120 may process the received beacon signal in operation 4404. In contrast, when they do no coincide, the processor relays the received beacon signal to another electronic device in operation 4405.

That is, when relay condition information is not extracted in operation 4402 or when the relay condition information coincides with one piece of information among information in the contact list stored in the electronic device, the processor 120 reproduces the received beacon signal without relaying it to another electronic device.

In contrast, when the relay condition information does not coincide with any information among the information in the contact list stored in the electronic device, the processor 120 relays the received beacon signal to another electronic device in operation 4403. In this case, the beacon signal may be reproduced as soon as it is relayed to the another electronic device.

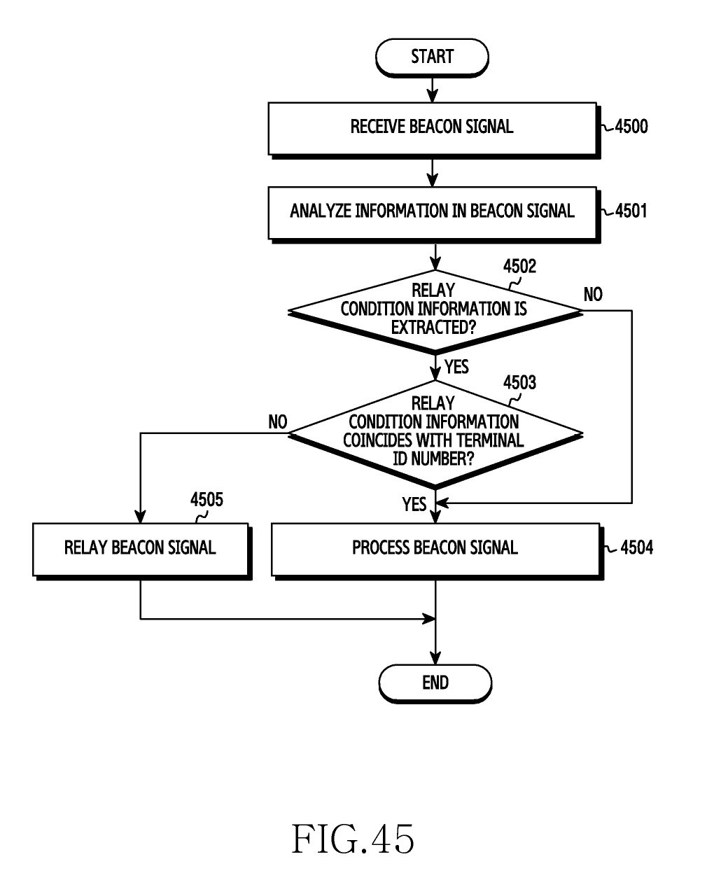

FIG. 45 is a flowchart illustrating a method of relaying a beacon signal by an electronic device according to another embodiment among various embodiments of the present disclosure. As described above with reference to FIG. 45, it is assumed that the beacon receiver and the beacon manager 320 are included in the Bluetooth module 380 and the processor 120, respectively.

Referring to FIG. 45, the processor 120 receives a beacon signal through the Bluetooth module 380 in operation 4500 and analyzes information of the received beacon signal in operation 4501. When relay condition information is extracted from the analyzed information in operation 4502, the processor 120 determines, in operation 4503, whether the relay condition information coincides with terminal identification information allocated to the electronic device.

For example, as described above with reference to FIG. 40, the relay condition information 4041 extracted from the PDU payload 4040 is terminal identification information corresponding to a destination which should receive the beacon signal, and may be one of a destination phone number, device information, and SNS account information.

When the terminal identification information allocated to the electronic device, for example, at least one of a phone number, device information, and SNS account information, coincides with the relay condition information, the processor 120 may process the received beacon signal in operation 4504. In contrast, when they do no coincide, the processor relays the received beacon signal to another electronic device in operation 4505.

That is, when relay condition information is not extracted in operation 4502 or when the relay condition information coincides with the terminal identification information allocated to the electronic device, the processor 120 reproduces the received beacon signal without relaying it to another electronic device in operation 4503.

In contrast, when the relay condition information does not coincide with the terminal identification information allocated to the electronic device, the processor 120 relays the received beacon signal to another electronic device in operation 4503. In this case, the beacon signal may be reproduced as soon as it is relayed to the another electronic device.

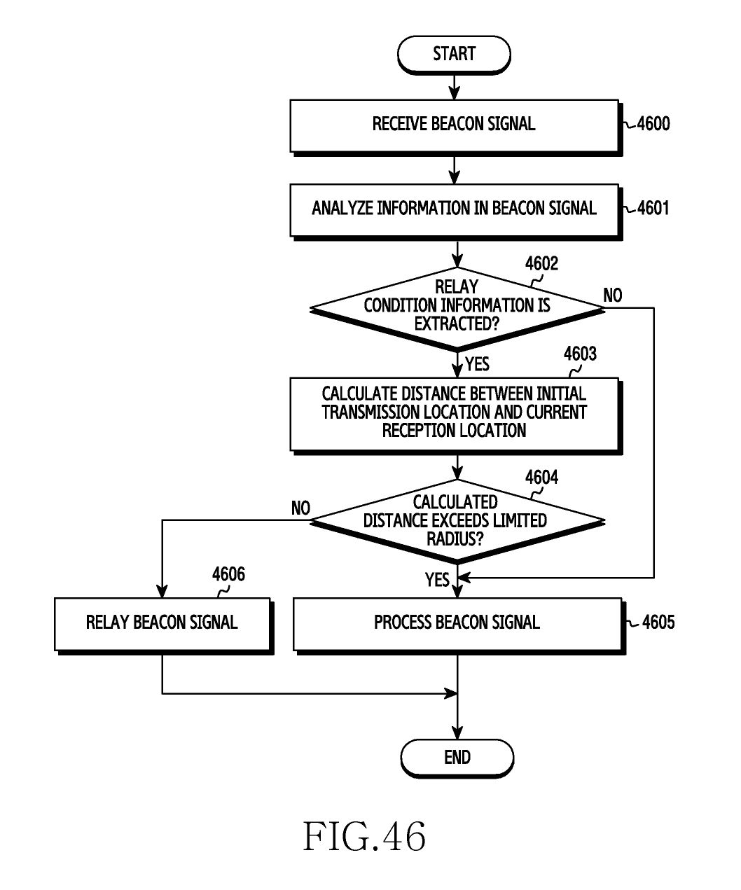

FIG. 46 is a flowchart illustrating a method of relaying a beacon signal by an electronic device according to another embodiment among various embodiments of the present disclosure. As described above with reference to FIG. 3, it is assumed that the beacon receiver for receiving the beacon and the beacon manager 320 are included in the Bluetooth module 380 and the processor 120, respectively.

Referring to FIG. 46, the processor 120 receives a beacon signal through the Bluetooth module 380 in operation 4600 and analyzes information of the received beacon signal in operation 4601. When relay condition information is extracted from the analyzed information in operation 4602, the processor 120 calculates a distance between the location of the electronic device having initially transmitted the beacon signal and the location of the electronic device having received the beacon signal in operation 4603.

For example, as described above with reference to FIG. 41, the relay condition information 4141 extracted from the PDU payload 4140 may be radius information for limiting the current location information and the transmission distance of the electronic device having initially transmitted the beacon signal.

Using the current location information detected by the GPS module 227 of FIG. 2 and current location information extracted as the relay condition information, the processor 120 calculates a distance between the location where the beacon signal has been initially transmitted and the current location where the beacon signal has been received.

In operation 4604, the processor 120 determines whether the calculated distance exceeds a limited radius of the radius information extracted as the relay condition information. As a result of the determination, the processor process the received beacon signal in operation 4605 when the calculated distance exceeds the limited radius, and relays the received beacon signal to another electronic device in operation 4606 when the calculated distance does not exceed the limited radius.

That is, when relay condition information is not extracted in operation 4602 or when the calculated distance exceeds the limited radius, the processor 120 reproduces the received beacon signal without relaying it to another electronic device in operation 4604. In this case, the beacon signal may neither be relayed to the another electronic device nor be reproduced.

In contrast, when the calculated distance does not exceed the radius information, the processor 120 relays the received beacon signal to another electronic device in operation 4604. In this case, the beacon signal may be reproduced as soon as it is relayed to another electronic device.

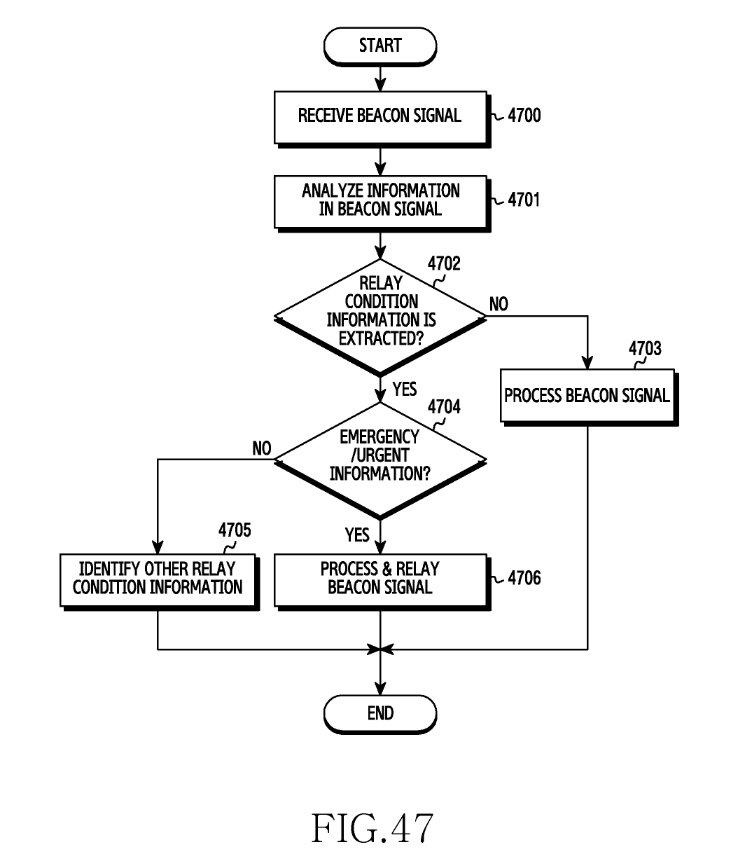

FIG. 47 is a flowchart illustrating a method of relaying a beacon signal by an electronic device according to another embodiment among various embodiments of the present disclosure. As described above with reference to FIG. 3, it is assumed that the beacon receiver for receiving the beacon and the beacon manager 320 are included in the Bluetooth module 380 and the processor 120, respectively.

Referring to FIG. 47, the processor 120 receives a beacon signal through the Bluetooth module 380 in operation 4700 and analyzes information of the received beacon signal in operation 4701. When relay condition information is not extracted from the analyzed information in operation 4702, the processor 120 processes the beacon signal in operation 4703. When relay condition information is not extracted from the analyzed information, the processor determines, in operation 4704, whether the relay condition information is information corresponding to emergency or urgency.

For example, as described above with reference to FIG. 42, the relay condition information 4241 extracted from the PDU payload 4240 may be location information and urgent event information where an emergency situation or urgent situation is generated.

When the relay condition information is not emergency information or urgent information, the processor 120 identifies other relay condition information in operation 4705. When the relay condition information is emergency information or urgent information, the processor processes the received beacon signal and relays the received beacon signal to another electronic device in operation 4706.

In other words, when the relay condition information is information corresponding to emergency situation or urgent situation, the processor 120 reproduces the received beacon signal and relays the received beacon signal to another electronic device so that the emergency information or urgent information can be rapidly and widely shared.

Meanwhile, according to various embodiments of the present disclosure, when the beacon signal is not smoothly relayed, the communication module for transmitting the beacon signal may be optionally changed. For example, even though the beacon signal has been received through a Bluetooth module, if it is difficult to smoothly use the Bluetooth module in transmitting the beacon signal to another electronic device, the beacon signal may be transmitted to another electronic device using another communication module, such as a WiFi module, an infrared module, a speaker, or a visible light module.

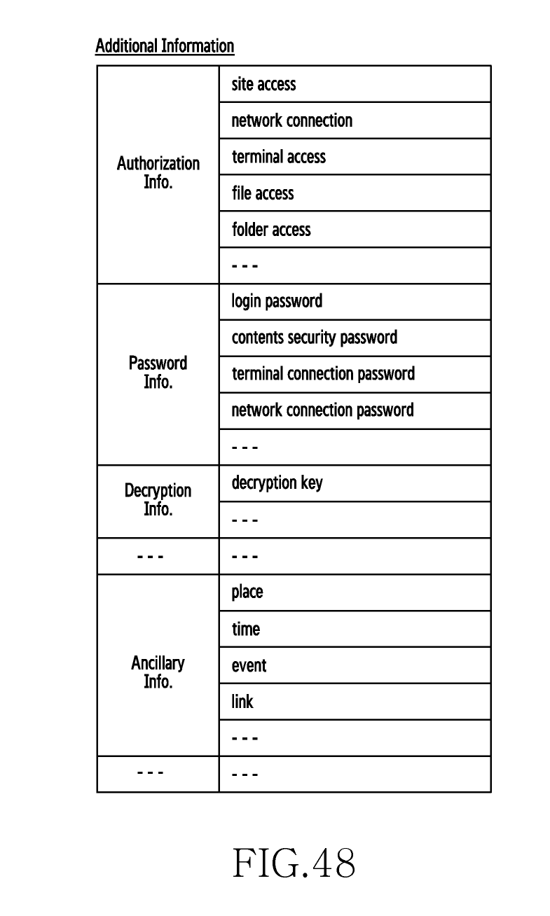

FIG. 48 illustrates an example of additional information according to various embodiments of the present disclosure. Referring to FIG. 48, the additional information may include at least one among authorization information, password information, and decryption information. Moreover, the additional information may include, as auxiliary information, at least one among information of a place for receiving a beacon signal, time information, information of an event generated at the place, and link information. Here, the auxiliary information may be called another name and may be included as mandatory information.

The authorization information may be information for access to at least one among a site, a network, a terminal, a file and a folder, and may include, for example, a URL, a key code, or a certification number necessary for executing site access, network connection, terminal access, file access, and folder access.

The password information may be, for example, one among a login password, content security password, a terminal connection password, and a network connection password, and the decryption information may include a decryption key for decrypting an encrypted content. Herein, each piece of information may be referred to as another predetermined name.

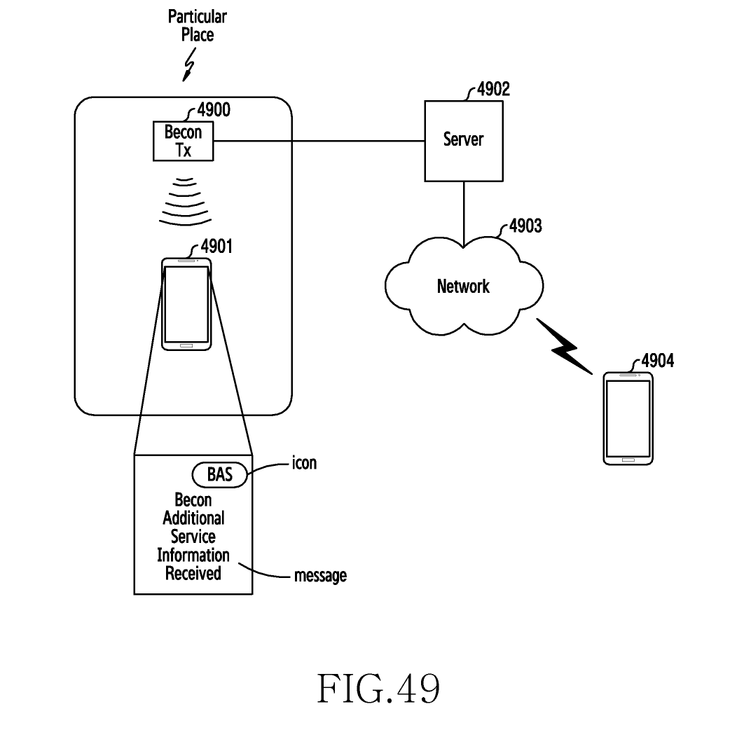

FIG. 49 illustrates an example in which an electronic device 4901 according to various embodiments of the present disclosure receives a beacon signal at a particular place. Referring to FIG. 49, for example, when the electronic device 4901 is located at a particular place, such as a venue, a restaurant, or a conference room, the electronic device may receive a beacon signal transmitted (e.g. broadcasted) by a beacon transmitter (beacon Tx) 4900 installed in the particular place.

The electronic device 4901 may extract additional information from the beacon signal and store the extracted additional information. Further, in order to enable a user to know the storage of the extracted additional information, the electronic device may display a message reporting reception of beacon additional service information or a pre-configured particular icon (e.g. Beacon Additional Service; BAS).

The beacon transmitter 4900 may interwork with various servers 4902, such as web sites for providing various contents (e.g. performance video, food discount coupon, minutes, etc.) relating to an event generated in the particular place, connecting to other terminals 4904, or may be independently operated as a separate element.

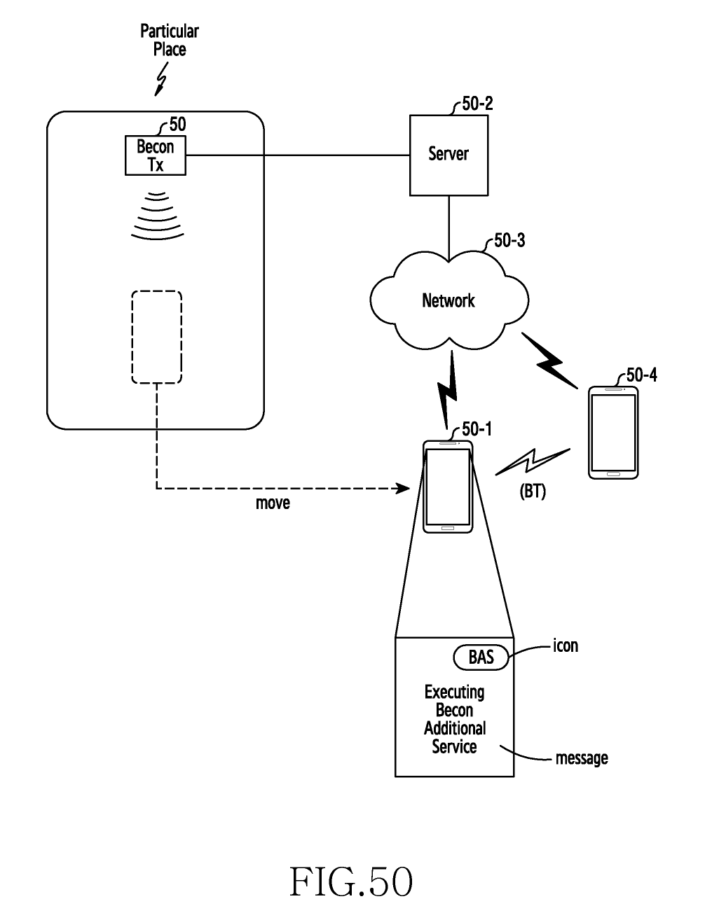

FIG. 50 illustrates an example in which an electronic device 50-1 according to various embodiments of the present disclosure communicates with a server 50-2 or terminal 50-4 through a beacon additional service over a network 50-3. Referring to FIG. 50, for example, at a position within the particular place 50 or out of the particular place 50, the electronic device 50-1 may execute a beacon additional service in response to a request from a user.

For example, when a user touches a particular icon (e.g. BAS) displayed in the electronic device 50-1, the electronic device 50-1 may access a resource, such as a particular site or particular network, using additional information received and stored at the particular place, and then acquire various contents through particular site or particular network. The network may include a content server, a cloud server, web sites, and entities connected through P2P communication.

The contents may be various contents, such as performance video, food discount coupon, and minutes. For example, if the particular place is a venue, the contents which can be acquired through the particular site or particular network may be a music file or a performance video.

In contrast, if the particular place is a restaurant, the contents may be a food discount coupon. If the particular place is a conference room, the contents may be minutes. In other words, the contents may be various types of contents which are added to basic contents and are additionally or limitedly provided to a user who has visited the particular place.

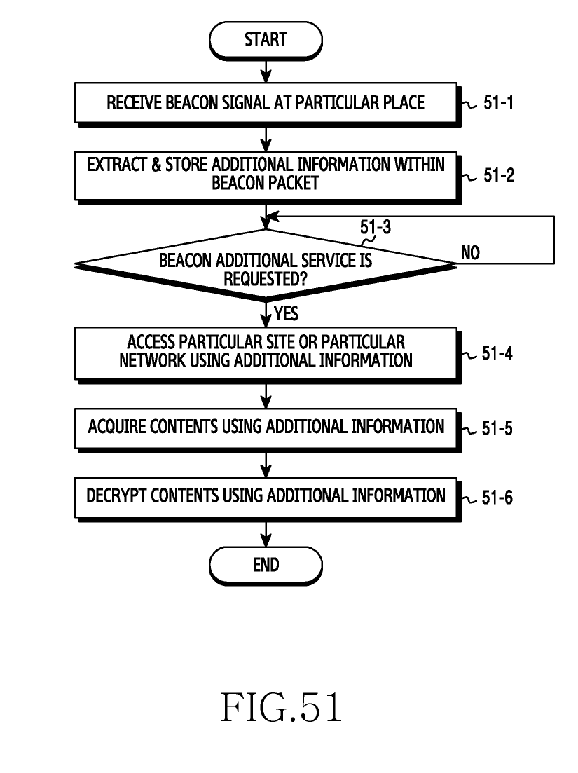

FIG. 51 is a flowchart illustrating a beacon additional service method of an electronic device according to various embodiments of the present disclosure. For example, the beacon manager 320 may be included in the processor 120 of the electronic device as described above.

Referring to FIG. 51, in operation 51-1, the beacon manager 320 or the processor 120 including the beacon manager 320 may receive a beacon signal transmitted from a particular place, through at least one module among the baseband module 350, the WiFi module 360, the infrared module 370, the Bluetooth module 380, the speaker 390, and the visible light module 391.

In operation 51-2, the beacon manager 320 or the processor 120 including the beacon manager 320 may extract additional information from the beacon signal and store the extracted information in an internal memory or external memory.

For example, as shown in FIG. 4, the beacon manager or the processor may extract user data included in a payload within a beacon packet. Then, when the extracted user data is additional information to enable access to a particular site or network and acquisition of contents therefrom, the beacon manager or the processor may identify the type of the additional information and then store the additional information after classifying the additional information into authorization information, password information, and decryption information as shown in FIG. 48.

Moreover, the beacon manager or the processor may store, as auxiliary information, information of a place for receiving a beacon signal, time information, information of an event generated at the place, and link information.

In operation 51-3, the processor 120 may determine whether execution of a beacon additional service is requested by a user. For example, when a user touches a particular icon (e.g. Beacon Additional Service; BAS) displayed on a display screen of the electronic device, the process may determine that execution of a beacon additional service has been requested.

In operation 51-4, the processor 120 may access a particular site or particular network using already stored additional information at a particular place in order to the beacon additional service. For example, the processor may access a particular site using site access information among the authority information stored as the additional information, may access a particular network (e.g. company communication network) using network connection information.

In operation 51-5, the processor 120 may acquire various contents through the connected particular site or particular network, using the additional information. For example, the processor may log in the particular site using a login password among the password information stored as the additional information and then read or acquire contents, or may access the particular network (e.g. company communication network) using network connection password and then read or acquire contents through an interfacing with a server or a terminal accessing the particular network.

In operation 51-6, the processor 120 may perform a decryption operation using a decryption key, which is decryption information stored as additional information, when the acquired contents are encrypted contents. Further, when the acquired contents are security contents, the processor may perform the decryption operation after releasing the security using the content security password stored as the additional information. Therefore, encrypted contents or security contents can also be normally reproduced. Meanwhile, the additional information may be used for either all or at least one of operation 51-4, operation 51-5, and operation 51-6.

Further, when a content to be acquired through the particular site or the particular network has an access limitation configured therein, the processor may acquire the content after obtaining an access permission using access information stored as the additional information, for example, file access or folder access information.

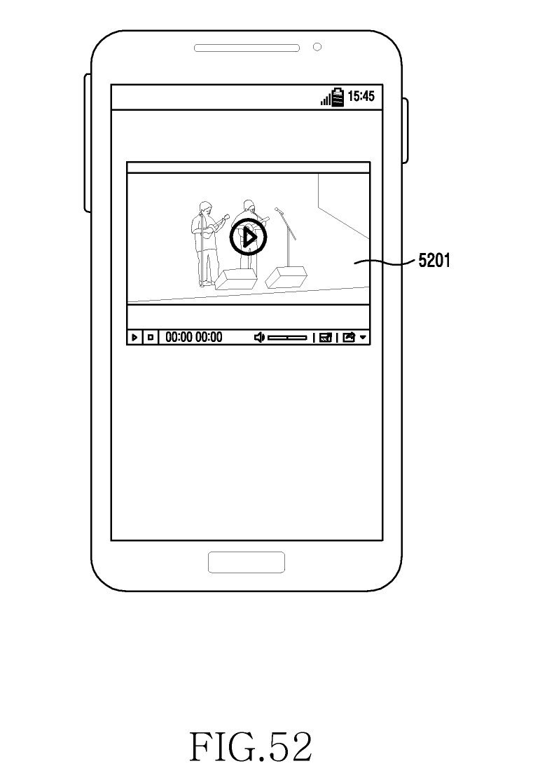

Therefore, a user who has visited a particular place while carrying the electronic device can acquire various contents additionally or limitedly provided through the beacon additional service as described above. For example, a user who has visited a venue while carrying the electronic device may additionally receive a performance video 5201 through the beacon additional service as shown in FIG. 52.

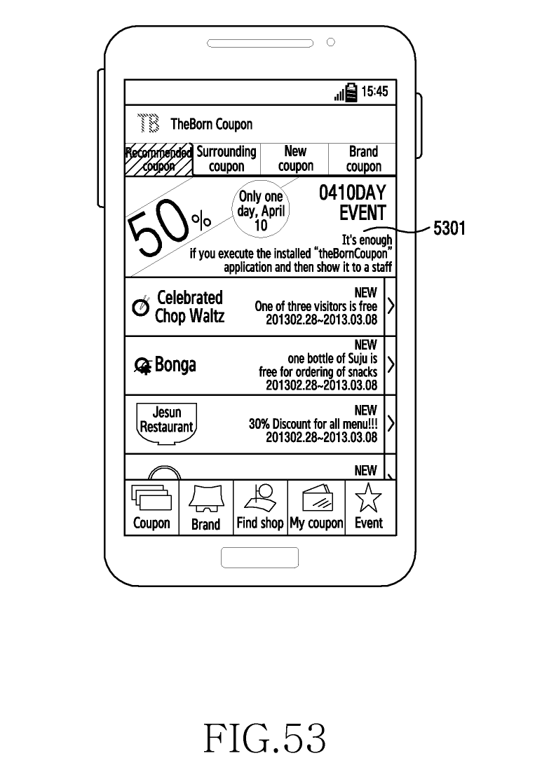

Further, a user who has visited a restaurant while carrying the electronic device may additionally receive a food discount coupon 5301 through the beacon additional service as shown in FIG. 53, and the discount rate of the additionally provided food discount coupon may be different according to users who have come back from the restaurant.

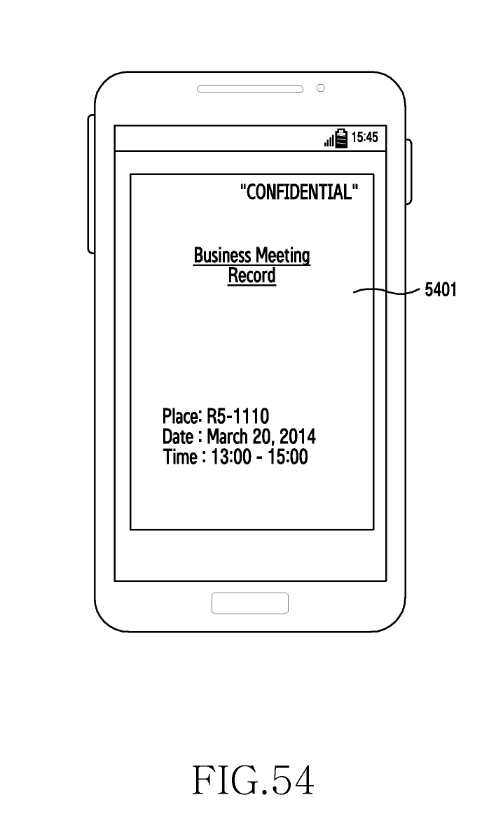

For example, a discount rate of 50% may be provided to a user when the number of times by which the user has visited the restaurant exceeds a predetermined reference number of times (e.g. three times), while a discount rate of 30% may be provided to the user when the number of times by which the user has visited the restaurant does not exceed the reference number of times. Further, a user who has visited a conference room while carrying the electronic device may limitedly receive minutes 5401 through the beacon additional service as shown in FIG. 54.

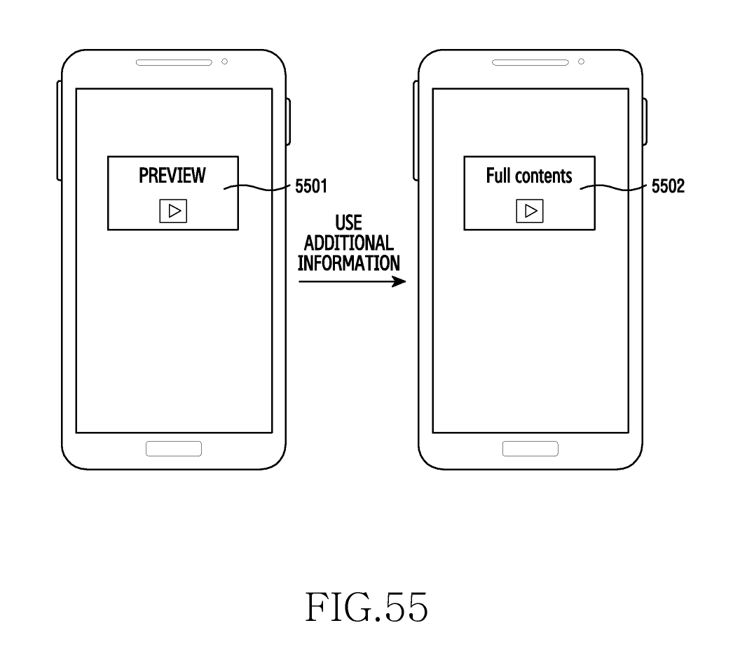

FIG. 55 illustrates an example of acquisition of full contents from preview contents using additional information according to various embodiments of the present disclosure. Referring to FIG. 55, for example, an electronic device, which has been carried by a user who has visited a particular place, such as a concert hall or theater, may store various additional information provided through a beacon signal by the particular place.

Using a user input or the stored additional information, the electronic device may connect to a particular server and may display preview contents 5501 basically provided by the particular server. Moreover, using the stored additional information, the electronic device may further perform an extended function in addition to the functions provided by the contents stored in the electronic device. For example, after acquiring the full contents extended further than the preview contents, the electronic device may display the full contents so that the user can view the full contents.

For example, an electronic device of a user who has visited a particular concert may store authorization information, which allows downloading of full contents of a filmed broadcast of the concert, as additional information, and the electronic device may acquire the full contents of the filmed broadcast of the concert by transmitting the stored authorization information to a particular server, and then display the full contents of the filmed broadcast so that the user can view the filmed broadcast.

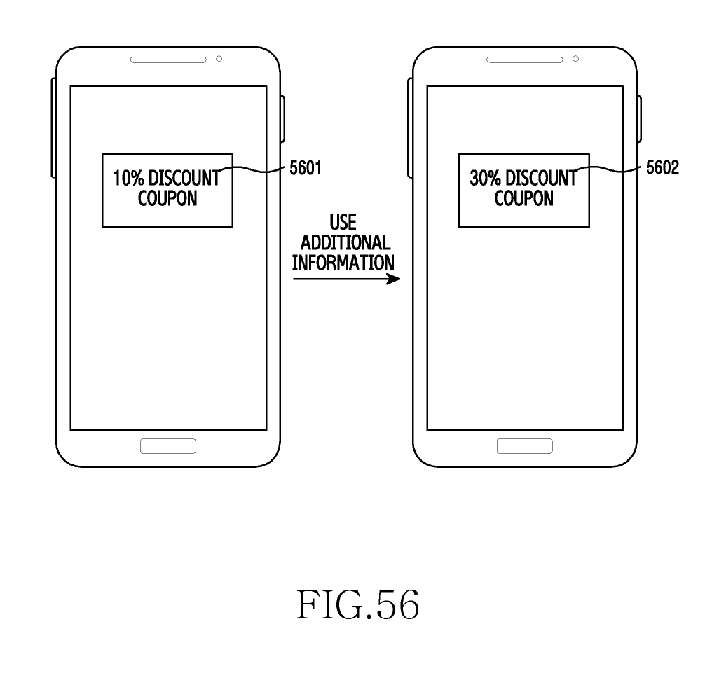

FIG. 56 illustrates an example of acquisition of an additional discount content further to a basic discount coupon using additional information according to various embodiments of the present disclosure. Referring to FIG. 56, for example, an electronic device, which has been carried by a user who has visited a particular place, such as a department store or restaurant, may store various additional information provided through a beacon signal by the particular place.

Using a user input or the stored additional information, the electronic device may connect to a particular server and may display a basic discount coupon (e.g., 10% discount) 5601 provided by the particular server. Moreover, using the stored additional information, the electronic device may acquire an additional discount coupon (e.g., 30% discount) 5602 from the particular server and then display the additional discount coupon so that the user can use the additional discount coupon.

For example, an electronic device of a user who has visited a particular restaurant may store authentication information, which allows a large-scale additional food discount, as additional information, and the electronic device may acquire the large-scale additional food discount coupon promised by the restaurant by transmitting the stored authentication information to a particular server, and then display the large-scale additional food discount coupon so that the user can use the coupon.

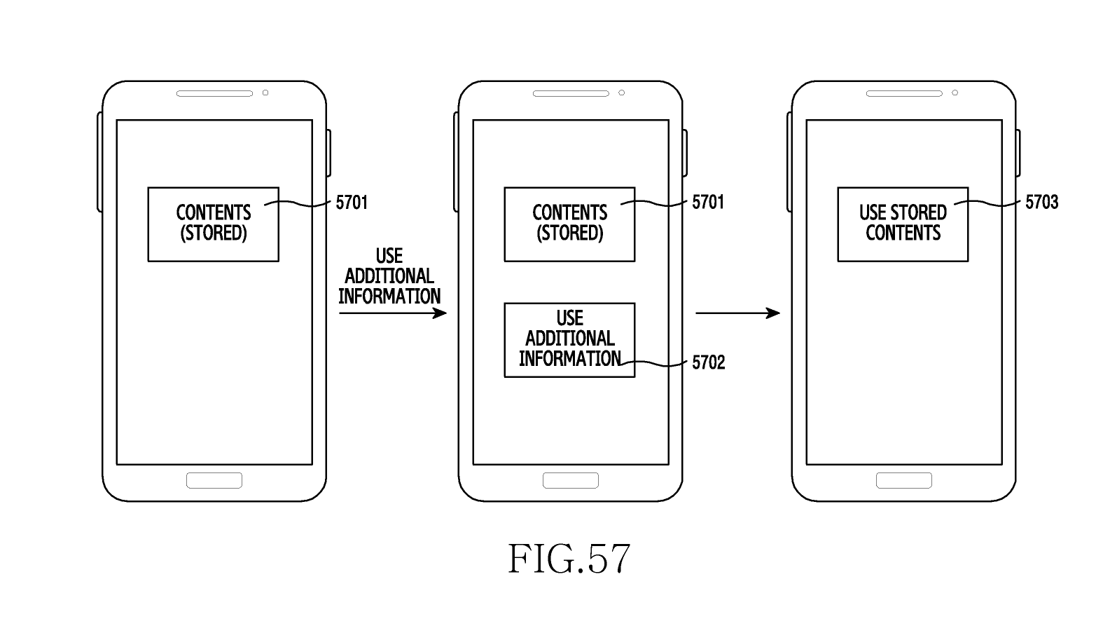

FIG. 57 illustrates an example of use of stored contents using additional information according to various embodiments of the present disclosure. Referring to FIG. 57, for example, an electronic device (e.g., a smart phone), which has been carried by a user who has visited a particular place, such as a conference room, may store various additional information provided through a beacon signal by the particular place.

Using the received additional information 5702, the electronic device may use the contents 5701 pre-stored in a memory of the electronic device. For example, in a state where contents, such as encrypted conference materials, are stored in a memory within the electronic device, an electronic device carried by a user who participates in a conference may receive additional information 5703, such as an encryption-decrypting key.

The electronic device may decrypt the contents, such as the encrypted conference materials stored in the memory, using the encryption-decrypting key and display the decrypted contents so that the user can normally use the contents, such as the conference materials.

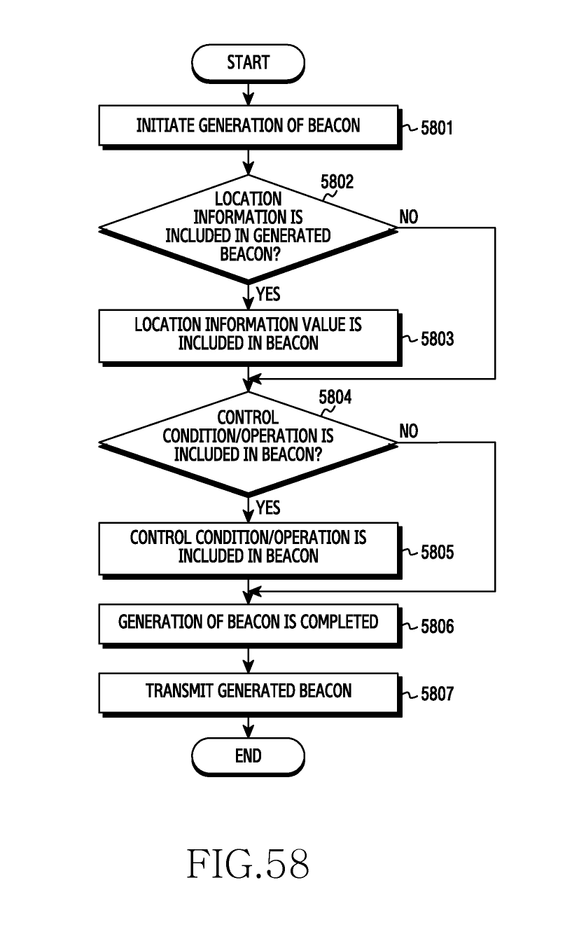

FIG. 58 is a flowchart illustrating a method of generating a beacon on the basis of location by an electronic device according to various embodiments of the present disclosure. For example, the beacon may be used for a short range service. In general, the range which a beacon signal can reach is a predetermined range, especially a short range, from a transmission device which transmits the beacon signal.

Therefore, when a beacon signal received by a reception device includes location information, the operation may be performed on the basis of the location information. Otherwise, when the beacon signal received by the reception device does not include location information, an operation of acquiring current location information of the reception device and tagging the acquired location information to the received beacon signal, for example, geo-tagging, may be performed at the moment when the reception device receives the beacon signal.

Referring to FIG. 58, the transmission device initiates generation of a beacon in operation 5801, and may determine whether to include location information in the generated beacon in operation 5802. When it is determined to include location information in the generated beacon, a location information value corresponding to the current position of the transmission device may be included in the beacon in operation 5803. The location information value may be a value of coordinates including a longitude value and a latitude value. The location information value may be information allowing identification of the location. The location information value may be information relating to a local area, such as a cell ID, a local area name, and a local address. The location information value may be geo-fence information.

The geo-fence information appoints a particular range, such that the particular range may be a range defined by a radius on the basis of the longitude value and latitude value. Otherwise, the geo-fence information may be appointed as a polygon. For example, the geo-fence information may be defined by the longitude values and latitude values corresponding to vertices of a polygon. Otherwise, the geo-fence information may be information relating to WiFi, AP, Bluetooth tag, etc. The location information value may be either manually appointed by a user or automatically appointed according to the type of the application or the type of the service.

Meanwhile, when it is determined not to include location information in the generated beacon in operation 5802, the location information may not be included in the beacon. Thereafter, in operation 5804, the transmission device may determine whether to include information relating to beacon control condition and control operation in the beacon. In operation 5805, when it is determined to include the information relating to beacon control condition and control operation in the beacon, the information relating to beacon control condition and control operation may be included in the beacon.

The beacon control condition may be a predetermined position or predetermined time. At the predetermined position or predetermined time, an operation relating to the corresponding beacon may be performed. For example, the operation relating to the beacon may be an operation of reading the received beacon. Here, the operation of reading may refer to an operation of decoding the beacon and displaying the beacon on a screen. For example, the operation relating to the beacon may be an operation of partially reading the received beacon. The operation relating to the beacon may be an operation of accessing a predetermined server using the received beacon. The operation relating to the beacon may be an operation of downloading predetermined contents from a predetermined server using the received beacon.

For example, the operation relating to the beacon may be an operation relating to contents included in the received beacon. For example, the operation relating to contents included in the received beacon may be an operation of payment for a product when the beacon includes information on the product. The operation relating to the beacon may be an operation of deleting or disabling the beacon when a terminal having received beacon escapes from a predetermined position. The operation relating to the beacon may be an operation of displaying a UI notifying of escaping a beacon reception area when a terminal having received the beacon escapes from a predetermined position. The operation relating to the beacon may be an operation of sharing the received beacon.

The operation of sharing the received beacon may be an operation of directly sharing the received beacon without processing the received beacon. The operation of sharing the received beacon may be an operation of sharing contents downloaded from a server using the received beacon. The operation of sharing the received beacon may include a predetermined address (URL) to be accessed using the received beacon. The received beacon may be shared using a cellular network, BT, WiFi connection, D2D, etc.

When the received beacon is shared, the number of times of sharing may be limited. For example, by pre-determining the maximum number of times allowed for the sharing, the beacon may be prevented from being shared more than the predetermined number of times. For example, when it is configured to allow the sharing up to three times, the count value may be set to 3 and be reduced by 1 for each time of sharing. When the count value becomes 0, the sharing is not allowed any more.

When the received beacon is shared, the subject to share the beacon may be limited. For example, the subject to share the beacon may be limited to users registered in a contact list of a person who has received the beacon, users registered as SNS friends of the receiver or a business operator providing the beacon, and users authenticated by an application/service providing the beacon. When the received beacon is shared, the shared information may be limited. For example, all contents usable by using the received beacon may be shared. Otherwise, limited contents available using the received beacon may be shared.

In operation 5804, when it is determined not to include the information relating to beacon control condition and control operation in the beacon, the information relating to beacon control condition and control operation may not be included in the beacon. In operation 5806, the generation of the beacon is completed through the operations described above. In operation 5807, the generated beacon may be transmitted.

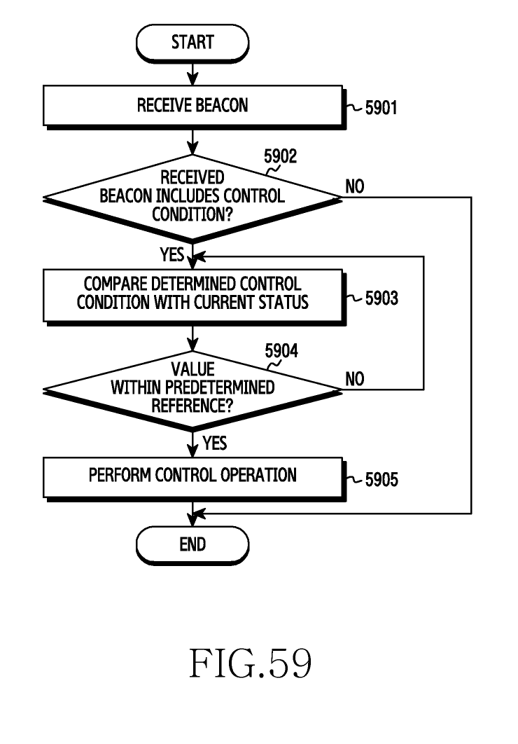

FIG. 59 is a flowchart illustrating an example method of performing a control operation according to the received beacon by an electronic device according to various embodiments of the present disclosure. For example, the electronic device may be various types of terminals, such as a smart phone or a tablet PC.

Referring to FIG. 59, the terminal receives a beacon in operation 5901, and may determine whether the received beacon includes a control condition in operation 5902. The control condition may be a predetermined position or predetermined time. The terminal compares the determined control condition with the current status in operation 5903. When the comparison shows a value within a predetermined reference in operation 5904, the terminal may perform a control operation corresponding to the control condition in operation 5905.

For example, when the terminal is located within a location predetermined by the control condition, the terminal may perform the control operation. As another example, when the terminal receives a beacon within a time predetermined by the control condition, the terminal may perform the control operation. For example, the control operation may be an operation included in the received beacon. As another example, the control operation may be an operation performed by the terminal itself having received the beacon, rather than an operation included in the beacon.

For example, the operation performed by the terminal itself having received the beacon may be an operation of reading the received beacon. For example, the operation of reading may be an operation of decoding the beacon and displaying the beacon on a screen. The operation performed by the terminal itself having received the beacon may be an operation of partially reading the received beacon. The operation performed by the terminal itself having received the beacon may be an operation of accessing a predetermined sever using the received beacon. The operation performed by the terminal itself having received the beacon may be an operation of downloading predetermined contents from a predetermined server using the received beacon. The operation performed by the terminal itself having received the beacon may be an operation relating to contents included in the received beacon. For example, the operation relating to contents included in the received beacon may be an operation of payment for a product when the beacon includes information on the product.

The operation performed by the terminal itself having received the beacon may be an operation of deleting or disabling the beacon when a terminal having received beacon escapes from a predetermined position. The operation performed by the terminal itself having received the beacon may be an operation of displaying a UI notifying of escaping a beacon reception area when a terminal having received the beacon escapes from a predetermined position. The operation performed by the terminal itself having received the beacon may be an operation of sharing the received beacon.

The operation of sharing the received beacon may be an operation of directly sharing the received beacon without processing the received beacon. The operation of sharing the received beacon may be an operation of sharing contents downloaded from a server using the received beacon. The operation of sharing the received beacon may include a predetermined address (URL) to be accessed using the received beacon. The received beacon may be shared using a cellular network, BT, WiFi connection, D2D, etc.

When the received beacon is shared, the terminal may limit the number of times of sharing. For example, by pre-determining the maximum number of times allowed for the sharing, the beacon may be prevented from being shared more than the predetermined number of times. For example, when it is configured to allow the sharing up to three times, the count value may be set to 3 and be reduced by 1 for each time of sharing. When the count value becomes 0, the sharing is not allowed any more. When the received beacon is shared, the terminal may limit the subject to share the beacon. For example, the subject to share the beacon may be limited to users registered in a contact list of a person who has received the beacon, users registered as SNS friends of the receiver or a business operator providing the beacon, and users authenticated by an application/service providing the beacon. When the received beacon is shared, the terminal may limit shared information. For example, all contents usable by using the received beacon may be shared. Otherwise, limited contents available using the received beacon may be shared.

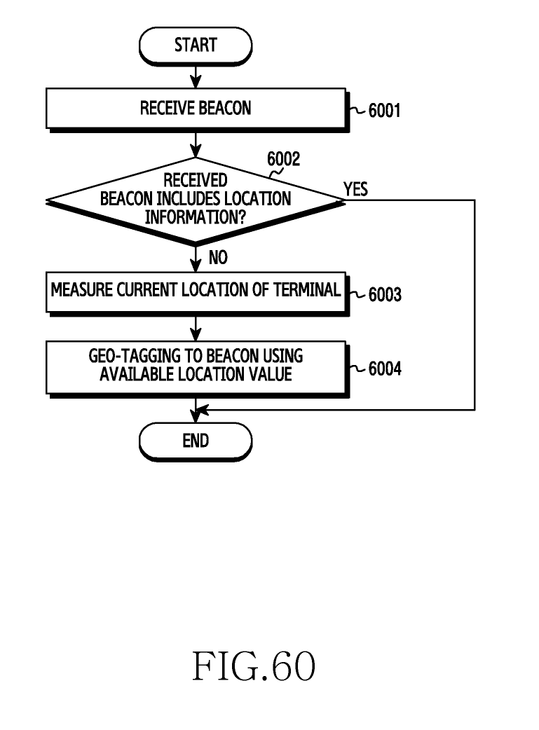

FIG. 60 is a flowchart illustrating a method of performing a geo-tagging operation to the received beacon by an electronic device according to various embodiments of the present disclosure. For example, the electronic device may be various types of terminals, such as a smart phone or a tablet PC.

Referring to FIG. 60, the terminal receives a beacon in operation 6001, and may determine whether the received beacon includes location information in operation 6002. As a result of the determination, when the received beacon does not include location information, the terminal may measure the current location of the terminal in operation 6003. The method of measuring the current location of the terminal may include a method of measuring the location using a GPS module, a WiFi module, a Bluetooth module, a cellular modem, a visible light module, a sensor module, or an ultrasonic wave reception module.

In operation 6004, the terminal may perform geo-tagging to the beacon, using an available location value. The available location value may be a location information value included in the received beacon or a value obtained by measuring the current location by the terminal. The geo-tagging may be an operation of including, in metadata of the beacon, a location information value included in the received beacon or a value obtained by measuring the current location by the terminal. Otherwise, the geo-tagging may be an operation of mapping a corresponding value to the beacon and storing the mapped value. Otherwise, the geo-tagging may be an operation of mapping geo-fence information defined as a radius of a predefined distance from a corresponding value as a center point to the beacon and storing the mapped value.

The beacon having location information geo-tagged therein may be displayed on a map of the terminal. For example, when a user executes a map application, the terminal possessing the geo-tagged beacon may display the beacon on a corresponding location on a map thereof. When the beacon displayed on the map is selected, contents included in the beacon may be displayed while a related application is executed and a sharing function is displayed. The function of displaying contents included in the beacon may be an operation of displaying information included in the beacon when it is selected by the user. The operation of executing the beacon-related application may be an operation of executing an application relating to the beacon when it is selected by the user. The beacon sharing function may be an operation of sharing the beacon with a predetermined person when it is selected by the user.

According to various embodiments of the present disclosure, for example, when a user carrying an electronic device, such as a smart phone or a tablet PC, has visited a particular place, such as a venue, restaurant, or conference room, the electronic device can access a resource of a particular site or particular network, using additional information, such as authorization information, password information, or decryption information, which are extracted from a beacon signal received at the particular place.

Further, through the particular site or particular network, the electronic device can acquire various contents. For example, the electronic device can acquire various contents, such as performance video, food discount coupon, minutes, etc., which are additionally or limitedly provided to a user who has visited to a particular place, such as a venue, restaurant, or conference room, from the particular site or a server or terminal connected through the particular network, and then decode and reproduce the acquired contents.

Methods stated in claims and/or specifications according to various embodiments may be implemented by hardware, software, or a combination of hardware and software. In the implementation of software, a computer-readable storage medium for storing one or more programs (software modules) may be provided. The one or more programs stored in the computer-readable storage medium may be configured for execution by one or more processors 120 within the electronic device. The at least one program may include instructions that cause the electronic device to perform the methods according to various embodiments of the present disclosure as defined by the appended claims and/or disclosed herein.

The programs (software modules or software) may be stored in non-volatile memories including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or other type optical storage devices, or a magnetic cassette. Alternatively, any combination of some or all of the may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In various specific embodiments of the present disclosure as described above, an element or elements included in the present disclosure are expressed in a singular form or plural form according to the presented specific embodiments. However, the singular form or plural form is selected for convenience of description suitable for the presented situation, and various embodiments of the present disclosure are not limited to a single element or multiple elements thereof. Further, either multiple elements expressed in the description may be configured into a single element or a single element in the description may be configured into multiple elements.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

Meanwhile, while the disclosure has been shown and described with reference to specific embodiments thereof in the detailed description of the present disclosure, it goes without saying that various changes in form and details may be made therein without departing from the disclosure. Therefore, the present disclosure should not be defined as being limited to the embodiments, but should be defined by the appended claims and equivalents thereof.

What is claimed is:

1. A method for an operation of an electronic device, the method comprising:
detecting a transmitted beacon signal by a beacon interface;
extracting additional information from the detected beacon signal; and
accessing a resource using the extracted additional information, the resource accessed from at least one of a source of the beacon signal and a remote terminal discoverable through a network.

2. The method of claim 1, wherein the beacon signal is received from an external electronic device installed at a particular place relating to the accessed resource.

3. The method of claim 1, further comprising: acquiring content of the accessed resource through network communication using the additional information.

4. The method of claim 3, wherein the remote terminal further comprises at least one of a content server, a cloud server, a web site, and a terminal communicatively coupled to the electronic device through peer-to-peer communication.

5. The method of claim 3, wherein the acquiring further comprises:
acquiring additional content extended from content previously stored on the electronic device using the additional information.

6. The method of claim 1, wherein the accessing further comprises:
accessing content stored in the electronic device using the additional information.

7. The method of claim 6, wherein the accessing further comprises:
decrypting the content stored in the electronic device using the additional information.

8. The method of claim 6, wherein the accessing further comprises:
releasing a lock prohibiting access to the content stored in the electronic device using the additional information.

9. The method of claim 6, wherein the accessing further comprises:
executing an extended function in addition to a function supported by the content stored in the electronic device using the additional information.

10. The method of claim 3, further comprising:
decrypting the acquired content using the additional information.

11. The method of claim 1, wherein the additional information is extracted from user data stored in a payload portion of a beacon packet transmitted through the beacon signal.

12. The method of claim 1, wherein the additional information comprises at least one of authority information, password information, decryption information, location indicating an origin of the beacon signal, time information, information on an event related to the origin, and link information.

13. The method of claim 12, wherein the authority information indicates at least one of a web site, a network, a terminal, a file, and a folder.

14. The method of claim 12, wherein the password information comprises at least one of a log-in password, a content security password, a terminal access password, and a network access password.

15. The method of claim 12, wherein the decryption information comprises a decryption key for decrypting encrypted contents.

16. An electronic device comprising:
a beacon module to detect a beacon signal; and
a processor to:
extract additional information from the detected beacon signal, and
access a resource using the extracted additional information, the resource accessed from at least one of a source of the beacon signal and a remote terminal discoverable through a network.

17. The electronic device of claim 16, wherein the beacon signal is received from an electronic device installed at a particular place relating to the accessed resource.

18. The electronic device of claim 16, wherein the processor further acquires content of the accessed resource through network communication using the additional information.

19. The electronic device of claim 18, wherein the remote terminal further comprises at least one of a content server, a cloud server, a web site, and a terminal communicatively coupled to the electronic device through peer-to-peer communication.

20. The electronic device of claim 18, wherein the processor further acquires additional content extended from content previously stored on the electronic device using the additional information.

21. The electronic device of claim 18, wherein the processor further accesses content stored in the electronic device using the additional information.

22. The electronic device of claim 21, wherein the processor further decrypts the content stored in the electronic device using the additional information.

23. The electronic device of claim 21, wherein the processor further releases a lock prohibiting access of the content stored in the electronic device using the additional information.

24. The electronic device of claim 21, wherein the processor further executes an extended function in addition to a function supported by the content stored in the electronic device using the additional information.

25. The electronic device of claim 18, wherein the processor further decrypts the acquired content using the additional information.

26. The electronic device of claim 16, wherein the additional information is extracted from user data stored in a payload portion of a beacon packet transmitted through the beacon signal.

27. The electronic device of claim 16, wherein the additional information comprises at least one of authority information, password information, decryption information, location information indicating an origin of the beacon signal, time information, information on an event related to the origin, and link information.

28. The electronic device of claim 27, wherein the authority information indicates at least one of a web site, a network, a terminal, a file, and a folder.

29. The electronic device of claim 27, wherein the password information comprises at least one of a log-in password, a content security password, a terminal access password, and a network access password.

30. The electronic device of claim 27, wherein the decryption information comprises a decryption key for decrypting encrypted contents.

31. A non-transitory computer-readable recording medium storing program instructions, the program instructions executable by a processor to:
detect a transmitted beacon signal by a beacon interface;
extract additional information from the detected beacon signal; and
access a resource using the extracted additional information, the resource accessed from at least one of a source of the beacon signal and an remote terminal discoverable through a network.
